(19) United States
(12) Patent Application Publication
(10) Pub. No.: US 2026/0247059 A1
(43) Pub. Date: Aug. 20, 2026

(54) EAR-CLIP EARPHONE AND EARPHONE MODULE

(71) Applicant: Shenzhen Baseus Technology Co., Ltd., Shenzhen (CN)

(72) Inventors: Fan Wu, Shenzhen (CN); Yuchao Li, Shenzhen (CN); Shunqing Su, Shenzhen (CN); Tao Chen, Shenzhen (CN); Guanglong Qi, Shenzhen (CN); Yangwen Jiang, Shenzhen (CN); Jianhai Liu, Shenzhen (CN)

(21) Appl. No.: 19/643,129

(22) Filed: Apr. 9, 2026

Related U.S. Application Data
(63) Continuation-in-part of application No. PCT/CN2025/107727, filed on Jul. 9, 2025.

(30) Foreign Application Priority Data
Sep. 27, 2024 (CN) 202422381293.4
Oct. 31, 2024 (CN) 202422662407.2
Apr. 18, 2025 (CN) 202520754822.2
Apr. 27, 2025 (CN) 202520818735.9
Sep. 28, 2025 (CN) 202522101743.4

(51) Int. Cl. H04R 1/10; H04R 1/1025

(52) U.S. Cl. CPC H04R 1/105; H04R 1/1066; H04R 1/1016; H04R 1/1025; H04R 2460/17

(57) ABSTRACT

The disclosed embodiment relates to the field of wireless earphones and provides an ear-clip earphone. The ear-clip earphone includes a postauricular component, a preauricular component, and a connection component. The preauricular component is at least used to install a sound emitting assembly thereto. The connection component is connected between the postauricular component and the preauricular component. The connection component is used to adjust a relative position between the postauricular component and the preauricular component to cooperatively clamp an ear.

### CROSS-REFERENCE TO RELATED APPLICATION(S)

The present application is a continuation-in-part application of PCT application No. PCT/CN2025/107727, entitled “WIRE HARNESS STORAGE BOX,” filed on July 9, 2025, which claims all benefits accruing from China Patent Application No. 202422381293.4, filed on September 27, 2024 and entitled “EAR-CLIP EARPHONE”, China Patent Application No. 202422662407.2, filed on October 31, 2024 and entitled “EAR-CLIP EARPHONE”, China Patent Application No. 202520754822.2, filed on April 18, 2025 and entitled “EARPHONE AND EARPHONE MODULE”, China Patent Application No. 202520818735.9, filed on April 27, 2025 and entitled “SELF-FITTING REBOUND EARPHONE AND EARPHONE MODULE”, China Patent Application No. 202522101743.4, filed on September 28, 2025 and entitled “EARPHONE AND EARPHONE DEVICE”, all filed in the China National Intellectual Property Administration, each of which is incorporated by reference herein in its entirety.

### FIELD

The subject matter herein generally relates to the field of wireless earphones, and particularly, to an ear-clip earphone.

### BACKGROUND

Existing ear-clip earphones may easily fall off during use, which affects the user’s experience.

### SUMMARY

Therefore, embodiments of the present disclosure provide an ear-clip earphone.

An ear-clip earphone according to the present application includes a postauricular component, a preauricular component being configured to install at least a sound emitting assembly thereto, and a connection component connected between the postauricular component and the preauricular component. A relative position between the postauricular component and the preauricular component is adjustable by the connection component to cooperatively clamp an ear, thereby allowing the postauricular component and the preauricular component to cooperatively clamp an ear. The preauricular component is provided with an elastic component. The elastic component is flexible and protrudes towards the postauricular component. The elastic component is configured to cooperate with an ear bone of the ear to locate a position of the ear-clip earphone worn on the ear.

Other aspects and embodiments of the present disclosure are also expected. The above summary and the following detailed description are not intended to limit the present disclosure to any particular embodiment, but are merely intended to describe some embodiments of the present disclosure.

### BRIEF DESCRIPTION OF THE DRAWINGS

In order to explain the technologies of the embodiments of the present disclosure or the related arts more clearly, the following accompanying drawings are briefly described. Obviously, the accompanying drawings are only some embodiments of the present disclosure. For those skilled in the field, other drawings can be obtained based on these drawings without any creative effort.

FIG. 1 is a schematic diagram of an ear-clip earphone in a first orientation according to an embodiment of the present disclosure.

FIG. 2 is a cross-sectional view of the ear-clip earphone of FIG. 1.

FIG. 3 is a schematic diagram of the ear-clip earphone of FIG. 1 in a second orientation.

FIG. 4 is a schematic diagram showing some dimensions of the ear-clip earphone of FIG. 3.

FIG. 5 is a schematic diagram of the ear-clip earphone according to an embodiment of the present disclosure, wherein a fixing component thereof is a first fixing component.

FIG. 6 is another schematic diagram of the ear-clip earphone according to an embodiment of the present disclosure, wherein the fixing component thereof is a second fixing component.

FIG. 7 is a schematic diagram of the ear-clip earphone according to an embodiment of the present disclosure, wherein the fixing component thereof is a third fixing component.

FIG. 8 is a cross-sectional view of the ear-clip earphone of FIG. 6.

FIG. 9 is a schematic diagram of a partial structure of the ear-clip earphone according to an embodiment of the present disclosure.

FIG. 10 is a schematic diagram of the first fixing component of FIG. 5.

FIG. 11 is a schematic diagram of the second fixing component of FIG. 6.

FIG. 12 is a schematic diagram of the third fixing component of FIG. 7.

FIG. 13 is a schematic diagram of the structure showing an earphone clamped on an ear according to another embodiment of the present application.

FIG. 14 is a schematic diagram of the ear of FIG. 13 from a certain perspective.

FIG. 15 is a schematic diagram of the ear of FIG. 13 from another perspective.

FIG. 16 is a schematic diagram of the structure of the earphone of FIG. 13 from a perspective.

FIG. 17 is a front view of the earphone of FIG. 16.

FIG. 18 is a schematic diagram of the earphone of FIG. 13 from another perspective.

FIG. 19 is a front view of the earphone of FIG. 18.

FIG. 20 is a front view of the earphone of FIG. 18, wherein a shape-memory connection component in the earphone is shown.

FIG. 21 is a front view of the earphone of FIG. 16, wherein a postauricular component and a connection component are removed.

FIG. 22 is a cross-sectional view of the earphone of FIG. 21.

FIG. 23 is a schematic diagram of an ear cap of the earphone of FIG. 16 from a perspective.

FIG. 24 is a schematic diagram of the ear cap of the earphone of FIG. 16 from another perspective.

FIG. 25 is a schematic diagram of the ear cap of the earphone of FIG. 16 from another perspective.

FIG. 26 is a cross-sectional view of the ear cap of the earphone of FIG. 16.

FIG. 27 is a schematic diagram of a self-fitting rebound earphone according to yet another embodiment of the present application.

FIG. 28 is a cross-sectional view of the self-fitting rebound earphone of FIG. 27.

FIG. 29 is a schematic diagram showing a preauricular component being connected to an airbag of the self-fitting rebound earphone of FIG. 27.

FIG. 30 is a cross-sectional view showing the preauricular component being connected to the airbag of the self-fitting rebound earphone of FIG. 27.

FIG. 31 is a schematic diagram of the preauricular component of the self-fitting rebound earphone of FIG. 27 from a perspective.

FIG. 32 is a schematic diagram of the preauricular component of the self-fitting rebound earphone of FIG. 27 from another perspective.

FIG. 33 is a schematic diagram of the airbag of the self-fitting rebound earphone of FIG. 27 from a perspective.

FIG. 34 is a schematic diagram of the airbag of the self-fitting rebound earphone of FIG. 27 from another perspective.

FIG. 35 is a schematic diagram of an ear-clip earphone according to yet another embodiment of the present application from a perspective.

FIG. 36 is a schematic diagram of the ear-clip earphone of FIG. 35 from another perspective.

FIG. 37 is a schematic diagram of the ear-clip earphone of FIG. 35 from another perspective.

FIG. 38 is a schematic diagram of the ear-clip earphone of FIG. 35 from another perspective.

FIG. 39 is a schematic diagram of the ear-clip earphone of FIG. 35 from another perspective.

FIG. 40 is a cross-sectional view of the ear-clip earphone taken along A-A of FIG. 36.

FIG. 41 is a schematic diagram of the ear-clip earphone of FIG. 23 from another perspective.

FIG. 42 is a cross-sectional view of the ear-clip earphone taken along B-B of FIG. 37.

FIG. 43 is a schematic diagram of a sound emitting assembly of the ear-clip earphone of FIG. 35.

FIG. 44 is another schematic diagram of the output component of the ear-clip earphone of FIG. 35.

FIG. 45 is a schematic diagram of the sound emitting assembly of FIG. 43 from another perspective.

FIG. 46 is a schematic diagram of the ear-clip earphone of FIG. 35 from another perspective.

FIG. 47 is a J-J sectional view of the ear-clip earphone of FIG. 46.

FIG. 48 is a schematic diagram of the structure of the ear-clip earphone of FIG. 35 from another perspective.

FIG. 49 is an exploded diagram of the ear-clip earphone of FIG. 35.

FIG. 50 is a schematic diagram of the ear-clip earphone of FIG. 35 from another perspective.

FIG. 51 is a schematic diagram of the ear-clip earphone of FIG. 50 from another perspective.

FIG. 52 is a schematic diagram of a portion of the ear-clip earphone of FIG. 51.

FIG. 53 is a cross-sectional view of the ear-clip earphone taken along I-I of FIG. 51.

FIG. 54 is a cross-sectional view of the ear-clip earphone taken along A-A of FIG. 36.

FIG. 55 is a partial enlarged diagram of the ear-clip earphone of FIG. 54.

FIG. 56 is an exploded view of a portion of the ear-clip earphone of FIG. 35.

FIG. 57 is a schematic diagram of an earphone module according to an embodiment of the present application.

### DETAILED DESCRIPTION

Implementations of the present disclosure will now be described clearly and completely with reference to the attached figures. It should be understood that the embodiments described here are only used to explain but not to limit the disclosure.

The various features described in the specific embodiments can be combined in a suitable way without contradiction, for example, different features can be combined to obtain different embodiments or technical solutions. In order to avoid unnecessary repetition, the combinations of the features in the present disclosure will not be explained.

In the following description, the terms “first” and “second” are used to distinguish different objects and not to imply similarities or connections. It should be understood that the orientation descriptions “on”, “under”, “outside”, and “inside” refer to orientations in normal use, and the orientation descriptions “left” and “right” refer to orientations shown in the corresponding drawings, which may be or not be the left and right directions in normal use.

It should be noted that the terms “including”, “comprising” or any other variation intended to encompass non-exclusive inclusion, can describe that a process, a method, an article, or a device not only includes the related elements, but also includes other elements that are not explicitly listed or inherent elements in such a process, method, article, or device. Without further limitations, the element defined by the statement “including a...” does not exclude the existence of other identical elements in the process, method, article, or device. The statement “a plurality of” means a number greater than or equal to two.

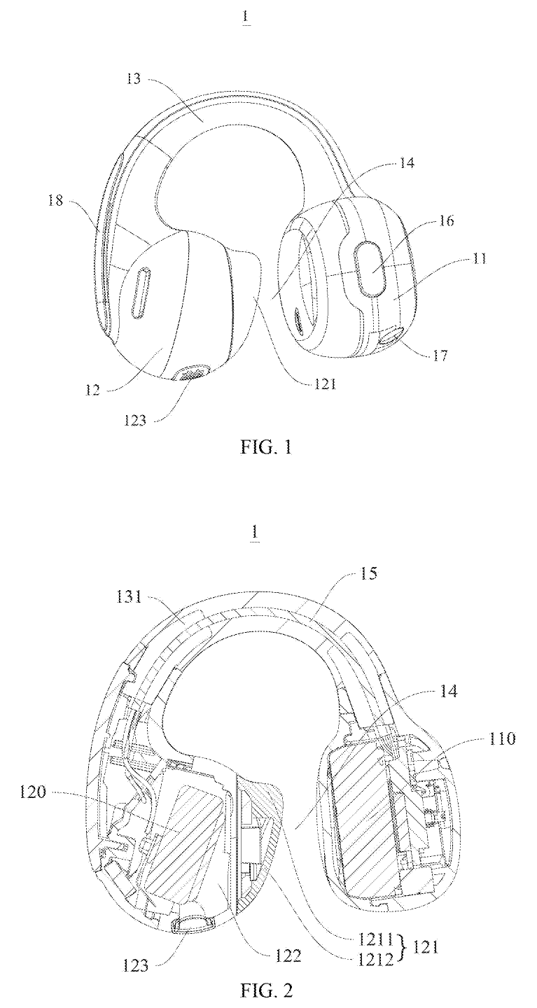

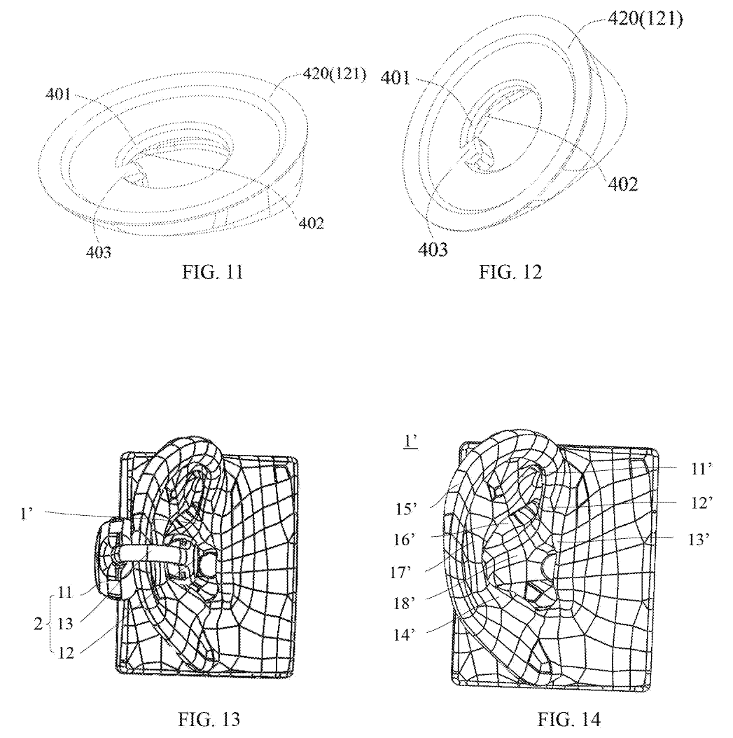

An earphone 1 according to an embodiment of the present application will be described with reference to FIGS. 1 to 14.

In the embodiment of the application, the quantity of ear-clip earphone(s) may be one or two. When there are two ear-clip earphones, one is a left-ear-clip earphone, and another is a right-ear-clip earphone. The two ear-clip earphones can be interchangeably used.

As shown in FIGS. 1 and 2, the ear-clip earphone 1 includes a first shell 11, a second shell 12, and a connection component 13. The first shell 11 is at least used for a power supply assembly 110 to install thereon. The second shell 12 is at least used for a sound emitting assembly 120 to install thereon. The connection component 13 is connected between the first shell 11 and the second shell 12. The connection component 13 is used to adjust a relative position between the first shell 11 and the second shell 12 to cooperatively clamp the ear. It can be understood that two ends of the connection component 13 are connected to the first shell 11 and the second shell 12, respectively. The connection component 13 can be elastically deformed under an external force, so that the first shell 11 and the second shell 12 can move away from or towards each other. The ear-clip earphone 1 is clamped on the front side and the back side of the ear bone by the first shell 11 and the second shell 12, thereby fixing the ear-clip earphone 1 on the ear. At this time, the second shell 12 is located at the front side of the ear bone, and the first shell 11 is located at the back side of the ear bone. It should be noted that the front side of the ear bone refers to a side of the ear bone near the face of the human, and the back side of the ear bone refers to another side of the ear bone away from the face of the user. The second shell 12 is equipped with a sound emitting assembly 120. The sound emitting assembly 120 is located near the cochlea to allow the user to hear clearer sound during use. The first shell 11 is equipped with a power supply assembly 110. The power supply assembly 110 supplies electric power at least to the sound emitting assembly 120 to maintain the normal operation of the ear-clip earphone 1.

In some embodiments, as shown in FIG. 2, the second shell 12 is provided with a fixing component 121 that is flexible. The fixing component 121 protrudes towards the first shell 11 and cooperates with the ear bone to locate a worn position. That is, the fixing component 121 protruding towards the first shell 11 is provided on the second shell 12, and the fixing component 121 is made of a flexible material. The setting of the fixing component 121 reduces the distance between the first shell 11 and the second shell 12. When the first shell 11 and the second shell 12 are clamped on the ear bone, the flexible fixing component 121 is compressed by the ear bone and elastically deformed, thus the fixing component 121 can also be referred to as an “elastic component”. Thus, the fixing component 121 may fit the shape of the ear bone to improve the wearing comfort of the user. The deformation may also increase the friction between the ear bone and the fixing component 121 and reduce the shaking of the ear-clip earphone 1 during use.

The ear-clip earphone according to the embodiment of the present disclosure includes the first shell, the second shell, and the connection component. The first shell is at least used for the power supply assembly to install thereon, and the second shell is at least used for the sound emitting assembly to install thereon. The connection component is connected between the first shell and the second shell, and is used to adjust the relative position between the first shell and the second shell such that the first shell and the second shell can cooperatively clamp the ear. The second shell is equipped with the fixing component that is flexible. The fixing component protrudes towards the first shell to cooperate with the ear bone to locate a worn position. Thus, by setting the flexible fixing component, when the ear-clip earphone is clamped on the ear, the fixing component can be elastically deformed according to the shape of the ear bone, which can fit the shape of the ear bone, improve the wearing comfort and clamping stability. At the same time, since the fixing component protrudes towards the first shell, the distance between the first shell and the second shell can be reduced, thereby optimizing the performance of the product and clamping the ear-clip earphone more securely on the ear. Thus, the ear-clip earphone can be better suitable for sport scenes, not easily be separated from the ear and improve the user’s experience.

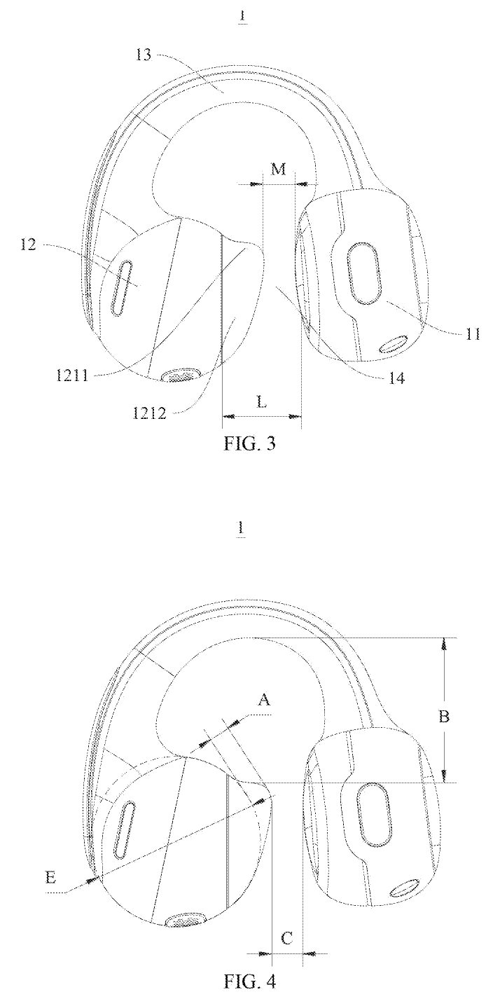

In some embodiments, as shown in FIGS. 2 and 3, a distance from an end of the fixing component 121 away from the connection component 13 to the first shell 11 is denoted as L, and a distance from another end of the fixing component 121 near the connection component 13 to the first shell 11 is denoted as M, and L>M. As an example, a vertical distance from the outer contour of the fixing component 121 of the second shell 12 near the first shell 11 to the first shell 11 varies. At the end of the fixing component 121 near the connection component 13, a vertical distance from the fixing component 121 to the first shell 11 is denoted as M. At the end of the fixing component 121 far from the connection component 13, a vertical distance from the fixing component 121 to the first shell 11 is denoted as L, and the size relationship between L and M satisfies: L>M. That is, the fixing component 121 is closest to the first shell 11 at the end of the fixing component 121 near the connection component 13.

Here, the end of the fixing component 121 away from the connection component 13 may be the end of the fixing component 121 away from the connection area between the connection component 13 and the second shell 12. The end of the fixing component 121 near the connection component 13 may be the end of the fixing component 121 near the connection area between the connection component 13 and the second shell 12.

When the ear-clip earphone 1 is clamped on the ear, the connection component 13 is located at the outer side of the ear bone. At a position near the edge of the ear bone, a distance between the fixing component 121 and the first shell 11 is the smallest. At this time, the flexible fixing component 121 will be deformed according to the contour of the ear bone, so that the outer contour of the fixing component 121 may fully fit the shape of the ear bone, so that the ear-clip earphone 1 can be stably clamped on the ear.

The embodiment of the present disclosure designs the outer contour of the fixing component, to minimize the distance between the fixing component and the first shell at a position closest to the connection component. Thus, the fixing component can better fit the shape of the ear bone, and the ear-clip earphone can be firmly clamped on the ear, thereby meeting the need to use the ear-clip earphone during exercise, expanding the usage scenarios of the ear-clip earphone, and optimizing the user’s experience.

In some embodiments, as shown in FIGS. 2 and 3, there is a clamping gap 14 between the first shell 11 and the fixing component 121. A width of the clamping gap 14 gradually decreases from the end of the fixing component 121 away from the connection component 13 towards the end of the fixing component 121 near the connection component 13. That is, in a direction from the end of the fixing component 121 away from the connection component 13 to the end of the fixing component 121 near the connection component 13, the outer contour of the fixing component 121 gradually approaches the first shell 11, thereby gradually reducing the width of the clamping gap 14. That is, the outer contour of the fixing component 121 is a smooth oblique line. On the one hand, the appearance of the fixing component 121 is improved, and on the other hand, the area where the fixing component 121 being in contact with the ear is smooth, thereby improving the wearing comfort.

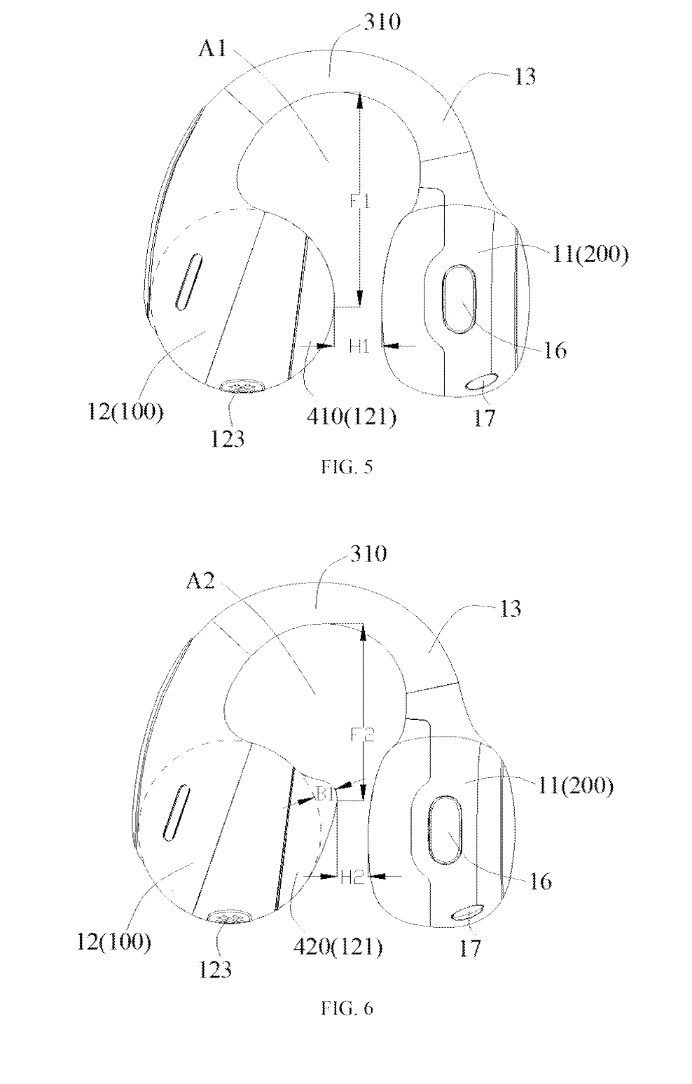

Here, the direction from the end of the fixing component 121 away from the connection component 13 to the end of fixing component 121 near the connection component 13 mentioned above, may also be a direction from the end of the fixing component 121 away from the middle of the connection component 13 to the end of fixing component 121 near the middle of the connection component 13. The middle of the connection component 13 may substantially be the middle portion of the connection component 13. The middle of the connection component 13 may also be the portion of the connection component 13 that is not connected to the first shell 11 and the second shell 12. The middle of the connection component 13 may also be the portion of the connection component 13 for cooperating with the helix of the user. The direction from the end of the fixing component 121 away from the connection component 13 to the end of fixing component 121 near the connection component 13 mentioned above, may also be a direction from the end of the fixing component 121 away from the connection portion 310 of the connection component 13 to the end of the fixing component 121 near the connection portion 310 of the connection component 13 (see FIG. 6).

The embodiment of the present disclosure designs the outer contour of the fixing component by adjusting the width of the clamping gap, thereby allowing the outer contour of the fixing component to be smooth and beautiful. At the same time, the area between the ear and the ear-clip earphone is smooth, thereby improving the wearing comfort, enhancing the performance of the product, and improving the user’s experience.

In some embodiments, as shown in FIGS. 2 and 3, the fixing component 121 includes a protruding portion 1211 and a supporting portion 1212. The protruding portion 1211 is located near an end of the second shell 12 near the connection component 13. The supporting portion 1212 is located near another end of the second shell 12 away from the connection component 13. The supporting portion 1212 extends towards the protruding portion 1211 and is connected to the protruding portion 1211. The protruding portion 1211 protrudes towards the first shell 11 and the connection component 13. The thickness of the supporting portion 1212 gradually increases along the extending direction of the supporting portion 1212, and the maximum thickness of the supporting portion 1212 is less than or equal to the minimum thickness of the protruding portion 1211. That is, the fixing component 121 is provided with the protruding portion 1211 and the supporting portion 1212 each being fixed to the second shell 12 and protruding towards the first shell 11. In the protruding/extending direction of each of the protruding portion 1211 and the supporting portion 1212 towards the first shell 11, the thickness of the protruding portion 1211 is greater than that of the supporting portion 1212, and the thickness of the supporting portion 1212 increases and smoothly connects to the position where the thickness of the protruding portion 1211 is the smallest. At the same time, at the end of the protruding portion 1211 away from the supporting portion 1212, the protruding portion 1211 also protrudes towards the connection component 13. At this time, the protruding portion 1211 forms a hook-shaped structure on the fixing component 121. When the ear-clip earphone 1 is clamped on the ear, the protruding portion 1211 can be hooked onto the ear bone, thereby further improving the wearing stability of the ear-clip earphone on the ear.

Here, the end of the second shell 12 away from the connection component 13 may be the end of the second shell 12 away from the middle of the connection component 13. The end of the second shell 12 near the connection component 13 may be the end of the second shell 12 near the middle of the connection component 13. Here, the protruding portion 1211 protrudes towards the connection component 13, which means that the protruding portion 1211 protrudes towards the middle of the connection component 13. The end of the second shell 12 away from the connection component 13 may also be the end of the second shell 12 away from the connection portion 310 of the connection component 13. The end of the second shell 12 near the connection component 13 may also be the end of the second shell 12 near the connection portion 310 of the connection component 13. Here, the protruding portion 1211 protrudes towards the connection component 13, which may also mean that the protruding portion 1211 protrudes towards the connection portion 310 of the connection component 13 (see FIG. 6).

The embodiment of the present disclosure arranges the protruding portion to protrude towards the connection component, thereby forming a hook-shaped fixing component. When the ear-clip earphone is worn on the ear, the fixing component can be hooked onto the ear bone, thereby further improving the wearing stability of the ear-clip earphone on the ear and optimizing the performance of the product.

In some embodiments, as shown in FIG. 4, a minimum opening of the gap C between the protruding portion 1211 and the first shell 11 is 0.4 mm to 6.5 mm. Alternatively, the maximum thickness A of the protruding portion 1211 is 0.4 mm to 5.5mm. Alternatively, the minimum opening of the gap C between the protruding portion 1211 and the first shell 11 is 0.4 mm to 6.5 mm, and the maximum thickness A of the protruding portion 1211 is 0.4 mm to 5.5 mm.

It can be understood that the minimum opening of the gap C between the protruding portion 1211 and the first shell 11 is the minimum width of the clamping gap 14 when the ear-clip earphone is in a natural state, and the minimum opening of the gap C satisfies: 0.4 mm<C<6.5 mm. By limiting the width of the clamping gap 14, the ear-clip earphone 1 can have a sufficient clamping force for clamping the ear. In some examples, the maximum thickness A of the protruding portion 1211 can also be limited to satisfy: 0.4 mm<A<5.5 mm. Thus, the fixing component 121 can form a hook-shaped structure, so that the fixing component 121 can be hooked onto the ear bone, thereby improving the wearing stability of the ear-clip earphone 1 on the ear.

The embodiment of the present disclosure limits the size of the protruding portion to always maintain a sufficient clamping force between the first shell and the second shell. At the same time, the thickness of the protruding portion can form a hook-shaped structure on the fixing component, which ensures that the fixing component can be stably hooked onto the ear bone, thereby improving the wearing stability of the ear-clip earphone on the ear and optimizing the performance of the product.

In some embodiments, as shown in FIG. 4, in the direction from the end of the fixing component 121 away from the connection component 13 towards the end of the fixing component 121 closer to the connection component 13, a straight distance B between the protruding portion 1211 and the connection component 13 is 5 mm to 22 mm. It can be understood that the straight distance B is a distance between the end of the protruding portion 1211 near the connection component 13 and the connection component 13, and 5 mm<B<22mm. The straight distance between the protruding portion 1211 and the connection component 13 is limited within an appropriate range, so that the hook-shaped structure formed by the fixing component 121 can be hooked onto the ear bone, which prevents the problem of the ear-clip earphone 1 from being too large or too small caused by a too large or too small distance between the protruding portion 1211 and the connection component 13, and the above problem may make the hook-shaped structure difficult to be hooked onto the ear bone.

The embodiment of the present disclosure further optimizes the size of the ear-clip earphone by limiting the straight distance between the protruding portion 1211 and the connection component 13 within an appropriate range, so that the fixing component can improve the clamping stability of the ear-clip earphone on the ear, ensure the implementation of functions, and improve the performance of the product.

In some embodiments, as shown in FIG. 4, at least a portion of the supporting portion 1212 is located at the contour edge of the second shell 12, and the maximum size E of the second shell 12 is 5 mm to 16 mm. That is, at least a portion of the supporting portion 1212 is set at the edge of the second shell 12, thereby forming a portion of the contour edge of the second shell 12. By limiting the maximum size E of the outer contour of the second shell 12 to satisfy: 5 mm<E<16 mm, the size of the product can be reasonably designed to provide a suitable space inside the second shell 12 for installing the sound emitting assembly 120. This not only meets the assembly requirement, but also ensures that the overall size of the second shell 12 will not be too large, resulting in a better appearance.

The embodiment of the present disclosure limits the size of the second shell to provide a sufficient space inside the second shell for installing relevant component. Also, the size of the second shell is not too large, thereby improving the space utilization of the second shell, optimizing product size, and enhancing user’s experience.

In some embodiments, as shown in FIG. 1, the connection component 13 is an elastic body. Two ends of the connection component 13 can extend elastically outward by a distance from 0 mm to 12 mm. It can be understood that the connection component 13 can be arched, and the first shell 11 and the second shell 12 are connected to the two ends of the arch. The connection component 13 can be elastically deformed. Under the external force, the first shell 11 and the second shell 12 can move outward together with the elastic deformation of the connection component 13. Thus, the distance between the first shell 11 and the second shell 12 increases, making it easier for the ear bone to enter the space therebetween. After the external force is removed, the connection component 13 rebounds, the shape of the connection component 13 changes, and the first shell 11 and the second shell 12 have a tendency to return to the initial state. Since the first shell 11 and the second shell 12 are located at the back side and the front side of the ear bone, respectively, the first shell 11 and the second shell 12 will be stably clamped on the ear, thereby ensuring a stable connection between the ear-clip earphone 1 and the ear. At this point, by limiting the deformation size of the connection component 13 to be 0 mm to 12mm, the first shell 11 and the second shell 12 can be sufficiently deformed to facilitate the fixing of the ear-clip earphone.

The embodiment of the present disclosure limits the size of the elastic deformation of the connection component, thereby allowing the distance between the first and second shells to change to enable the ear-clip earphone to be clamped on the ear, avoiding detachment during use caused by unstable connection between the ear-clip earphone and the ear, ensuring stable clamping, and further optimizing the performance of the product.

In some embodiments, the fixing component 121 is an elastic rubber component. Alternatively, the fixing component 121 has an airbag inside. Alternatively, the fixing component 121 is an elastic rubber component, and the fixing component 121 has an airbag inside. It can be understood that when the fixing component 121 is made of soft rubber with certain elasticity and tactile sensation, the fixing component 121 can be deformed with the contour of the human ear in the worn state, thereby allowing the fixing component 121 to fully fit the ear. In addition, the airbag may be installed inside the fixing component 121 to provide elasticity and optimize the tactile sensation in the worn state.

The fixing component according to the embodiment of the present disclosure is an elastic rubber component and/or equipped with an airbag inside, thereby allowing the fixing component to have a certain degree of elasticity. Thus, the fixing component may fit the contour of the ear in the worn state. The ear may also have a good tactile sensation when being in contact with the fixing component, thereby improving the user’s tactile sensation, enhancing the wearing comfort, and optimizing the performance of the product.

In some embodiments, in the wearing state, the protruding portion 1211 at least partially extends into the inner side of the ear bone. It can be understood that the protruding portion 1211 has a portion that protrudes towards the connection component 13. In the wearing state, the fixing component 121 is clamped on one side of the ear bone, and the portion protruding towards the connection component 13 can extend into the inner side of the ear bone. Thus, the ear-clip earphone is hooked onto the ear bone, thereby improving the wearing stability and the wearing stability of the ear-clip earphone on the ear.

Here, the protruding portion 1211 may have a portion protruding towards the middle of the connection component 13. Alternatively, the protruding portion 1211 may also have a portion protruding towards the connection portion 310 of the connection component 13 (see FIG. 6).

The protruding portion according to the embodiment of the present disclosure extends into the inner side of the ear bone, to hook the hook-shaped protruding portion onto the ear bone, thereby further improving the wearing stability of the ear-clip earphone, making it difficult to be separated from the ear, and improving the user’s experience.

In some embodiments, as shown in FIG. 2, a wire channel 131 is defined inside the connection component 13. A wire 15 is routed through the wire channel 131, and the two ends of the wire 15 are connected to the power supply assembly 110 and the sound emitting assembly 120, respectively, such that the power supply assembly 110 supplies electric power at least to the sound emitting assembly 120. It can be understood that when the ear-clip earphone 1 is clamped on the ear, the second shell 12 is located at the front side of the ear, and the sound emitting assembly 120 is received in the second shell 12 such that the ear can receive sound from the sound emitting assembly 120. The power supply assembly 110 is received in the first shell 11. The connection component 13 defines the wire channel 131 therein. The wire 15 is routed through the wire channel 131 to connect the sound emitting assembly 120 and the power supply assembly 110. The power supply assembly 110 supplies electric power to the sound emitting assembly 120 through the wire 15 in the connection component 13 to ensure the normal function of the ear-clip earphone.

The embodiment of the present disclosure provides the wire channel in the connection component, and the wire extends through the wire channel and connects the power supply assembly to the sound emitting assembly. The wire channel is used to protect the wire, which can extend the service life of the relevant components and improve the performance of the product.

In some embodiments, as shown in FIGS. 1 and 2, a receiving chamber 122 is defined inside the second shell 12. The sound emitting assembly 120 is received inside the receiving chamber 122. The second shell 12 further defines multiple sound outlets 123 that face different directions and communicate with the receiving chamber 122. That is, the sound emitting assembly 120 is received in the receiving chamber 122 inside the second shell 12, and the sound outlets 123 are further defined on the second shell 12 and communicate with the receiving chamber 122. The sound from the sound emitting assembly 120 can be transmitted from the sound outlet 123 to the outside of the receiving chamber 122, thereby achieving sound transmission to the ear. At the same time, the sound outlets 123 may be multiple that face different directions, thereby increasing the direction of sound propagation and improving the quality of sound transmission, so that user can listen more clearly.

The embodiment of the present disclosure defines multiple sound outlets on the second shell to ensure normal propagation of sound from the sound emitting assembly. At the same time, the multiple sound outlets face different directions, thereby further increasing the clarity of the sound produced by the ear-clip earphone, improving the quality of the product, and enhancing the user’s experience.

In some embodiments, as shown in FIGS. 1 and 2, the ear-clip earphone 1 further includes a button 16, a charge connector 17, and a decorative component 18. The button 16 is arranged on the first shell 11 and connected to the power supply assembly 110. The button 16 is at least used to control the power supply function of the power supply assembly 110. The charge connector 17 is arranged on the first shell 11 and connected to the power supply assembly 110 to charge the power supply assembly 110. The decorative component 18 is at least installed on the second shell 12 and located at the side away from the first shell 11.

It can be understood that the first shell 11 is provided with the button 16, such that the power supply assembly 110 in the first shell 11 can be controlled through the button 16 to achieve on and off control of the ear-clip earphone 1. The first shell 11 can also be equipped with the charge connector 17, which can connect an external power source to the power supply assembly 110 inside the first shell 11. The charge connector 17 can be used to charge the power supply assembly 110, thereby ensuring the sustainable use of the ear-clip earphone 1. The second shell 12 can also be equipped with the decorative component 18 to improve the appearance of the ear-clip earphone 1 and optimize the user’s experience.

The embodiment of the present disclosure provides the button and the charge connector on the first shell, thereby facilitating the control of the working state of the power supply assembly in the first shell, simplifying the product structure, and facilitating the user operation. At the same time, the decorative component can improve the appearance of the product, so that the product has a good appearance to optimize the user’s experience.

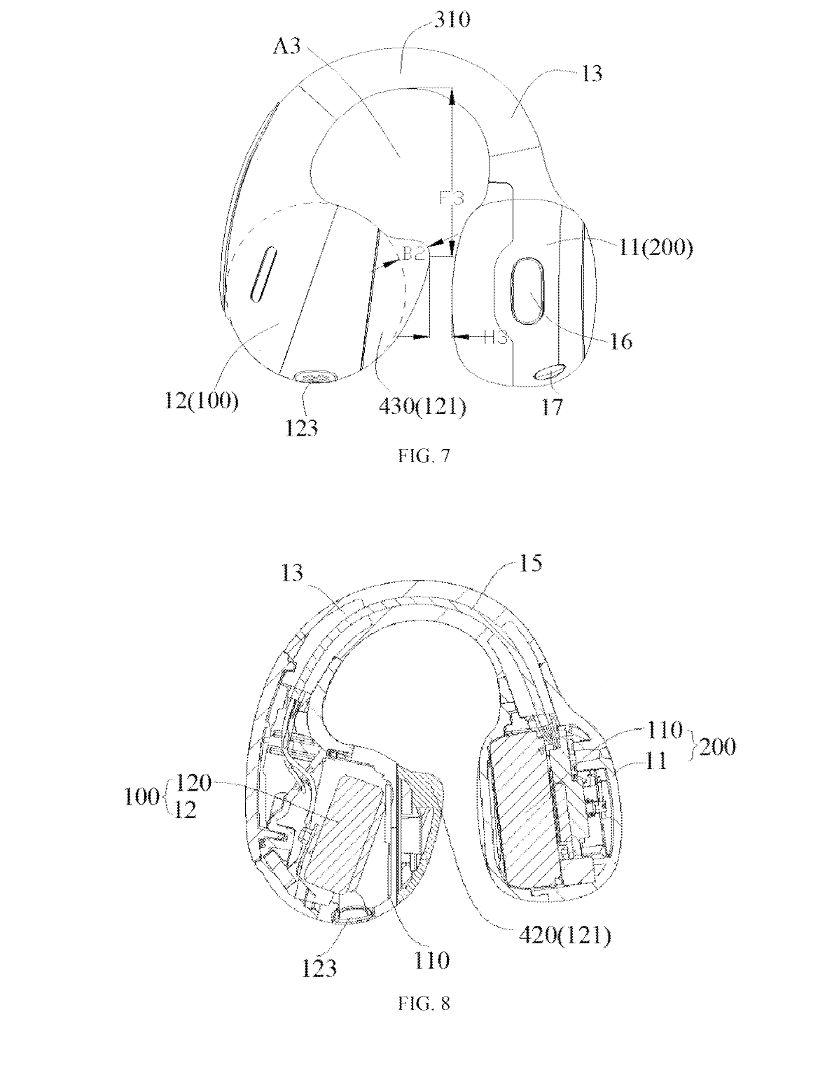

In some embodiments, as shown in FIGS. 2 and 8, the sound emitting assembly 120 can generate audio, so the sound emitting assembly 120 can also be referred to as an audio assembly. As shown in FIGS. 1 and 6, the fixing component 121 is used to cooperate with the ear bone of the user, so the fixing component 121 can also be referred to as a fitting body. The charge connector 17 is used for charging, so the charge connector 17 can also be referred to as a charge portion. As shown in FIGS. 2 and 8, the power supply assembly 110 is used to supply electric power to the ear-clip earphone, so the power supply assembly 110 can also be referred to as a battery assembly. As shown in FIGS. 1 and 6, the connection component 13 is connected to the first shell 11 and the second shell 12, respectively, so the connection component 13 can also be referred to as a connection body.

In some embodiments, the fixing component 121 can be detachably connected to the side of the second shell 12 facing the first shell 11, and the fixing component 121 is used to cooperate with the ear bone. When the fixing component 121 is damaged, the user can replace the fixing component 121 with a new one without the need to replace the whole earphone, thereby improving the adaptability of the earphone. Of course, in other embodiments, the fixing component 121 may also be fixedly connected to the side of the second shell 12 facing the first shell 11.

In the wearing state, a clamping space is formed between the first shell 11 and the second shell 12, and the helix of the user is located in the clamping space. The first shell 11 is located at the back side of the helix, and the second shell 12 is located at the front side of the helix. The second shell 12 corresponds to the position of the cavity of auricular concha of the user, so that audio can be transmitted to the ear canal. The fixing component 121 can come into contact with the ear bone of the user to improve the wearing stability of the ear-clip earphone.

In some embodiments, the ear-clip earphone may include a first body 200, an audio body 100, a connection component 13, and a fixing component 121. The first body 200 includes the first shell 11 and the power supply assembly 110 located inside the first shell 11. The audio body 100 may include a second shell 12 and a sound emitting assembly 120 located inside the second shell 12. The second shell 12 is spaced apart from the first shell 11. The power supply assembly 110 is used to supply electric power to the sound emitting assembly 120. The connection component 13 includes a first end and a second end. The second shell 12 is connected to the first end of the connection component 13, and the first shell 11 is connected to the second end of the connection component 13. The fixing component 121 is detachably connected to the side of the second shell 12 facing the first shell 11 and used to cooperate with the ear bone of the user.

In the wearing state, a clamping space is formed between the first body 200 and the audio body 100. The helix of the user is located in the clamping space. The first body 200 is located at the back side of the helix, and the audio body 100 is located at the front side of the helix. The audio body 100 corresponds to the position of the cavity of auricular concha of the user, so that the audio generated by the audio body 100 can be transmitted to the ear canal. The fixing component 121 can come into contact with the ear bone of the user to improve the wearing stability of the ear-clip earphone.

The inventors of the present disclosure have found that when the fitting structure of the ear-clip earphone is damaged, the user needs to use the ear-clip earphone with the damaged fitting structure, resulting in poor adaptability of the ear-clip earphone. However, the ear-clip earphone disclosed herein has the fixing component 121 that can be detachably connected to the side of the second shell 12 facing the first shell 11. Thus, when the fixing component 121 is damaged, the user can replace the fixing component 121 with a new one without the need to replace the whole ear-clip earphone, thereby improving the adaptability of the ear-clip earphone.

In the embodiment of the present disclosure, the structure of the first body 200 is not limited. For example, the first body 200 may be block-shaped. The first body 200 may also be strip-shaped.

The structure of the first shell 11 is not limited. For example, the first shell 11 may be strip-shaped or block-shaped. Here, the first shell 11 may also be equipped with the charge connector 17, which is used to charge the power supply assembly 110. The charge connector 17 may be a charging pin. Here, the first shell 11 may also be equipped with the button 16.

In the embodiment of the present disclosure, as shown in FIG. 8, the audio body 100 may include the second shell 12 and the sound emitting assembly 120 located inside the second shell 12. The shape of the second shell 12 is not limited. For example, the second shell 12 may be strip-shaped or block-shaped. For example, the second shell 12 may have a spherical structure. The structure of the sound emitting assembly 120 is not limited. For example, the sound emitting assembly 120 may include a sound emitter. The structure of the emitter is not limited. For example, the emitter may be a speaker. Here, the second shell 12 may also have the sound outlets 123 for guiding the sound from the sound emitter out. For example, the sound emitting assembly 120 may also include a sound collector. The structure of the sound collector is not limited. For example, the sound collector may be a microphone. Here, the second shell 12 may also have a sound collection hole, so that the sound collector can receive the external sound from the sound collection hole.

In the embodiment of the present disclosure, the structure of the connection component 13 is not limited. For example, the connection component 13 may be made of a material having elasticity, so that the distance between the first body 200 and the audio body 100 can be adjusted through the elasticity of the connection component 13. Thus, it is convenient for wearing the ear-clip earphone on the ear of the user and for removing the ear-clip earphone in the wearing state from the ear. For example, the connection component 13 may be made of a material such as silicone, thermoplastic polyurethane (TPU), or thermoplastic elastomer (TPE). Here, a steel wire may be installed inside the connection component 13 to enhance the strength of the connection component 13.

The second end of connection component 13 can be fixed to the first shell 11 such as by clamping, welding, and gluing. The first end of the connection component 13 can be fixed to the second shell 12 such as by clamping, welding, and gluing. For example, the ear-clip earphone may also include the wire 15 set inside the connection component 13, so that the power supply assembly 110 and the sound emitting assembly 120 are electrically connected to each other through the wire 15.

Here, the connection component 13 may include the connection portion 310 that corresponds to the position of the helix of the user. In the wearing state, the connection portion 310 may be in contact with the helix or spaced from the helix.

In the embodiment of the present disclosure, the quantity of the fixing component(s) 121 may be one. The quantity of the fixing component(s) 121 may also be at least two.

The at least two fixing components 121 may be the same or different from each other. By setting the at least two fixing components 121, it is possible to replace one fixing component 121 with a new one timely when the fixing component 121 is damaged.

As an example, the characteristic parameters of the at least two fixing components 121 may be different from each other, so that the at least two fixing components 121 are also different from each other.

The inventors of the present disclosure have found that the ear-clip earphone is fixed on the ear by clamping, but the adaptability of the ear-clip earphone may be poor since the ear-clip earphone has only a single structure. However, the ear-clip earphone according to the present disclosure may include at least two fixing components 121 having different characteristic parameters. Here, when a different one of the fixing components is detachably connected to the side of the second shell 12 facing the first shell 11, the ear-clip earphone has a different form, thereby making the structure of the ear-clip earphone to be diverse and improving the adaptability of the ear-clip earphone.

Here, the type of the characteristic parameter is not limited. For example, the characteristic parameters may include at least one of shape, size, and hardness. For example, the characteristic parameter may include shape, namely, the at least two fixing components 121 have different shapes so that the ear-clip earphone can adapt to users with different ear sizes, thereby improving the adaptability of the ear-clip earphone. For example, the characteristic parameter may include size, namely, the at least two fixing components have different sizes so that the ear-clip earphone can adapt to users with different ear sizes, thereby improving the adaptability of the ear-clip earphone. The shapes of the fixing components may be the same or different from each other. As another example, the characteristic parameter may include hardness, namely, the at least two fixing components have different hardnesses so that the ear-clip earphone can adapt to the needs of different wearers, thereby improving the adaptability of the ear-clip earphone. In a specific application, the at least two fixing components are made of different materials, so that the hardnesses of the at least two fixing components are different from each other. As yet another example, the characteristic parameter may include all of shape, size, and hardness. As yet another example, the characteristic parameter may include two of shape, size, and hardness.

The quantity of the at least two fixing components 121 is not limited. For example, the at least two fixing components may include two fixing components. Here, the at least two fixing components may include a first fixing component 410 and a second fixing component 420 with different characteristic parameters. For example, the at least two fixing components may include three fixing components. Here, the at least two fixing components may include a first fixing component 410, a second fixing component 420, and a third fixing component 430 with different characteristic parameters. The first fixing component 410, the second fixing component 420, and the third fixing component 430 may also be referred to as a first elastic component, a second elastic component, and a third elastic component.

The position of the fixing component 121 is not limited. For example, as shown in FIGS. 5, 6, and 7, the second shell 12 of the audio body 100 is provided with the sound outlets 123, which are located at the end of the second shell 12 away from the connection portion 310. The fixing component is located between the connection portion 310 and the sound outlets 123, so that the sound outlets 123 are closer to the ear of the user, and the fixing component 121 is closer to the ear bone of the user.

The fixing component 121 and the second shell 12 can be detachably connected to each other such as by a clamping structure, a threaded structure, a magnetic adsorption structure, etc. For example, the magnetic adsorption structure may include a first adsorption component and a second adsorption component. The first adsorption component is disposed on the second shell 12, and the second adsorption component is disposed on the fixing component. There is a magnetic adsorption force between the first adsorption component and the second adsorption component, and the polarities of the first adsorption component and the second adsorption component may be opposite to each other. One of the first adsorption component and the second adsorption component may have magnetism, and the other of the first adsorption component and the second adsorption component may be made of iron. Here, the first adsorption component and the second adsorption component can be exposed or shielded.

The material of the fixing component is not limited. For example, the fixing component can be made of an elastic material to form a soft structure. When the fixing component comes into contact with the ear of the user, the fixing component with a soft structure can improve the wearing comfort of the ear-clip earphone. For example, the fixing component may be made of a material such as silicone, thermoplastic polyurethane (TPU), or thermoplastic elastomer (TPE). For example, the fixing component may include a skeleton part and a fitting part. The skeleton part is detachably connected to the second shell 12, and the fitting part is set on the side of the skeleton part facing the first shell 11 and can come into contact with the user. Here, the skeleton part and the second shell 12 can be detachably connected to each other such as by a clamping structure, a threaded structure, and a magnetic adsorption structure. Here, the fitting part may be connected to the skeleton part such as by gluing, welding, clamping, etc. Here, the hardness of the skeleton part may be greater than that of the fitting part, thereby improving the connection stability between the fitting part and the second shell 12 through the skeleton part and the wearing comfort of the fixing component through the fitting part. Here, the skeleton may be made of a material such as plastic. Here, the fitting part may be made of an elastic material.

In some embodiments of the present disclosure, the quantity of the fixing component(s) 121 is at least two, and the at least two fixing components 121 are detachably connected to the side of the second shell 12 facing the first shell 11, respectively. The at least two fixing components 121 and the first shell 11 form different forms of the ear-clip earphone to improve the adaptability of the ear-clip earphone.

In one embodiment, the at least two fixing components 121 have different characteristic parameters.

In one embodiment, when one of the at least two fixing components 121 is detachably connected to the side of the second shell 12 facing the first shell 11, the fixing component 121 of the at least two fixing components 121 and the first shell 11 forms the ear-clip earphone with a specific form. When another of the at least two fixing components 121 is detachably connected to the side of the second shell 12 facing the first shell 11, the fixing component 121 of the at least two fixing components 121 and the first shell 11 forms the ear-clip earphone with another specific form. That is, the two forms of the ear-clip earphone are different from each other to improve the adaptability.

The implementation manner of the two forms of the ear-clip earphone is not limited. For example, when a different one of the at least two fixing components 121 is detachably connected to the side of the second shell 12 facing the first shell 11, the gap between each fixing component 121 and the first shell 11 is different, so that the ear-clip earphone can adapt to the users with different ear sizes. For example, when a different one of the at least two fixing components 121 is detachably connected to the side of the second shell 12 facing the first shell 11, the space defined among each fixing component 121, the first shell 11, the second shell 12, and the connection component 13 is different, so that the ear-clip earphone can adapt to the users with different ear sizes. For example, when a different one of the at least two fixing components 121 is detachably connected to the side of the second shell 12 facing the first shell 11, the distance from the end of each fixing component 121 closest to the first shell 11 to the connection portion 310 is different, so that the ear-clip earphone can adapt to the users with different ear sizes.

In one embodiment, the at least two fixing components may include a first fixing component 410, a second fixing component 420, and a third fixing component 430. In order to improve the adaptability of the ear-clip earphones, three forms of the ear-clip earphone can be provided.

In the embodiment, the characteristic parameters of the first fixing component 410, the second fixing component 420, and the third fixing component 430 are different from each other.

The first example is that when the first fixing component 410 is detachably connected to the side of the second shell 12 facing the first shell 11, there is a first gap H1 between the first fixing component 410 and the first shell 11 as shown in FIG. 5. When the second fixing component 420 is detachably connected to the side of the second shell 12 facing the first shell 11, there is a second gap H2 between the second fixing component 420 and the first shell 11 as shown in FIG. 6. When the third fixing component 430 is detachably connected to the side of the second shell 12 facing the first shell 11, there is a third gap H3 between the third fixing component 430 and the first shell 11 as shown in FIG. 7. The value of the first gap H1 is greater than the value of the second gap H2, and the value of the second gap H2 is greater than the value of the third gap H3. By setting different gaps between the fixing components and the first shell 11, the ear-clip earphone can adapt to the users with different ear sizes.

Here, the first fixing component 410 is suitable for the users with thick ears, the second fixing component 420 is suitable for the users with normal thick ears, and the third fixing component 430 is suitable for the users with thin ears.

Here, the sizes of the first fixing component 410, the second fixing component 420, and the second fixing component 420 are different from each other. The shapes of the first fixing component 410, the second fixing component 420, and the second fixing component 420 may be the same or different from each other. The hardnesses of the first fixing component 410, the second fixing component 420, and the second fixing component 420 may be the same or different from each other.

The second example is that when the first fixing component 410 is detachably connected to the side of the second shell 12 facing the first shell 11, there is a first distance F1 from the end of the first fixing component 410 closest to the first shell 11 to the connection portion 310 as shown in FIG. 5. When the second fixing component 420 is detachably connected to the side of the second shell 12 facing the first shell 11, there is a second distance F2 from the end of the second fixing component 420 closest to the first shell 11 to the connection portion 310 as shown in FIG. 6. When the third fixing component 430 is detachably connected to the side of the second shell 12 facing the first shell 11, there is a third distance F3 from the end of the third fixing component 430 closest to the first shell 11 to the connection portion 310 as shown in FIG. 7. The value of the first distance F1 is greater than the value of the second distance F2, and the value of the second distance F2 is greater than the value of the third distance F3. By setting different distances between the fixing components and the connection portion 310, the ear-clip earphone can adapt to the users with different ear sizes.

Here, the first fixing component 410 is suitable for the users with large ears, the second fixing component 420 is suitable for the users with normal size ears, and the third fixing component 430 is suitable for the users with small ears.

Here, the sizes of the first fixing component 410, the second fixing component 420, and the second fixing component 420 are different from each other. The shapes of the first fixing component 410, the second fixing component 420, and the second fixing component 420 may be the same or different from each other. The hardnesses of the first fixing component 410, the second fixing component 420, and the second fixing component 420 may be the same or different from each other.

The third example is that when the first fixing component 410 is detachably connected to the side of the second shell 12 facing the first shell 11, the first fixing component 410 and the second shell 12 form a spherical structure as shown in FIG. 5. When the second fixing component 420 is detachably connected to the side of the second shell 12 facing the first shell 11, a first portion of the second fixing component 420 and the second shell 12 cooperatively form a spherical structure, and a second portion of the second fixing component 420 protrudes from the spherical structure as shown in FIG. 6. When the third fixing component 430 is detachably connected to the side of the second shell 12 facing the first shell 11, a first portion of the third fixing component 430 and the second shell 12 cooperatively form a spherical structure, and a second portion of the third fixing component 430 protrudes from the spherical structure as shown in FIG. 7. The height B2 of the second portion of the third fixing component 430 protruding from the respective spherical structure is greater than the height B1 of the second portion of the second fixing component 420 protruding from the respective spherical structure.

Here, the first fixing component 410 is suitable for the users with thick ears, the second fixing component 420 is suitable for the users with normal thick ears, and the third fixing component 430 is suitable for the users with thin ears.

Here, the sizes of the first fixing component 410, the second fixing component 420, and the second fixing component 420 are different from each other. The shapes of the first fixing component 410, the second fixing component 420, and the second fixing component 420 are different from each other. The hardnesses of the first fixing component 410, the second fixing component 420, and the second fixing component 420 may be the same or different from each other.

The fourth example is that when the first fixing component 410 is detachably connected to the side of the second shell 12 facing the first shell 11, the first fixing component 410, the first shell 11, the second shell 12, and the connection component 13 cooperatively define a first space A1 as shown in FIG. 5. When the second fixing component 420 is detachably connected to the side of the second shell 12 facing the first shell 11, the second fixing component 420, the first shell 11, the second shell 12, and the connection component 13 cooperatively define a second space A2 as shown in FIG. 6. When the third fixing component 430 is detachably connected to the side of the second shell 12 facing the first shell 11, the third fixing component 430, the first shell 11, the second shell 12, and the connection component 13 cooperatively define a third space A3 as shown in FIG. 7. The first space A1 is larger than the second space A2, and the second space A2 is larger than the third space A3.

Here, the first space A1, the second space A2, and the third space A3 are used to receive the ear of the user. By forming spaces of different sizes through different fixing components, the ear-clip earphone can adapt to the users with different ear sizes.

Here, the first fixing component 410 is suitable for the users with large ears, the second fixing component 420 is suitable for the users with normal sized ears, and the third fixing component 430 is suitable for the users with small ears.

Here, the sizes of the first fixing component 410, the second fixing component 420, and the second fixing component 420 may be the same or different from each other. The shapes of the first fixing component 410, the second fixing component 420, and the second fixing component 420 may be the same or different from each other. The hardnesses of the first fixing component 410, the second fixing component 420, and the second fixing component 420 may be the same or different from each other.

Here, the implementation manner of forming spaces of different sizes by the fixing components is not limited. For example, the manner described in at least one of the first to third examples mentioned above may be used to form spaces of different sizes by the fixing components. As an example, the fixing components form spaces of different sizes by three manners mentioned in the first to third examples.

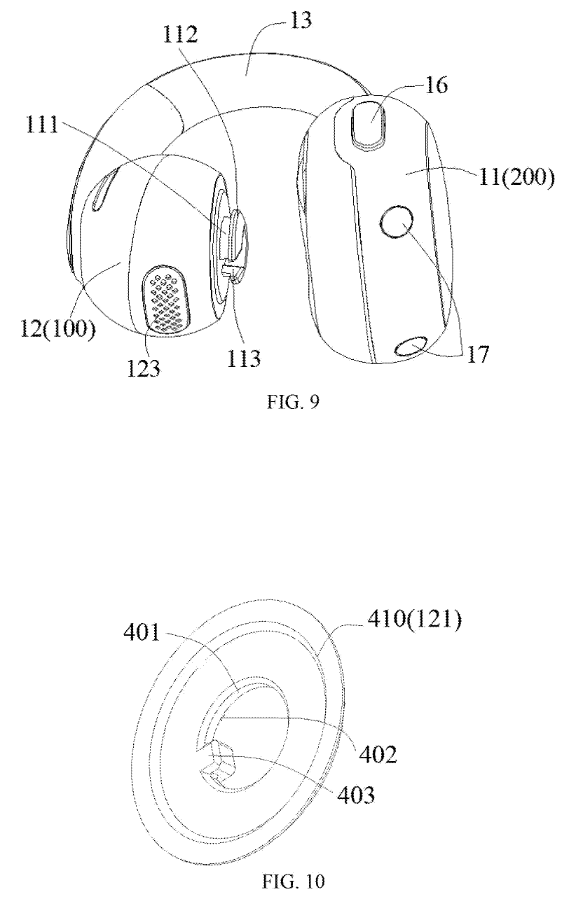

In some embodiments of the present disclosure, the side of the second shell 12 facing the first shell 11 has a convex portion 111 and a flange 112 located at a top of the convex portion 111 as shown in FIG. 9. The fixing component has a groove 401 for receiving the convex portion 111 and an annular slot 402 located on a bottom side of the groove 401 as shown in FIGS. 10, 11, and 12. The flange 112 is detachably clamped in the annular slot 402. By detachably clamping the flange 112 in the annular slot 402, the fixing component can be detachably connected to the side of the second shell 12 facing the first shell 11.

In one embodiment, the shape of the convex portion 111 is not limited. For example, the convex portion 111 may be cylindrical. For example, the convex portion 111 may also be annular.

In one embodiment, the shape of the groove 401 is not limited. For example, the groove 401 may be cylindrical.

In one embodiment, the convex portion 111 may define a limiting slot 113. The sidewall of the groove 401 may be provided with a limiting protrusion 403 inserted into the limiting slot 113. By inserting the limiting protrusion 403 into the limiting slot 113, the orientation of the fixing component relative to the second shell 12 can be limited.

In one embodiment, when the fixing component includes the skeleton part and the fitting part, the skeleton part may have the groove 401 for receiving the convex portion 111 and the annular slot 402 located on the bottom side of the groove 401.

In some embodiments, the sound emitting assembly is referred to as an audio assembly, and the fixing component is referred to as a fitting body. Thus, the first fixing component can be referred to as a first fitting body, the second fixing component can be referred to as a second fitting body, and the third fixing component can be referred to as a third fitting body. The charge connector is referred to as a charge portion. The power supply assembly is referred to as a battery assembly. The connection component is referred to as a connection body.

The ear-clip earphone according to the embodiment of the present disclosure will be described in detail with reference to FIGS. 5 to 12.

In the embodiment of the present disclosure, the ear-clip earphone includes a first body 200, an audio body 100, a connection component (connection body) 13, and a fixing component (fitting body) 121. The first body 200 includes a first shell 11 and a power supply assembly 110 located inside the first shell 11. The audio body 100 includes a second shell 12 and a sound emitting assembly (audio assembly) 120 located inside the second shell 12. The second shell 12 is spaced apart from the first shell 11. The power supply assembly 110 is used to supply electric power to the sound emitting assembly 120. The connection component 13 includes a first end and a second end. The second shell 12 is connected to the first end of the connection component 13, and the first shell 11 is connected to the second end of the connection component 13. The fixing component (fitting body) 121 is detachably connected to the side of the second shell 12 facing the first shell 11 and used to cooperate with the ear bone of the user.

In the wearing state, a clamping space is formed between the first body 200 and the audio body 100, and the helix of the user is located in the clamping space. The first body 200 is located at the back side of the helix, and the audio body 100 is located at the front side of the helix. The audio body 100 corresponds to the position of the cavity of auricular concha of the user, so that audio generated by the audio body 100 can be transmitted to the ear canal. The fixing component 121 can come into contact with the ear bone of the user to improve the wearing stability of the ear-clip earphone.

The inventors of the present disclosure have found that when the ear-clip earphone includes an earphone body and a fitting structure integrally formed with the earphone body, the fitting structure cannot be removed from the earphone body. The fitting structure of the ear-clip earphone may be easily damaged, and when the fitting structure of the ear-clip earphone is damaged, the whole ear-clip earphone needs to be replaced, or the user needs to use the ear-clip earphone with the damaged fitting structure, resulting in poor adaptability of the ear-clip earphone. However, the ear-clip earphone of the present disclosure includes the detachable fixing component 121 provided on the side of the second shell 12 facing the first shell 11. When the fixing component 121 is damaged, the user can replace the fixing component 121 with a new one without the need to replace the whole ear-clip earphone, thereby improving the adaptability of the ear-clip earphone.

In the embodiment of the present disclosure, the structure of the first body 200 is not limited. For example, the first body 200 may be block-shaped. For example, the first body 200 may also be strip-shaped.

The structure of the first shell 11 is not limited. For example, the first shell 11 may be strip-shaped or block-shaped. Here, the first shell 11 may also be equipped with the charge connector (charge portion) 17, which is used to charge the power supply assembly (battery assembly) 110. The charge connector 17 may be a charging pin. Here, the first shell 11 may also be equipped with the button 16.

In the embodiment of the present disclosure, as shown in FIG. 8, the audio body 100 includes the second shell 12 and the sound emitting assembly 120 located inside the second shell 12. The shape of the second shell 12 is not limited. For example, the second shell 12 may be strip-shaped or block-shaped. For example, the second shell 12 may have a spherical structure. The structure of the sound emitting assembly 120 is not limited. For example, the sound emitting assembly 120 may include a sound emitter. The structure of the sound emitter is not limited. For example, the sound emitter may be a speaker. Here, the second shell 12 may also have the sound outlets 123 for guiding the sound from the sound emitter out. For example, the sound emitting assembly 120 may also include a sound collector. The structure of the sound collector is not limited. For example, the sound collector may be a microphone. Here, the second shell 12 may also have a sound collection hole, so that the sound collector can receive external sound from the sound collection hole.

In the embodiment of the present disclosure, the structure of the connection component 13 is not limited. For example, the connection component 13 may be made of a material having elasticity, so that the distance between the first body 200 and the audio body 100 can be adjusted through the elasticity of the connection component 13. Thus, it is convenient for wearing the ear-clip earphone on the ear of the user and for removing the ear-clip earphone in the wearing state from the ear. For example, the connection component 13 may be made of a material such as silicone, thermoplastic polyurethane (TPU), or thermoplastic elastomer (TPE). Here, a steel wire may be installed inside the connection component 13 to enhance the strength of the connection component 13.

The second end of the connection component 13 can be fixed to the first shell 11 such as by clamping, welding, and gluing. The first end of the connection component 13 can be fixed to the second shell 12 such as by clamping, welding, and gluing. For example, the ear-clip earphone may also include the wire (connection wire) 15 set inside the connection component 13, so that the power supply assembly 110 and the sound emitting assembly 120 are electrically connected to each other through the wire 15.

Here, the connection component 13 may include the connection portion 310 that corresponds to the helix of the user. In the wearing state, the connection portion 310 may be in contact with the helix or spaced from the helix.

In the embodiment of the present disclosure, the quantity of the fixing components (fitting bodies) 121 may be one. The quantity of the fixing components 121 may also be at least two.

The at least two fixing components 121 may be the same or different from each other. By setting the at least two fixing components 121, it is possible to replace one fixing component 121 with a new one timely when the fixing component 121 is damaged.

As an example, the characteristic parameters of the at least two fixing components 121 may be different from each other, so that the at least two fixing components 121 are also different from each other.

The inventors of the present disclosure have found that the ear-clip earphone is fixed on the ear by clamping, but the adaptability of the ear-clip earphone may be poor since the ear-clip earphone has only a single structure. However, the ear-clip earphone according to the present disclosure may include at least two fixing components 121 having different characteristic parameters. Here, when a different one of the fixing components 121 is detachably connected to the side of the second shell 12 facing the first shell 11, the ear-clip earphone has a different form, thereby making the structure of the ear-clip earphone to be diverse and improving the adaptability of the ear-clip earphone.

Here, the type of characteristic parameter is not limited. For example, the characteristic parameter may include at least one of shape, size, and hardness. For example, the characteristic parameter may include shape, namely, the at least two fixing components 121 have different shapes so that the ear-clip earphone can adapt to users with different ear sizes, thereby improving the adaptability of the ear-clip earphone. For example, the characteristic parameter may include size, namely, the at least two fixing components 121 have different sizes so that the ear-clip earphone can adapt to users with different ear sizes, thereby improving the adaptability of the ear-clip earphone. The shapes of the fixing component 121 may be the same or different from each other. As another example, the characteristic parameter may include hardness, namely, the at least two fixing components 121 have different hardnesses so that the ear-clip earphone can adapt to the needs of different wearers, thereby improving the adaptability of the ear-clip earphone. In a specific application, the at least two fixing components 121 are made of different materials, so that the hardnesses of the at least two fixing components 121 are different from each other. As yet another example, characteristic parameter may include all of shape, size, and hardness. As yet another example, the characteristic parameter may include two of shape, size, and hardness.

The quantity of the at least two fixing components 121 is not limited. For example, the at least two fixing components 121 may include two fixing components 121. Here, the at least two fixing components 121 may include a first fixing component (first fitting body) 410 and a second fixing component (second fitting body) 420 with different characteristic parameters. For example, the at least two fixing components 121 may include three fixing components 121. Here, the at least two fixing components 121 may include a first fixing component (first fitting body) 410, a second fixing component (second fitting body) 420, and a third fixing component (third fitting body) 430 with different characteristic parameters.

The position of the fixing component 121 is not limited. For example, as shown in FIGS. 5, 6, and 7, the second shell 12 of the audio body 100 is provided with the sound outlets 123, which are located at the end of the second shell 12 away from the connection portion 310. The fixing component 121 is located between the connection portion 310 and the sound outlets 123, so that the sound outlets 123 are closer to the ear of the user, and the fixing component 121 is closer to the ear bone of the user.

The fixing component 121 and the second shell 12 can be detachably connected to each other such as by a clamping structure, a threaded structure, a magnetic adsorption structure, etc. For example, the magnetic adsorption structure may include a first adsorption component and a second adsorption component. The first adsorption component is disposed on the second shell 12, and the second adsorption component is disposed on the fixing component 121. There is a magnetic adsorption force between the first adsorption component and the second adsorption component, and the polarities of the first adsorption component and the second adsorption component may be opposite to each other. One of the first adsorption component and the second adsorption component may have magnetism, and the other of the first adsorption component and the second adsorption component may be made of iron. Here, the first adsorption component and the second adsorption component can be exposed or shielded.

The material of the fixing component 121 is not limited. For example, the fixing component 121 can be made of an elastic material to form a soft structure. When the fixing component 121 comes into contact with the ear of the user, the fixing component 121 with a soft structure can improve the wearing comfort the ear-clip earphone. For example, the fixing component 121 may be made of a material such as silicone, thermoplastic polyurethane (TPU), or thermoplastic elastomer (TPE). For example, the fixing component 121 may include a skeleton part and a fitting part. The skeleton part is detachably connected to the second shell 12, and the fitting part is set on the side of the skeleton part facing the first shell 11 and can come into contact with the user. Here, the skeleton part and the second shell 12 can be detachably connected to each other such as by a clamping structure, a threaded structure, and a magnetic adsorption structure. Here, the fitting part may be connected to the skeleton part such as by gluing, welding, clamping, etc. Here, the hardness of the skeleton part can be greater than that of the fitting part, thereby improving the connection stability between the fitting part and the second shell 12 through the skeleton part and the wearing comfort of the fixing component 121 through the fitting part. Here, the skeleton may be made of a material such as plastic. Here, the fitting part may be made of an elastic material.

In some embodiments of the present disclosure, the quantity of the fixing components 121 is at least two, and the at least two fixing components 121 are detachably connected to the side of the second shell 12 facing the first shell 11. The at least two fixing components 121 and the first shell 11 form different forms of the ear-clip earphone to improve the adaptability of the ear-clip earphone.

In one embodiment, the at least two fixing components 121 have different characteristic parameters.

In one embodiment, when one of the at least two fixing components 121 is detachably connected to the side of the second shell 12 facing the first shell 11, the fixing component 121 of the at least two fixing components 121 and the first shell 11 forms the ear-clip earphone with a specific form. When another of the at least two fixing components 121 is detachably connected to the side of the second shell 12 facing the first shell 11, the fixing component 121 of the at least two fixing components 121 and the first shell 11 forms the ear-clip earphone with another specific form. That is, the two forms of the ear-clip earphone are different from each other to improve the adaptability.

The implementation manner of the two forms of the ear-clip earphone is not limited. For example, when a different one of the at least two fixing components 121 is detachably connected to the side of the second shell 12 facing the first shell 11, the gap between each fixing component 121 and the first shell 11 is different, so that the ear-clip earphone can adapt to the users with different ear sizes. For example, when a different one of the at least two fixing components 121 is detachably connected to the side of the second shell 12 facing the first shell 11, the space defined among each fixing component 121, the first shell 11, the second shell 12, and the connection component (connection body) 13 is different, so that the ear-clip earphone can adapt to the users with different ear sizes. For example, when a different one of the at least two fixing components 121 is detachably connected to the side of the second shell 12 facing the first shell 11, the distance from the end of each fixing component 121 closest to the first shell 11 to the connection portion 310 is different, so that the ear-clip earphone can adapt to the users with different ear sizes.

In one embodiment, the at least two fixing components 121 may include a first fixing component (first fitting body) 410, a second fixing component (second fitting body) 420, and a third fixing component (third fitting body) 430. In order to improve the adaptability of ear-clip earphone, three forms of the ear-clip earphone can be provided.

In the embodiment, the characteristic parameters of the first fixing component 410, the second fixing component 420, and the third fixing component 430 are different from each other.

The first example is that when the first fixing component 410 is detachably connected to the side of the second shell 12 facing the first shell 11, there is a first gap H1 between the first fixing component 410 and the first shell 11 as shown in FIG. 5. When the second fixing component 420 is detachably connected to the side of the second shell 12 facing the first shell 11, there is a second gap H2 between the second fixing component 420 and the first shell 11 as shown in FIG. 6. When the third fixing component 430 is detachably connected to the side of the second shell 12 facing the first shell 11, there is a third gap H3 between the third fixing component 430 and the first shell 11 as shown in FIG. 7. The value of the first gap H1 is greater than the value of the second gap H2, and the value of the second gap H2 is greater than the value of the third gap H3. By setting different gaps between the fixing components 121 and the first shell 11, the ear-clip earphone can adapt to the users with different ear sizes.

Here, the first fixing component 410 is suitable for the users with thick ears, the second fixing component 420 is suitable for the users with normal thick ears, and the third fixing component 430 is suitable for the users with thin ears.

Here, the sizes of the first fixing component 410, the second fixing component 420, and the second fixing component 420 are different from each other. The shapes of the first fixing component 410, the second fixing component 420, and the second fixing component 420 may be the same or different from each other. The hardnesses of the first fixing component 410, the second fixing component 420, and the second fixing component 420 may be the same or different from each other.

The second example is that when the first fixing component 410 is detachably connected to the side of the second shell 12 facing the first shell 11, there is a first distance F1 between the end of the first fixing component 410 closest to the first shell 11 and the connection portion 310 as shown in FIG. 5. When the second fixing component 420 is detachably connected to the side of the second shell 12 facing the first shell 11, there is a second distance F2 between the end of the second fixing component 420 closest to the first shell 11 and the connection portion 310 as shown in FIG. 6. When the third fixing component 430 is detachably connected to the side of the second shell 12 facing the first shell 11, there is a third distance F3 between the end of the third fixing component 430 closest to the first shell 11 and the connection portion 310 as shown in FIG. 7. The value of the first distance F1 is greater than the value of the second distance F2, and the value of the second distance F2 is greater than the value of the third distance F3. By setting different distances between the fixing components 121 and the connection portion 310, the ear-clip earphone can adapt to the users with different ear sizes.

Here, the first fixing component 410 is suitable for the users with large ear, the second fixing component 420 is suitable for the users with normal size ears, and the third fixing component 430 is suitable for the users with small ears.

Here, the sizes of the first fixing component 410, the second fixing component 420, and the second fixing component 420 are different from each other. The shapes of the first fixing component 410, the second fixing component 420, and the second fixing component 420 may be the same or different from each other. The hardnesses of the first fixing component 410, the second fixing component 420, and the second fixing component 420 may be the same or different from each other.

The third example is that when the first fixing component 410 is detachably connected to the side of the second shell 12 facing the first shell 11, the first fixing component 410 and the audio body 100 form a spherical structure as shown in FIG. 5. When the second fixing component 420 is detachably connected to the side of the second shell 12 facing the first shell 11, a first portion of the second fixing component 420 and the audio body 100 cooperatively form a spherical structure with, and a second portion of the second fixing component 420 protrudes from the spherical structure as shown in FIG. 6. When the third fixing component 430 is detachably connected to the side of the second shell 12 facing the first shell 11, a first portion of the third fixing component 430 and the audio body 100 cooperatively form a spherical structure, and a second portion of the third fixing component 430 protrudes from the spherical structure as shown in FIG. 7. The height B2 of the second portion of the third fixing component 430 protruding from the respective spherical structure is greater than the height B1 of the second portion of the second fixing component 420 protruding from the respective spherical structure.

Here, the first fixing component 410 is suitable for the users with thick ears, the second fixing component 420 is suitable or the users with normal thick ears, and the third fixing component 430 is suitable for the users with thin ears.

Here, the sizes of the first fixing component 410, the second fixing component 420, and the second fixing component 420 are different from each other. The shapes of the first fixing component 410, the second fixing component 420, and the second fixing component 420 are different from each other. The hardnesses of the first fixing component 410, the second fixing component 420, and the second fixing component 420 may be the same or different from each other.

The fourth example is that when the first fixing component 410 is detachably connected to the side of the second shell 12 facing the first shell 11, the first fixing component 410, the first shell 11, the second shell 12, and the connection component (connection body) 13 cooperatively define a first space A1 as shown in FIG. 5. When the second fixing component 420 is detachably connected to the side of the second shell 12 facing the first shell 11, the second fixing component 420, the first shell 11, the second shell 12, and the connection component (connection body) 13 cooperatively define a second space A2 as shown in FIG. 6. When the third fixing component 430 is detachably connected to the side of the second shell 12 facing the first shell 11, the third fixing component 430, the first shell 11, the second shell 12, and the connection component (connection body) 13 cooperatively define a third space A3 as shown in FIG. 7. The first space A1 is larger than the second space A2, and the second space A2 is larger than the third space A3.

Here, the first space A1, the second space A2, and the third space A3 are used to receive the ear of the user. By forming spaces of different sizes through different fixing components 121, the ear-clip earphone can adapt to the users with different ear sizes.

Here, the first fixing component 410 is suitable for the users with large ears, the second fixing component 420 is suitable for the users with normal sized ears, and the third fixing component 430 is suitable for the users with small ears.

Here, the sizes of the first fixing component 410, the second fixing component 420, and the second fixing component 420 may be the same or different from each other. The shapes of the first fixing component 410, the second fixing component 420, and the second fixing component 420 may be the same or different from each other. The hardnesses of the first fixing component 410, the second fixing component 420, and the second fixing component 420 may be the same or different from each other.

Here, the implementation manner of forming spaces of different sizes by the fixing components 121 is not limited. For example, the manner described in at least one of the first to third examples mentioned above may be used to form spaces of different sizes by the fixing components 121. As an example, the fixing components 121 form spaces of different sizes by three manners mentioned in the first to third examples.

In some embodiments of the present disclosure, the side of the second shell 12 facing the first shell 11 has a convex portion 111 and a flange 112 located at a top of the convex portion 111 as shown in FIG. 9. The fixing component 121 has a groove 401 for receiving the convex portion 111 and an annular slot 402 located on a bottom side of the groove 401 as shown in FIGS. 10, 11, and 12. The flange 112 is detachably clamped in the annular slot 402. By detachably clamping the flange 112 in the annular slot 402, the fixing components 121 can be detachably connected to the side of the second shell 12 facing the first shell 11.

In one embodiment, the shape of the convex portion 111 is not limited. For example, the convex portion 111 may be cylindrical. For example, the convex portion 111 may also be annular.

In one embodiment, the shape of groove 401 is not limited. For example, the groove 401 may be cylindrical.

In one embodiment, the convex portion 111 may define a limiting slot 113, and the sidewall of the groove 401 may be provided with a limiting protrusion 403 inserted into the limiting slot 113. By inserting the limiting protrusion 403 into the limiting slot 113, the orientation of the fixing components 121 relative to the second shell 12 can be limited.

In one embodiment, when the fixing component 121 includes the skeleton part and the fitting part, the skeleton part may have the groove 401 for receiving the convex portion 111 and the annular slot 402 located on the bottom side of the groove 401.

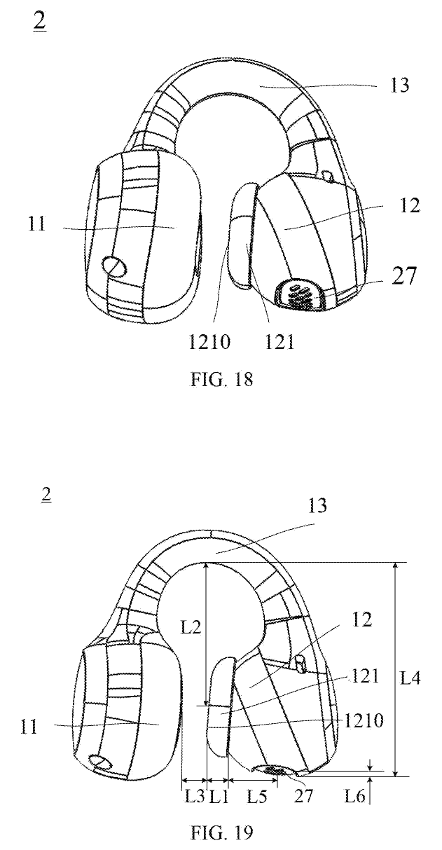

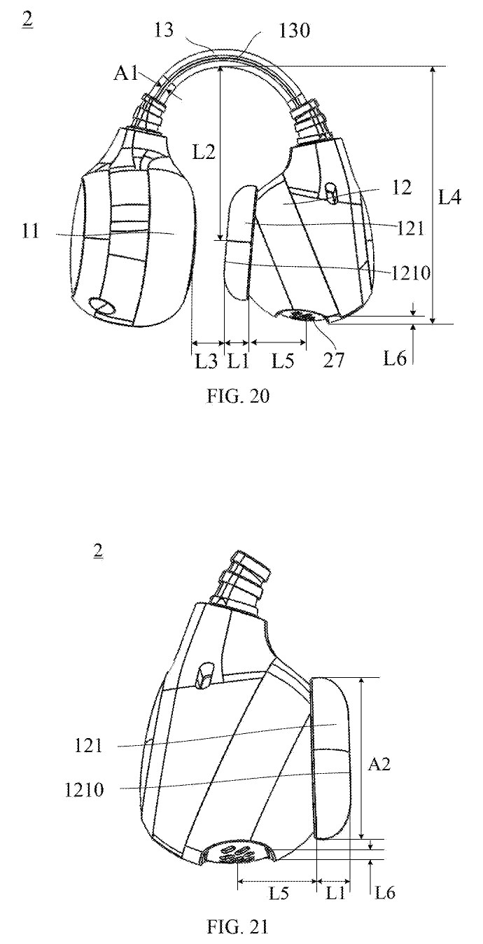

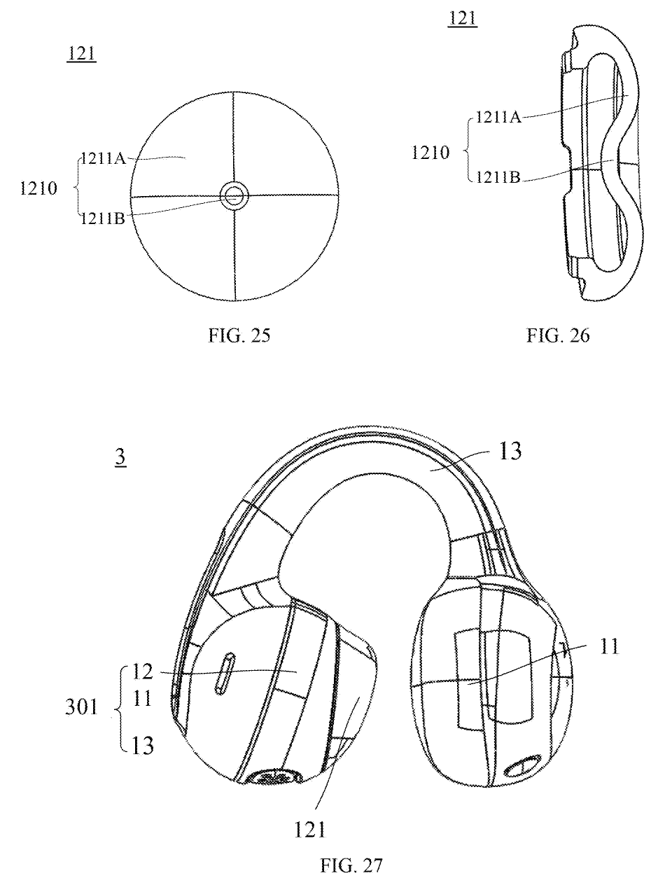

An earphone 2 according to another embodiment of the present application will be described with reference to FIGS. 13 to 26.

Referring to FIGS. 13 to 16 and 20 to 22, the earphone 2 includes a preauricular component 12, a postauricular component 11, a connection component 13, and an ear cap 121. The preauricular component 12 is located at the front side of the ear, and the postauricular component 11 is located at the back side of the ear. The connection component 13 is connected between the preauricular component 12 and the postauricular component 11. The ear cap 121 is located at a side of the preauricular component 12 close to the postauricular component 11. The ear cap 121 includes a first side 1210 facing away from the preauricular component 12. The first side 1210 includes a first portion 1211A and a second portion 1211B. The first portion 1211A surrounds a periphery of the second portion 1211B. The second portion 1211B is recessed with respect to the first portion 1211A along a direction toward the preauricular component 12 to form an avoidance portion. The first portion 1211A forms a clamping portion. The clamping portion and the preauricular component 11 cooperative clamp on the auricle of the ear. Therefore, the ear cap 121 can also be referred to as a fixing component.

In the embodiment of the present application, the earphone 2 is fixed to the ear 1’ by being clamped on the auricle. When the earphone 2 is worn, the ear cap 121 is attached to the ear 1’. Specifically, the ear 1’ includes a preauricular portion and a postauricular portion. The preauricular portion may include a crus of helix 11’, a supratragic notch 12’, a tragus 13’, an antitragus 14’, a helix 15’, a cymba conchae 16’, an antihelix 17’, and a cavum conchae 18’. The postauricular portion may include a superior root of the auricle 19’, a postauricular attachment point 20’, and a mastoidale point 201’. In some embodiments, when the earphone 2 is worn, the ear cap 121 is attached to the cavum conchae 18’ and the cymba conchae 16’ of the ear 1’.

In the embodiments of the present application, the earphone 2 can also be referred to as an Open Wearable Stereo (OWS) earphone. Here, the OWS earphone 2 has an open structure, and may be an ear-hook earphone or a bone-conduction earphone that will not enter the ear canal. The OWS earphone 2 conducts sound through the outer ear or the bone, so that the user can perceive the sound of the exterior of the earphone 2 while enjoying music, thereby improving the safety of the earphone 2.

In one embodiment, the connection component 13 can be made of an elastic material. For example, the connection component 13 can be made of a soft material, such as rubber, silicone, soft plastic, etc. In some embodiments, the connection component 13 is made of a material with hardness of 65A to 85A, which is tested under Shore A hardness standard.

In one embodiment, the connection component 13 can be integrally formed with the preauricular component 12 and the postauricular component 11. For example, the connection component 13 can be welded to the preauricular component 12 and the postauricular component 11. The connection component 13 can also be formed separately from the preauricular component 12 and the postauricular component 11, and is connected to each of the preauricular component 12 and the postauricular component 11 through a connector. For example, the connection component 13 can be connected to each of the preauricular component 12 and the postauricular component 11 through a clamping structure.

In one embodiment, in addition to the preauricular component 12, the postauricular component 11, and the connection component 13, the earphone 2 may further include a button. Here, the button may be operated by the user to turn on the earphone 2 or turn off earphone 2. The button can also be operated by the user to switch the content stored in the earphone 2. It should be noted that the function of the button is not limited. The button can be arranged on the preauricular component 12, the postauricular component 11, or the connection component 13.

In one embodiment, the connection component 13 may include a connection component without shape memory function. Here, the connection component without shape memory function refers to a connection component that can switch from a first state to a second state under an external force, but cannot switch from the second state to the first state after the external force is removed. The connection component 13 can also include a shape-memory connection component 130. Here, the shape-memory connection component 130 refers to a connection component that can switch from the first state to the second state under an external force, and can switch from the second state to the first state after the external force is removed. The connection component 13 can be made of a stainless steel material. In one embodiment, the shape-memory connection component 130 is made of a shape-memory steel wire with a diameter A1 in a range of 0.4 millimeters to 0.5 millimeters.

In the embodiment of the present application, the ear cap 121 is provided on the side of the preauricular component 12 close to the postauricular component 11. The ear cap 121 may reduce the risk of the earphone 2 separated from the ear 1’ when the user walks or moves, and may reduce the discomfort feelings of the auricle when the preauricular component 12 and the postauricular component 11 cooperatively clamps on the auricle. Based on this, the ear cap 121 may be connected to the side of the preauricular component 12 near the postauricular component 11 through an undetachable manner, which can reduce the risk of the ear cap 121 separated from the ear 1’. The ear cap 121 may also be connected to the side of the preauricular component 12 near the postauricular component 11 through a detachable manner, so that the ear cap 121 can be repaired and replaced by a new one. For example, the ear cap 121 is connected to the side of the preauricular component 12 near the postauricular component 11 through a snap-fitting structure or a threaded connection structure.

In one embodiment, along a direction of the first side 1210 and the preauricular component 12, an orthogonal projection of the first side 1210 can be regular. For example, the orthogonal projection of the first side 1210 can be square, rectangular or circular. In other embodiments, the orthogonal projection of the first side 1210 can be regular. For example, the orthogonal projection of the first side 1210 can be irregular. In one embodiment, along the direction of the first side 1210 and the preauricular component 12, the orthogonal projection of the first side 1210 is a circle with a diameter A2 in a range of 8 millimeters to 11 millimeters. Along the direction of the first side 1210 and the preauricular component 12, a thickness L1 of the ear cap 121 is in a range of 1.5 millimeters to 4.0 millimeters.

In one embodiment, along the direction of the first side 1210 and the preauricular component 12, an orthogonal projection of each of the first portion 1211A and the second portion 1211B may be regular. For example, the orthogonal projection of each of the first portion 1211A and the second portion 1211B may be square, rectangular, or circular. In another embodiment, along the direction of the first side 1210 and the preauricular component 12, the orthogonal projection of one of the first portion 1211A and the second portion 1211B may be regular, and the orthogonal projection of another of the first portion 1211A and the second portion 1211B may be irregular. In other embodiments, along the direction of the first side 1210 and the preauricular component 12, the orthogonal projection of each of the first portion 1211A and the second portion 1211B may be irregular. In the embodiment of the present application, along the direction of the first side 1210 and the preauricular component 12, the orthogonal projection of each of the first portion 1211A and the second portion 1211B is circular.

In one embodiment, the second portion 1211B is recessed with respect to first portion 1211A along a direction toward the preauricular component 12, and is directly resisted against the preauricular component 12. In another embodiment, the second portion 1211B may not be resisted against the preauricular component 12.

In one embodiment, the first portion 1211A forms a portion of the clamping portion, and a remaining portion of the ear cap 121 besides first side 1210 forms another portion of the clamping portion.

In one embodiment, the clamping portion and the postauricular component 11 cooperatively clamp the auricle. Here, each of the surfaces of the clamping portion and the postauricular component 11 that clamp the auricle may be curved, which can allow the clamping portion and the postauricular component 11 to tightly adhere to the auricle. In another embodiment, one of the surfaces of the clamping portion and the postauricular component 11 that clamp the auricle is flat, and another of the surfaces of the clamping portion and the postauricular component 11 that clamp the auricle is curved. In other embodiments, each of the surfaces of the clamping portion and the postauricular component 11 that clamp the auricle may be flat.

In the embodiment of the application, the earphone 2 includes the preauricular component 12 located at the front side of the ear, the postauricular component 11 located at the back side of the ear, and the connection component 13 connected between the preauricular component 12 and the postauricular component 11. As such, the preauricular component 12 and the postauricular component 11 can be connected to each other as a whole. Furthermore, the ear cap 121 is connected to the side of the preauricular component 12 close to the postauricular component 11. The ear cap 121 includes the first side 1210 facing away from the preauricular component 12. The first side 1210 includes the first portion 1211A and the second portion 1211B. The first portion 1211A surrounds the periphery of the second portion 1211B, and the second portion 1211B is recessed with respect to the first portion 1211A along the side closer to the preauricular component 12 to form an avoidance section. The first portion 1211A forms the clamping portion. As such, only the first portion 1211A of the first side 1210 A forms the clamping portion, and the clamping portion and the postauricular component 11 cooperatively clamp the auricle. The second portion 1211B of the first side 1210 does not form a clamping portion, thereby reducing the contact area between the ear cap 121 and the auricle, reducing the pressure of the ear cap 121 applied onto the ear 1’, and thus enhancing the user’s experience.

Referring to FIGS. 23 to 26, in one embodiment, the second portion 1211B is located at the central position of the first side 1210. Along the direction of the first side 1210 and the preauricular component 12, if the orthogonal projection of the first side 1210 is a circle, the central position can be the center of the circle; if the orthogonal projection of the first side 1210 is a triangle, the central position can be the center of gravity of the triangle; if the orthogonal projection of the first side 1210 is a square, the central position can be the intersection point between two diagonals of the square.

In the earphone 2 of the above embodiment of the application, since the second portion 1211B is located at the central position of the first side 1210, it can facilitate the positioning of the second portion 1211B when a manufacturer processes the ear cap 121.

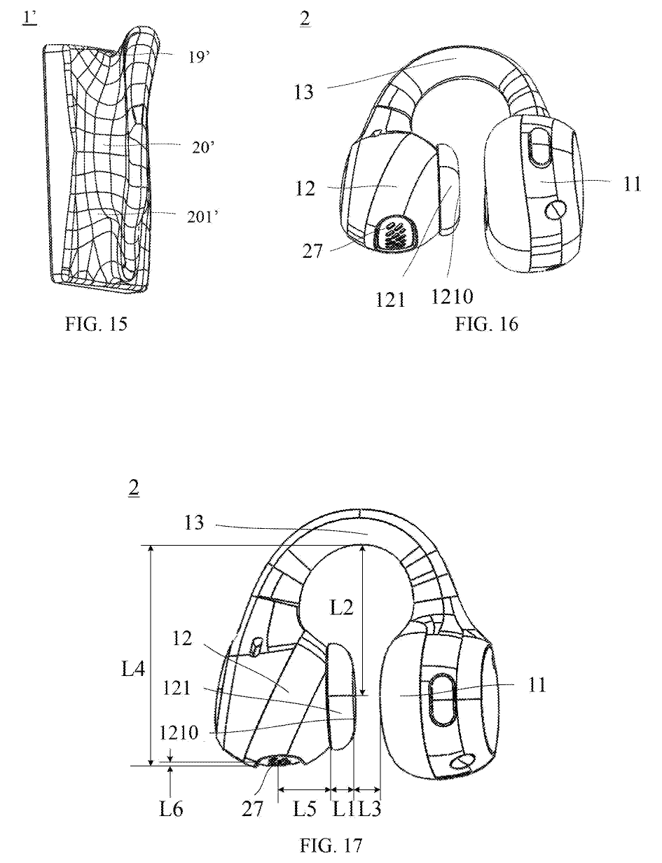

Referring to FIGS. 16 to 19, in one embodiment, a distance L2 between the center of the first side 1210 and the connection component 13 is in a range from 13 millimeters to 17 millimeters, which can reduce the discomfort feelings of the user caused by inaccurate clamping position of the ear cap 121, and the inaccurate clamping position of the ear cap 121 is resulted from a too short or too long distance between the center of the first side 1210 and the connection component 13. Similarly, a distance L3 between the first side 1210 and the postauricular component 11 is in a range from 3.0 millimeters to 4.0 millimeters, which can reduce the discomfort feelings of the users caused by a too short or too long distance between the first side 1210 and the postauricular component 11.

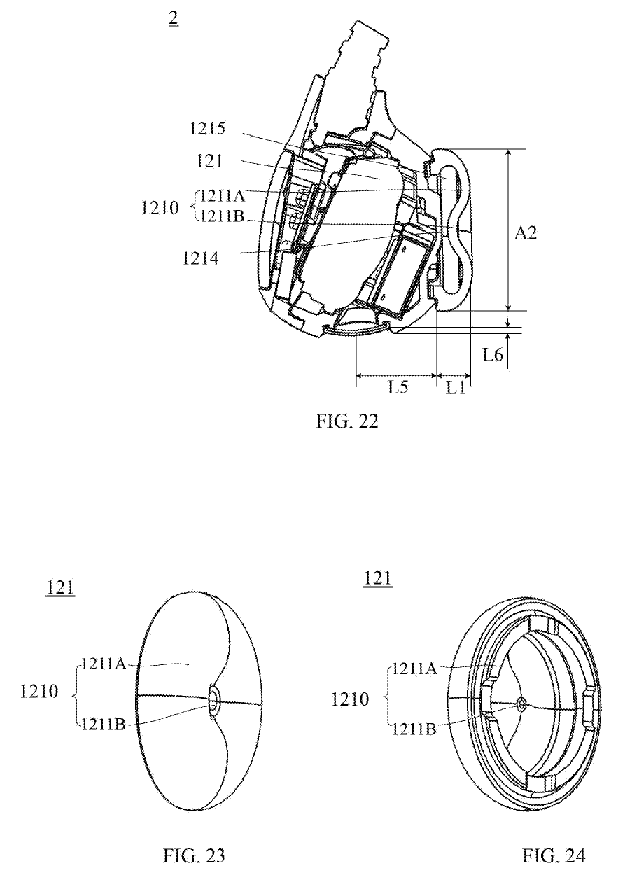

Referring to FIGS. 21 and 22, in one embodiment, along the direction of the first side 1210 and the preauricular component 12, a first cavity 1213 is defined between a side of the preauricular component 12 close to the first portion 1211A and a side of the first portion 1211A close to the preauricular component 12. The first cavity 1213 is used to receive gas. The second portion 1211B is recessed with respect to the first portion 1211A along the direction close to the preauricular component 12, and resisted against the preauricular component 12. At this time, the ear cap 121 can also be referred to as an airbag.

In the embodiment of the present application, the first cavity 1213 can be formed by directly reserving a gap during the actual processing between the side of the preauricular component 12 close to the first portion 1211A and the side of the first portion 1211A close to the preauricular component 12. The first cavity 1213 can also be formed by removing some material from the side of the first portion 1211A close to the preauricular component 12 during the actual processing, which can facilitate the lightweight design of the earphone 2.

In the earphone 2 of the embodiment of the present application, the first cavity 1213 is defined between the side of the preauricular component 12 close to the first portion 1211A and the side of the first portion 1211A close to the preauricular component 12. The first cavity 1213 is used to receive gas, which can facilitate the lightweight design of the earphone 2. At the same time, when vibration occurs, the gas in the first cavity 1213 can be buffered to reduce the discomfort feelings of the user caused by excessive vibration. Based on this, the second portion 1211B is recessed with respect to the first portion 1211A along the direction toward the preauricular component 12, and resisted against the preauricular component 12, thereby improving the reliability of the ear cap 121.

Referring to FIGS. 21 and 22, in one embodiment, a second cavity 26 is defined between a side of the preauricular component 12 close to the second portion 1211B and a side of the second portion 1211B close to the preauricular component 12. The second cavity 1214 is also used to be infilled with gas, and communicates with the first cavity 1213. The cavity consisting of the first cavity 1213 and the second cavity 1214 can also be referred to as an airbag cavity.

In the embodiment of the present application, the second cavity 1214 can be formed by directly reserving a gap during the actual processing between the side of the preauricular component 12 close to the second portion 1211B and the side of the second portion 1211B close to the preauricular component 12. The second cavity 1214 can also be formed by removing some material from the side of the second portion 1211B close to the preauricular component 12 during the actual processing, which can facilitate the lightweight design of the earphone 2.

In one embodiment, along another direction perpendicular to the direction of the first side 1210 and the preauricular component 12, a size of the first cavity 1213 may be larger than a size of the second cavity 1214, equal to the size of the second cavity 1214, or smaller than the size of the second cavity 1214. Here, along the direction perpendicular to the direction of the first side 1210 and the preauricular component 12, the sizes of the first cavity 1213 and the second cavity 1214 ma also be limited by the shape of the surface of the preauricular component 12 close to the first side 1210. In the embodiment of the present application, the surface of the preauricular component 12 close to the first side 1210 is a flat surface, and the size of the first cavity 1213 is larger than that of the second cavity 1214.

In the earphone 2 of the embodiment of the application, the first cavity 1213 is defined between the side of the preauricular component 12 close to the first portion 1211A and the side of the first portion 1211A close to the preauricular component 12, and is used to be infilled with gas. The second cavity 1214 is defined between the side of the preauricular component 12 close to the second portion 1211B and the side of the second portion 1211B close to the preauricular component 12, and is used to be infilled with gas and communicates with the first cavity 1213. Thus, it can facilities the lightweight design of the earphone 2. When vibration occurs, the gas in the first cavity 1213 can be buffered to reduce the discomfort feelings of the user caused by excessive vibration.

Referring to FIGS. 23 to 26, the ear cap 121 is an elastic component made of a soft rubber material. It should be noted that the soft rubber material usually refers to polymers with a low hardness and good elasticity, and the hardness range is generally measured by Shore A. The soft rubber material may be thermoplastic elastomers, silicone, natural rubber, synthetic rubber, or soft polyvinyl chloride. In one embodiment, the ear cap 121 is made of silicone with a hardness in a range from 35A to 50A.

In the earphone 2 of the embodiment of the application, since the ear cap 121 is made of the soft rubber material, the clamping force can be buffered, and the cushion the clamping force, and the soft rubber material has a more comfortable fit with the human skin, thereby improving the user experience.

Referring to FIGS. 16 to 20, in one embodiment, the earphone 2 further includes a sound emitting assembly. The sound emitting assembly is arranged on the side of the preauricular component 12 facing away from the connection component 13, and is used to generate sound. Here, the sound emitting assembly may include a moving coil unit, which uses electromagnetic induction to drive the diaphragm to produce sound. The sound emitting assembly may also include a moving iron unit, which uses armature vibration to transmit sound. The sound emitting assembly may also include a moving coil-iron unit, which uses a moving coil to handle low frequencies and a moving iron to handle medium and high frequencies, and optimizes frequency band through a frequency divider circuit. The sound emitting assembly may also include an air diaphragm unit, which transmits sound through air vibration, thereby reducing the pressure on the ear canal ear canal caused by the existing diaphragms.

In one embodiment, a distance L4 between the sound emitting assembly and the connection component 13 is in a range from 20 millimeters to 22.5 millimeters.

In the earphone 2 of the embodiment of the application, by placing the sound emitting assembly at the side of the preauricular component 12 facing away from the connection component 13, the sound from the sound emitting assembly can be quickly transmitted to the ear canal.

Referring to FIGS. 16 to 20, in one embodiment, the preauricular component 12 defines a receiving chamber, and the sound emitting assembly is received in a portion of the receiving chamber facing away from the connection component 13. A side of the preauricular component 12 facing away from the connection component 13 further defines a through hole, and the sound emitting assembly emits sound to outside through the through hole.

In the earphone 2 of the embodiment of the application, the receiving chamber is defined in the preauricular component 12, and the sound emitting assembly is received in a portion of the receiving chamber facing away from the connection component 13. As such, the preauricular component 12 can protect the sound emitting assembly and reduce damages to the sound emitting assembly. Based on this, the through hole is provided on the side of the preauricular component 12 facing away from the connection component 13, and the sound emitting assembly emits sound to outside through the through hole. Thus, the sound emitted by the sound emitting assembly can be quickly transmitted to the ear canal.

Referring to FIGS. 16 to 20, in one embodiment, the sound emitting assembly includes a sound emitting body and a protective component 27. The sound emitting body is received in the portion of the receiving chamber away from the connection component 13. The protective component 27 is set on a side of the sound emitting body near the through hole to protect the sound emitting body, which means that the protective member 27 is located at the outer side of the preauricular component 12.

In one embodiment, the protective component 27 can be a mesh structure made of a rigid material or a flexible material. In the embodiment of the present application, the protective component 27 is a sound emitting steel mesh.

In one embodiment, a distance L5 between the protective member 27 and the outer surface of the preauricular component 12 is in a range from 6.5 millimeters to 9.0 millimeters. In other words, the protective member 27 is higher than the outer surface of the preauricular component 12 by a distance L6 in a range from 0.3 millimeters to 0.7 millimeters.

In the earphone 2 of the embodiment of the application, by placing the protective component 27 at the side of the sound emitting body close to the through hole, the sound emitting body can be protected by the protective component 27. At the same time, the protective component 27 is located at the side of the sound emitting body close to the through hole, which means that the protective component 27 is located at the outer side of the preauricular component 12. Thus, the protective component 27 is prevented from being in direct contact with the outside during use and from being polluted by the outside.

An earphone 3 according to yet another embodiment of the present application will be described with reference to FIGS. 27 to 34. The features of the earphone 3 may be combined with the features of the ear-clip earphone 2 mentioned above without conflict.

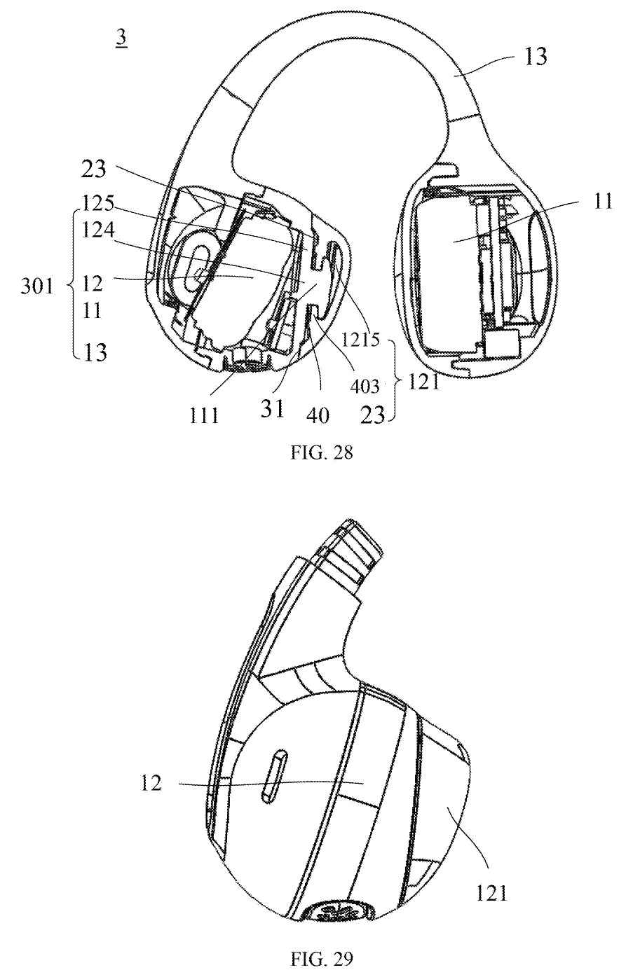

Referring to FIGS. 27 and 28, the self-fitting rebound earphone 3 includes an earphone body 301, an airbag 121, and an adjusting assembly 30. The airbag 121 is connected to the earphone body 301. A side of the airbag 121 facing away from the earphone body 301 is used to be attached to the contour of the ear. An airbag cavity 1215 is formed at a side of the airbag 121 close to the earphone body 301. The adjusting assembly 30 includes a main discharge groove 31. The main discharge groove 31 is located at the side of the airbag 121 near the earphone body 301. A first end of the main discharge groove 31 is located in the airbag cavity 1215. A second end of the main discharge groove 31 communicates with the exterior of the earphone 3, such that the airbag cavity 1215 communicates with the exterior.

In the embodiment of the present application, the earphone body 301 may include a preauricular component 12, a postauricular component 11, and a connection component 13. The connection component 13 is connected between the preauricular component 12 and the postauricular component 11 such that the preauricular component 12 and the postauricular component 11 are connected as a whole. The airbag 121 is provided on at least one of the preauricular component 12 and the postauricular component 11. In the embodiment of the present application, the airbag 121 is provided on the preauricular component 12. Based on this, a speaker, a battery, a magnet, or an antenna may also be installed in the preauricular component 12. The connection component 13 may also include an ear-clip wire, and a hard glue may be provided at each of two ends of the connection component 13, which is connected to the preauricular component 12 or the postauricular component 11.

In one embodiment, the airbag 121 may be made of a silicone or other materials such as rubber. In the embodiment of the present application, the airbag 121 is made of silicone, which has advantages such as good adhesion and high stability to improve the comfort of the user.

In one embodiment, the airbag 121 is connected to the earphone body 301 through an undetachable manner. For example, the airbag 121 is welded or glued to the earphone body 301. Of course, the airbag 121 may also be detachably connected to the earphone body 301. For example, the airbag 121 may be connected to the earphone body 301 in a threaded connection or snap-fitting manner. In one embodiment, the airbag 121 is connected to the earphone body 301 through a combination of glue and snap-fitting, thereby allowing the connection between the airbag 121 and the earphone body 301 to be more secure and reliable. The glue provides good bonding strength, and the snap-fitting further enhances the stability of the mechanical connection. The combination of glue and snap-fitting may effectively prevent the airbag 121 from being loosen or separated from the ear during daily use, and extend the service life of the self-fitting rebound earphone 3.

In one embodiment, the inner contour of the airbag cavity 1215 may be regular. For example, the inner contour of the airbag cavity 1215 may be cylindrical or elliptical structure. Of course, the inner contour of airbag cavity 1215 may also be irregular.

In one embodiment, the first end of the main discharge groove 31 may be located at the edge position inside the airbag cavity 1215. The first end of the main discharge groove 31 may also be located at the central position of the airbag cavity 1215.

In the self-fitting rebound earphone 3 of the embodiment of the application, the main discharge groove 31 is defined at the side of the airbag 121 close to the earphone body 301. The first end of the main discharge groove 31 is located in the airbag cavity 1215, and the second end of the main discharge groove 31 communicates with the exterior, such that the airbag cavity 1215 communicates with the exterior. When the earphone is worn on the ear contour and the side of the airbag 121 facing away from the earphone body 301 is in contact with the ear contour, if the ear contour compresses the airbag 121 due to the wearing action, the gas in the airbag cavity 1215 can be quickly discharged through the main discharge groove 31, thereby reducing the internal pressure of the airbag cavity 1215 such that the airbag 121 can quickly adapt to the deformation of the ear contour. When the pressure applied on the ear contour is released, the external air can enter the airbag cavity 1215 in reverse through the main discharge groove 31, thereby increasing the internal pressure of the airbag cavity 1215, such that the airbag 121 can quickly return to the initial state and keep fitting with the ear. Thus, the airbag 121 can rapidly achieve the effect of self-fitting rebound. Thus, the shape of the airbag 121 can be adjusted in real time according to the dynamic changes of the ear contour, such that the airbag 121 can stably fit with the ear contour in various usage scenarios, thereby improving the wearing comfort and stability of the earphone. Based on this, the self-fitting rebound earphone 3 of the embodiment of the present application can significantly improve the performance and user experience of earphone products, and has obvious advantages in wearing comfort, stability, and structural stability.

Referring to FIGS. 29 and 30, in the self-fitting rebound earphone 3 of the embodiment of the present application, the first end of the main discharge groove 31 is located at the central position inside the airbag cavity 1215. For example, when the inner contour of the airbag cavity 1215 is spherical, the first end of the main discharge groove 31 may be located at the center of the sphere. For example, when the inner contour of the airbag cavity 1215 is cubic, the first end of the main discharge groove 31 may be located at the center of the cube. For example, when the inner contour of the airbag cavity 1215 is irregular, the first end of the main discharge groove 31 may be located at the center of gravity of the irregular structure.

In the self-fitting rebound earphone 3 of the embodiment of the application, by arranging the first end of the main discharge groove 31 to be at the center of the airbag cavity 1215, on the one hand, the positioning of the first end of the main discharge groove 31 is facilitated; On the other hand, during the gas discharge or introduce process, the center of the airbag cavity 1215 is the position where the gas is first discharged from or introduced to, which can improve the stability of the deformation of the airbag 121.

Referring to FIGS. 31 to 34, in one embodiment, an orthogonal projection of the airbag 121 along the connection direction between the airbag 121 and the earphone body 301 is a close-shaped structure. There are multiple main discharge grooves 31, which are uniformly distributed along the outer contour of the close-shaped structure at the side of the airbag 121 near the earphone body 301.

In one embodiment, the orthogonal projection of the airbag 121 along the connection direction between the airbag 121 and the earphone body 301 is a close-shaped structure, and the close-shaped structure may be regular, such as a circle or a square. Of course, the close-shaped structure may also be irregular. In the embodiment of the present application, the close-shaped structure is circle, and the peripheral direction of the outer contour of the close-shaped structure is the peripheral direction of the circle.

In one embodiment, there are two main discharge grooves 31, which are uniformly distributed at the side of the airbag 121 close to the earphone body 301, at intervals of 180 degrees along the peripheral direction of the outer contour of the close-shaped structure. There may also be four main discharge grooves 31, which are uniformly distributed at the side of the airbag 121 close to the earphone body 301, at intervals of 90 degrees along the peripheral direction of the outer contour of the close-shaped structure.

In one embodiment, a size of the main discharge groove 31 along the periphery direction of the outer contour of the close-shaped structure may be 5 millimeters, 10 millimeters, or 15 millimeters. By precise calculation of the size of the main discharge groove 31, the gas in the airbag cavity 1215 can be quickly discharged out when the pressure applied onto the ear contour changes, and excessive rebound of the airbag 121 can be avoided due to rapid gas leakage. The quantity of the main discharge groove 31 is one, and the size of the main discharge groove 31 along the periphery direction of the outer contour of the close-shaped structure is in a range from 5 millimeters to 10 millimeters, thereby meeting the gas discharge needs in different usage scenarios.

In the self-fitting rebound earphone 3 of the embodiment of the application, by arranging multiple main discharge grooves 31, which are uniformly distributed at the side of the airbag 121 close to the earphone body 301 along the peripheral direction of the close-shaped structure, the speed of the gas being discharged from the airbag cavity 1215 to the exterior through the main discharge grooves 31 and the speed of the external air entering the airbag cavity 1215 through the main discharge grooves 31 can be accelerated.

Referring to FIGS. 31 to 34, in the self-fitting resilience headset 3 of the embodiment of the application, the adjusting assembly 30 further includes an auxiliary discharge groove 32. The auxiliary discharge groove 32 is defined at the side of the airbag 121 close to the body. The first end of the auxiliary discharge groove 32 communicates with the main discharge groove 31, and the second end of the auxiliary discharge groove 32 communicates with the exterior.

In the embodiment of the present application, the first end of the auxiliary discharge groove 32 communicates with the main discharge groove 31, which may means that the first end of the auxiliary discharge groove 32 only communicates with the main discharge groove 31 but is isolated from the airbag cavity 1215. In addition, the first end of the auxiliary discharge groove 32 may communicate with a portion of the main discharge groove 31 near the first end. The first end of the auxiliary discharge groove 32 may communicate with a portion of the main discharge groove 31 near the second end. The first end of the auxiliary discharge groove 32 may communicate with a middle portion of the main discharge groove 31 between the first and the second end. Based on this, the first end of the auxiliary discharge groove 32 directly communicates with the main discharge groove 31. In other words, the first end of the auxiliary discharge groove 32 extends into the main discharge groove 31. Of course, the first end of the auxiliary discharge groove 32 may also indirectly communicates with the main discharge groove 31.

In the self-fitting rebound earphone 3 of the embodiment of the application, the auxiliary discharge groove 32 is defined, the first end of the auxiliary discharge groove 32 communicates with the main discharge groove 31, and the second end of the auxiliary discharge groove 32 communicates with the exterior. When the earphone 3 is worn on the ear contour, if the ear contour squeezes the airbag 121 due to the wearing action, the gas in the airbag cavity 1215 can first be discharged out through the main discharge groove 31, thereby reducing the internal pressure of the airbag cavity 1215 such that the airbag 121 can quickly adapt to the deformation of the ear contour. At the same time, some gas will also be simultaneously discharged out through the auxiliary discharge groove 32, thereby further accelerating the gas discharge speed and achieving rapid rebound of the airbag 121. After the pressure applied on the ear contour is released, the external air will enter the airbag cavity 1215 in reverse through the main discharge groove 31 and the auxiliary discharge groove 32, thereby allowing the airbag 121 to quickly return to the initial state and to keep fitting with the ear contour. Thus, through the combination of the main discharge groove 31 and the auxiliary discharge groove 32, the airbag 121 can quickly adapt to the dynamic changes of the ear contour and adjust the shape in real time according to the movements of the ear contour. Thus, the airbag 121 can always maintain a close fit with the ear contour, thereby effectively avoiding the sound leakage and sound quality deterioration caused by insufficient fitting, and improving the wearing comfort and stability. Whether in sports, daily activities, or long-term wearing, the user can enjoy a more comfortable and stable wearing experience.

Referring to FIGS. 31 to 34, in one embodiment, the orthogonal projection of the airbag 121 along the connection direction between the airbag 121 and the earphone body 301 is a close-shaped structure. There are one main discharge groove 31 and multiple auxiliary discharge grooves 32. The first end of each of the auxiliary discharge groove 32 communicates with the main discharge groove 31, and the second end of each of the auxiliary discharge groove 32 communicates with the exterior. The auxiliary discharge grooves 32 are uniformly distributed at the side of the airbag 121 near the earphone body 301 along the peripheral direction of the close-shaped structure, and the main discharge groove 31 is located between two adjacent auxiliary discharge grooves 32.

For example, there are one main discharge groove 31 and four auxiliary discharge grooves 32. The four auxiliary discharge grooves 32 are uniformly distributed at the side of the airbag 121 near the earphone body 301, along the peripheral direction of the close-shaped structure at intervals of 90 degrees. The main discharge groove 31 is located between two adjacent auxiliary discharge grooves 32. It should be noted that the quantity and the distribution of the auxiliary discharge grooves 32 may be optimized according to the size and shape of the airbag 121.

In the self-fitting rebound earphone 3 of the embodiment of the application, the auxiliary discharge groove 32 can assist the main discharge groove 31 to accelerate the gas discharge speed when the pressure changes on the ear contour are complex, thereby achieving rapid rebound of the airbag 121.

Referring to FIGS. 31 to 34, in one embodiment, along the peripheral direction of the outer contour of the close-shaped structure, the size of each of the auxiliary discharge grooves 32 is smaller than the size of the main discharge groove 31.

For example, along the peripheral direction of the outer contour of the close-shaped structure, the size of the main discharge groove 31 is in a range from 5 millimeters to 10 millimeters. Accordingly, along the peripheral direction of the outer contour of the close-shaped structure, the size of each of the auxiliary discharge grooves 32 is less than 5 millimeters.

In the self-fitting rebound earphone 3 of the embodiment of the application, by arranging the size of each of the auxiliary discharge grooves 32 to be smaller than the size of the main discharge groove 31 along the peripheral direction of the outer contour of the close-shaped structure, the gas inside the airbag cavity 1215 can be quickly discharged out when the pressure on the ear contour changes, and excessive rebound of the airbag 121 can also be avoided caused by rapid gas leakage.

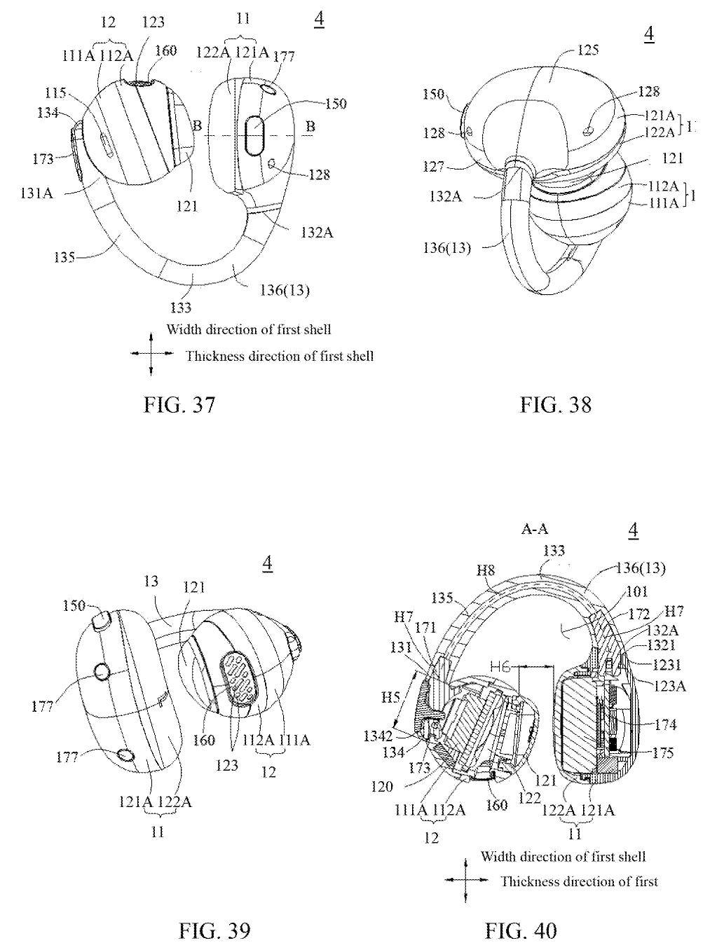

Referring to FIGS. 37 to 30, in the self-fitting rebound earphone 3 of the embodiment of the present application, the earphone body 301 includes a third portion 124 and a fourth portion 125. The third portion 124 has a convex portion 111 extending relative to the fourth portion 125 toward the airbag 121. The convex portion 111 defines a clamping slot 113 (i.e., a limiting slot). The airbag 121 has a clamping protrusion 403 (i.e., a limiting protrusion) at the side close to the earphone body 301, and the clamping protrusion 403 extends toward the center of the airbag cavity 1215. The clamping protrusion 403 extends into the clamping slot 113, thereby clamping the earphone body 301 with the airbag 121. When the earphone body 301 is clamped with the airbag 121, a communication channel 40 is defined between the side of the clamping protrusion 403 facing away from the airbag cavity 1215 and the fourth portion 125, along the connection direction between the earphone body 301 and the airbag 121. The auxiliary discharge groove 32 communicates with the main discharge groove 31 through the communication channel 40.

In one embodiment, the fourth portion 125 may surround the third portion 124. The fourth portion 125 may also be enclosed by the third portion 124.

In one embodiment, the convex portion 111 may have a certain degree of elasticity and toughness, which facilitates the insertion of the clamping protrusion 403 into the clamping slot 113 such that the earphone body 301 is clamped with the airbag 121. Accordingly, the convex portion 111 may be made of plastic, metal, or rubber with elasticity and toughness.

In one embodiment, the clamping protrusion 403 may also have a certain degree of elasticity and toughness, which facilitates the insertion of the clamping protrusion 403 into the clamping slot 113 such that the earphone body 301 is clamped with the airbag 121. Accordingly, the clamping protrusion 403 may be made of plastic, metal, or rubber with elasticity and toughness.

In the self-fitting rebound earphone 3 of the embodiment of the application, the clamping slot is provided on the earphone body 301, and the clamping slot is defined at the side of the airbag 121 close to the earphone body 301. The clamping protrusion 403 is inserted into the clamping slot 113, such that the earphone body 301 is clamped with the airbag 121, thereby ensuring connection strength and allowing the connection between the airbag 121 and the earphone body 301 to be more secure.

Referring to FIGS. 27 to 30, in the self-fitting rebound earphone 3 of the embodiment of the present application, the convex portion 111 or the clamping protrusion 403 is made of an elastic material. Here, the elastic material may be rubber or plastic.

In the self-fitting rebound earphone 3 of the embodiment of the application, since the convex portion 111 or the clamping protrusion 403 is made of an elastic material, it can facilitate the insertion of the clamping protrusion 403 into the clamping slot 113 of the convex portion 111.

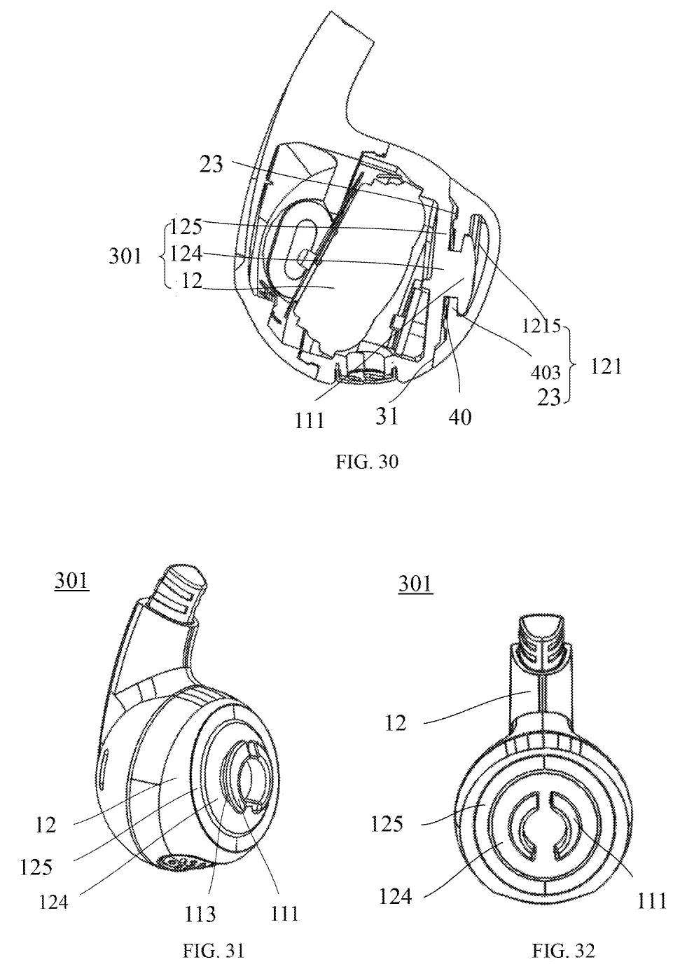

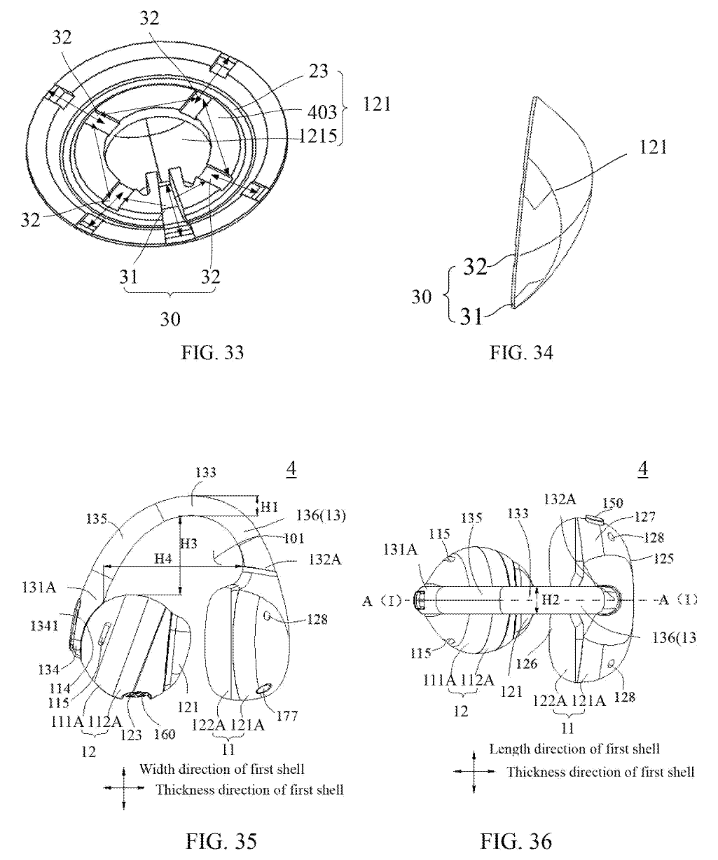

Referring to FIGS. 33 and 34, in one embodiment, a glue dispensing groove 23 is defined at the side of the clamping protrusion 403 facing away from the airbag cavity 1215, and the glue dispensing groove 23 is concave along a direction facing away from the earphone body 301. The glue dispensing groove 23 is used for allowing glue to be dispense therein. When the clamping protrusion 403 extends into the clamping slot 113, the earphone body 301 and the airbag 121 are bonded together by the glue in the glue dispensing groove 23. It should be noted that the dispensed glue will not affect the gas discharge through the main discharge groove 31 and the auxiliary discharge groove 32.

In the embodiment of the present application, the glue dispensing process has high precision. The glue to be dispensed in the glue dispensing groove 23 may have high strength and aging resistance characteristics. Thus, the glue can ensure the connection strength, and can also adapt to different usage environments, thereby effectively preventing the airbag 121 from separated from the earphone body 301 due to long-term use or environmental factors.

In the embodiment of the application, the position of the glue dispensing groove 23 may be carefully designed and analyzed. The glue dispensing groove 23 may be distributed at the edge of the airbag 121 and some key force points, to ensure a tight connection between the airbag 121 and the earphone body 301. In one embodiment, the glue may be applied at the upper and lower ends of the airbag 121, and also at some positions of the fitting surface near the ear contour, thereby forming a continuous glue ring that firmly bonds the airbag 121 to the earphone body 301.

In the embodiment of the present application, when the earphone body 301 and the airbag 121 are connected together by a snap-fitting manner together with the glue, the clamping positions and the gluing positions may cooperate with each other. For example, the clamping positions are located at the left and right sides of the airbag 121, and the gluing positions are located at the upper and lower sides of the airbag 121. Alternatively, the clamping positions are located at the upper and lower sides of the airbag 121, and the gluing positions are located at the left and right sides of the airbag 121. As such, the fixing effect is achieved, and the connection between the airbag 121 and the earphone body 301 is more firm and reliable.

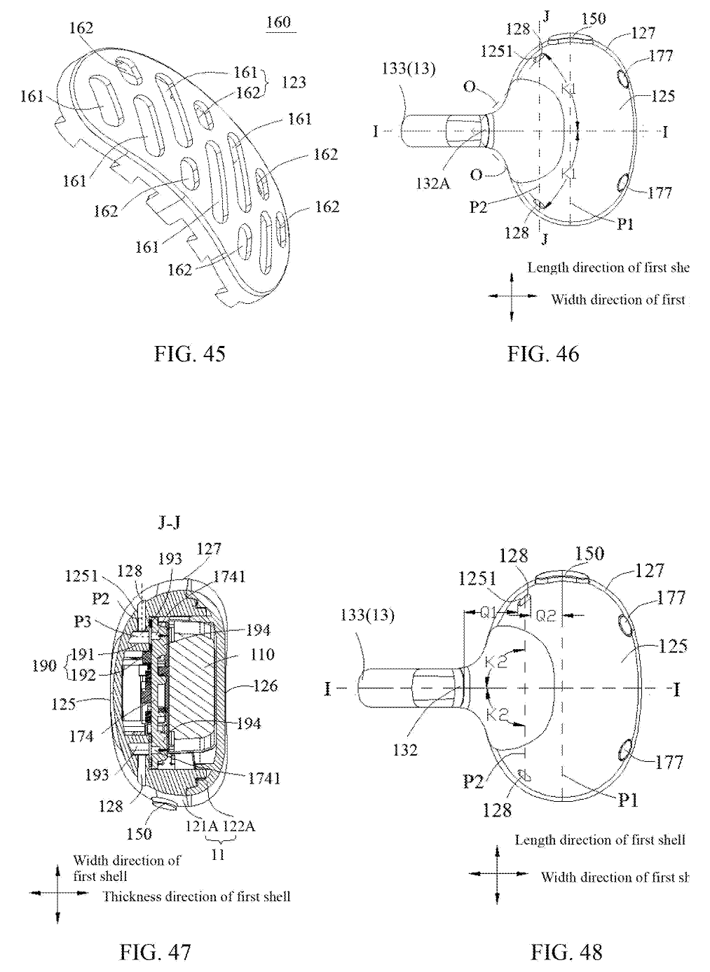

An ear-clip earphone 4 according to yet another embodiment of the present application will be described with reference to FIGS. 35 to 56. The features of the ear-clip earphone 4 may be combined with the features of the ear-clip earphone 2 or 3 mentioned above without conflict.

In one embodiment, the ear-clip earphone 4 may include a first shell 11, a second shell 12, a sound emitting assembly 120, and a connection component 13. When in use, the second shell 12 is used to be located at the front side of the ear, and the first shell 11 is used to be located at the back side of the ear. Therefore, the second shell 12 can also be referred to as a preauricular component, and the first shell 11 can also be referred to as a postauricular component.

As an example, the second shell 12 may substantially be spherical. The second shell 12 may define a receiving chamber, namely an audio chamber 122. The audio chamber 122 is used to receive audio components of the ear-clip earphones 4 therein. For example, the audio chamber 122 may have a sound emitting assembly 120 that can be fixed inside the audio chamber 122 through bonding, snap-fitting, welding, and other manners. The second shell 12 may be provided with a sound outlet 123. The audio from the sound emitting assembly 120 can be transmitted outside the second shell 12 through the sound outlet 123. The second shell 12 may further define a rear-side chamber hole 115, which can prevent any sound leakage. The structure of the sound emitting assembly 120 is not limited. For example, the sound emitting assembly 120 is a structure capable of generating audio. As an example. The sound emitting assembly 120 may be a structure such as a speaker that can generate audio. In one embodiment, the ear-clip earphone 4 may further include a sound collector 194, which may be fixed inside the audio chamber 122 by bonding, snap-fitting, welding, or other manners. Here, the second shell 12 may further define a sound collection hole 128. The sound collector 194 can collect the external sound through the sound collection hole 128. The structure of the sound collector 194 is not limited. For example, the sound collector 194 may include a structure such as a microphone capable of collecting sound. In other embodiments, the sound collector 194 may also be fixed inside the first shell 11 through bonding, snap-fitting, welding, and other manners. Here, the first shell 11 may be provided with the sound collection hole 128.

For example, the second shell 12 may include a first half shell 111A and a second half shell 112A. The second half shell 112A and the first half shell 111A may be connected together by bonding, snap-fitting, welding, or other manners. The audio chamber 122 may be defined between the first half shell 111A and the second half shell 112A. By setting the second shell 12 to include the second half shell 112A and the first half shell 111A, it is convenient to manufacture the second shell 12 and install the sound emitting assembly 120 inside the audio chamber 122.

Here, the sound emitting assembly 120 may be fixed to the second half shell 112A by bonding, snap-fitting, welding, or other manners, and located in the audio chamber 122 defined by the first half shell 111A and the second half shell 112A. In other embodiments, the sound emitting assembly 120 may also be fixed to the first half shell 111A by bonding, snap-fitting, welding, or other manners.

Here, the first half shell 111A may be connected to the first end of the connection component 13 by bonding, snap-fitting, welding, or other manners. Of course, the second half shell 12A may be connected to the first end of the connection component 13 by bonding, snap-fitting, welding, or other manners.

Here, the sound outlet 123 is provided on the second half shell 1121. Of course, the sound outlet 123 may also be provided on the first half shell 111A.

Here, the first half shell 111A may define one or two rear-side chamber holes 115. Of course, the second half shell 12A may also define one or two rear-side chamber holes 115.

Here, when the earphone 4 is worn, the second half shell 12A is used to cooperate with the ear.

As shown in FIGS. 35 and 36, the second shell 12 may further include an elastic component 121. The elastic component 121 may also be an ear cap or an airbag. The elastic component 121 may be fixed to the side of the second half shell 112A facing the first half shell 111A by bonding, snap-fitting, welding, or other manners, such that the second shell 12 can fit with the ear through the elastic component 121. The elastic component 121 is in contact with the ear. Thus, the elastic component 121 can deform to reduce the clamping force of the ear-clip earphone 4 on the ear, thereby improving the wearing experience of the ear-clip earphone 4.

Here, the material of the elastic component 121 may have elasticity and is not limited. For example, the elastic component 121 may be made of silicone, thermoplastic polyurethane (TPU), or thermoplastic elastomer (TPE). As an example, the elastic component 121 may be made of silicone rubber with a Shore hardness in a range from 30A to 40A.

Here, the material of the first half shell 111A and the second half shell 112A may be rigid. For example, the first half shell 111A and the second half shell 112A may be made of plastic. The hardness of the first half shell 111A and the second half shell 112A may be greater than the hardness of the elastic component 121.

The first shell 11 and the second shell 12 are spaced apart from each other, such that a clamping space is defined among the first shell 11, the second shell 12, and the connection component 13 for clamping the ear. When the earphone 4 is worn, the second shell 12 may be located at the front side of the ear, the first shell 11 may be located at the back side of the ear, and the ear may be sandwiched between the second shell 12 and the first shell 11.

The structure of the first shell 11 is not limited. For example, the first shell 11 may be a strip structure or a block structure. As an example, the first shell 11 may substantially be elliptical.

The cavity of the first shell 11 may be used to accommodate structural components of the ear-clip earphone 4.

As shown in FIGS. 35 and 36, the first shell 11 may include an exposing half shell 121A and a mating half shell 122. The mating half shell 122A and the exposing half shell 121A may be connected together by bonding, snap-fitting, welding, or other manners. The cavity of the first shell 11 is defined between the half shell 122A and the exposing half shell 121A. The mating half shell 122A may be used to fit with the ear. When the earphone 4 is worn, the mating half shell 122A may be in contact with the ear, and the exposing half shell 121A may be in an exposed state.

Here, the exposing half shell 121A and the mating half shell 122A may opposite to each other along the thickness direction of the first shell 11.

A size of the first shell 11 along its length direction may be greater than a size of the first shell 11 along its width direction. As shown in FIG. 46, the connection component 13 may be set at one side of the first shell 11 along its width direction. The size of the first shell 11 along its width direction may be greater than a size of the first shell 11 along its thickness direction.

The material of the connection component 13 may have elasticity. As such, the distance between the first shell 11 and the second shell 12 is adjustable through the elastic deform of the connection component 13. Thus, it only facilitates the wearing of the ear-clip earphone 4 on the ear, but also facilitates the removal of the ear-clip earphone 4 from the ear. As an example, the connection component 13 may be made of silicone, thermoplastic polyurethane (TPU), or thermoplastic elastomer (TPE). Here, a steel wire may also be installed inside the connection component 13 to enhance the strength and elasticity of the connection component 13.

The shape of the connection component 13 may be C-shaped, n-type, etc. The connection component 13 may be curved. The curves of different sections of the connection component 13 may be the same or different from each other.

The connection component 13 may be connected to each of the second shell 12 and the first shell 11 by bonding, snap-fitting, welding, or other manners. The connection component 13 may include a first end 131A and a second end 132A opposite to each other. The first end 131A of the connection component 13 may be connected to the second shell 12 by bonding, snap-fitting, welding, or other manners. The second end 132A of the connection component 13 may be connected to the first shell 11 by bonding, snap-fitting, welding, or other manners.

As an example, as shown in FIG. 36, the first end 131A of the connection component 13 may be connected to the first half shell 111A of the second shell 12 by bonding, snap-fitting, welding, or other manners. The second end 132A of the connection component 13 may be connected to the exposing half shell 121A of the first shell 11 by bonding, snap-fitting, welding, or other manners. Of course, the first end 131A of the connection component 13 may also be connected to the second half shell 112A and/or the first half shell 111A of the second shell 12 by bonding, snap-fitting, welding, or other manners. The second end 132A of the connection component 13 may also be connected to the exposing half shell 121A and/or the mating half shell 122A of the first shell 11 by bonding, snap-fitting, welding, or other manners.

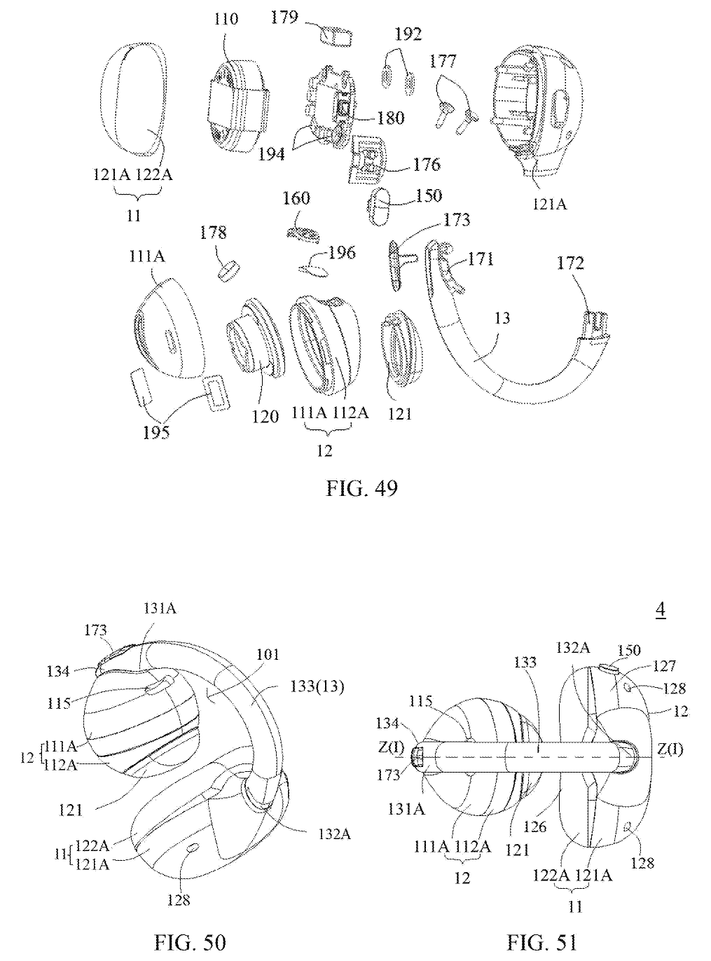

In one embodiment, as shown in FIGS. 40 and 49, the ear-clip earphone 4 may include a first fixing member 171 and a second fixing member 172. The first fixing member 171 may be provided on the first end 131A of the connection component 13 by bonding, snap-fitting, welding, or other manners. The first fixing member 171 may be connected to the second shell 12 by bonding, clamping, welding, or other manners. The second fixing member 172 may be provided on the second end 132A of the connection component 13 by bonding, snap-fitting, welding, or other manners. The second fixing member 172 may be connected to the first shell 11 by bonding, snap-fitting, welding, or other manners.

Here, the hardness of the first fixing member 171 may be greater than the hardness of the connection component 13.

The hardness of the second fixing member 172 may be greater than the hardness of the connection component 13. The harder first fixing member 171 may improve the connection strength between the first end 131A of the connection component 13 and the second shell 12. The harder second fixing member 172 may improve the connection strength between the second end 132A of the connection component 13 and the first shell 11. At the same time, the softer connection component 13 may fit the shape of the ear, thereby improving the adaptability and clamping ability of the ear-clip earphone 4.

Here, the portion of the connection component 13 between the first fixing member 171 and the second fixing member 172 is deformable. The portion of the connection component 13 connected to the first fixing member 171 is basically unable to deform. The portion of the connection component 13 connected to the second fixing member 172 is basically unable to deform.

In one embodiment, the ear-clip earphone 4 may include a power supply assembly 110 for supplying electric power to the ear-clip earphone 4. The power supply assembly 110 may be installed in the second shell 12, the first shell 11, or the connection component 13.

In one embodiment, as shown in FIGS. 40 and 49, the power supply assembly 110 may be fixed in the first shell 11 by bonding, snap-fitting, welding, or other manners. The power supply assembly 110 may supply electric power to the sound emitting assembly 120.

Here, the thickness direction of the power supply assembly 110 may be the same or substantially the same as the thickness direction of the first shell 11. The power supply assembly 110 may be a cylindrical, conical, or other rotating structure with a central axis. The central axis of the power supply assembly 110 may be the same or substantially the same as the thickness direction of the first shell 11.

In one embodiment, the ear-clip earphone 4 may include a first circuit board 174. The first circuit board 174 may be installed in the second shell 12, the first shell 11, or the connection component 13.

As an example, as shown in FIGS. 40 and 49, the first circuit board 174 may be fixed inside the first shell 11 by bonding, snap-fitting, welding, or other manners. The first circuit board 174 may be electrically connected to the power supply assembly 110.

Here, the thickness direction of the first circuit board 174 may be the same or substantially the same as the thickness direction of the first shell 11.

In one embodiment, the ear-clip earphone 4 may include a second electrical connector 177. One end of the second electrical connector 177 may be electrically connected to the first circuit board 174, such that the end of the second electrical connector 177 can charge or supply electric power to the power supply assembly 110 through the first circuit board 174. Another end of the second electrical connector 177 may be in an exposed state, and is used to be in contact with and electrically connect to a first electrical connector 251 of an earphone case. Thus, when the ear-clip earphone 4 is stored in the earphone case, the power supply assembly 110 of the ear-clip earphone 4 may be charged through the earphone case.

Here, the second electrical connector 177 and the first circuit board 174 may be located in a same shell. For example, the second electrical connector 177 and the first circuit board 174 may be located in the first shell 11.

In one embodiment, the ear-clip earphone 4 may further include an operation button 150. The operation button 150 may be provided on the second shell 12, the first shell 11, or the connection component 13. The operation button 150 can be used to be operated to control the operation of the ear-clip earphones 4.

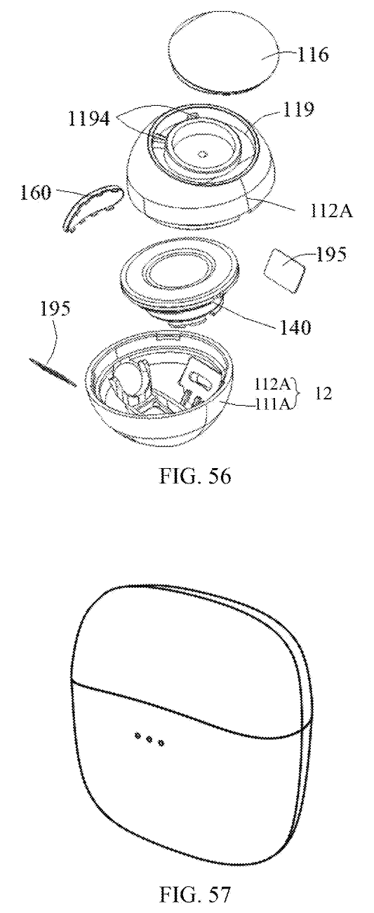

In one embodiment, as shown in FIGS. 40 and 56, the ear-clip earphone 4 may further include a first dustproof component 195. The first dustproof component 195 may be arranged at the rear-side chamber hole 115 by bonding, snap-fitting, welding, or other manners. The structure of the first dustproof component 195 is not limited. For example, the first dustproof component 195 may have a mesh structure or a structure having multiple holes. The material of the first dust-proof component 195 is not limited. For example, the first dustproof component 195 may be made of metal, fabric, etc. The first dustproof component 195 may also have a sound tuning function. In some embodiments, the first dustproof component 195 may be a dustproof and sound tuning mesh.

In one embodiment, as shown in FIG. 40, the ear-clip earphone 4 may further include a second dustproof component 196. The second dustproof component 196 may be arranged at the sound outlet 123 by bonding, snap-fitting, welding, or other manners. The structure of the second dustproof component 196 is not limited. For example, the second dustproof component 196 may have a mesh structure or a structure having multiple holes. The material of the second dustproof component 196 is not limited. For example, the second dustproof component 196 may be made of metal, fabric, etc. The second dustproof component 196 may also have a sound tuning function. In some embodiments, the second dustproof component 196 may be a dustproof and sound tuning mesh.

As shown in FIG. 35, the connection component 13 may include a fitting portion 133 located between the second shell 12 and the first shell 11. The cross-sectional area of the fitting portion 133 may be less than or equal to 9 mm².

The inventors have found that when the earphone is worn on the ear, the earphone may often press against the helix, such that the helix may feel painful caused by the earphone pressing against the helix, and the earphone is uncomfortable to be worn after a long-term use. In the ear-clip earphone 4 of the present application, since the cross-sectional area of the fitting portion 133 is less than or equal to 9 mm², in other words, the cross-sectional area of the fitting portion 133 is small. Thus, the connection component 13 may be easily deformed at the fitting portion 133, thereby reducing the deformation force of the fitting portion 133, then reducing the painful feelings of the helix caused by the connection component 13 pressing against the helix, and improving the wearing comfort of the ear-clip earphone 4. At the same time, the fitting portion 133 with a relatively small cross-sectional area may also have a small weight, making it easier to be worn to improve the user experience. In addition, in the case that the overall height of the ear-clip earphone 4 is the same, the fitting portion 133 with a small cross-sectional area can form a larger clamping space, thereby allowing the ear-clip earphone 4 to fit with ears of different sizes.

For example, when the ear-clip earphone 4 is worn on a large ear, the ear may come into contact with the connection component 13 of the ear-clip earphone 4, and the ear-clip earphone 4 may be lifted or raised away from the wearer’s head through the connection component 13, resulting in a larger distance between the second shell 12 and the ear canal, which will reduce the volume and sound quality of the audio received by the wearer and affect the audio effect of the ear-clip earphone 4. The ear-clip earphone 4 of the present application has a larger clamping space formed by the fitting portion 133 with a smaller cross-sectional area. Thus, the ear-clip earphone 4 will not be easily lifted or raised. At the same time, the cross-sectional area of the fitting portion 133 is relatively small, such that the connection component 13 is easily deformed at the fitting portion 133, thereby reducing the deformation force of the fitting portion 133 and allowing the connection component 13 to easily fit with the size of the ear, thereby reducing the painful feelings of the helix caused by the connection component 13 pressing against the helix and improving the wearing comfort of the ear-clip earphone 4. In addition, since the connection component 13 may have a smaller deformation force, the clamping force of the ear-clip earphone 4 applied onto the ear may be reduced, thereby further improving the wearing comfort of the ear-clip earphone 4.

In the embodiment of the present application, the fitting portion 133 may be an area in the connection component 13 with the smallest cross-section. The fitting portion 133 may be an area in the connection component 13 that is more easily to deform. When the connection component 13 is under the external force, the fitting portion 133 may first deform, such that the clamping space or clamping force between the second shell 12 and the first shell 11 may be quickly adjusted through the fitting portion 133.

In one embodiment, the fitting portion 133 may be located in the middle area of the connection component 13. Here, the length of the connection component 13 between the fitting portion 133 and the first end 131A of the connection component 13 is substantially the same as the length of the connection component 13 between the fitting portion 133 and the second end 132A of the connection component 13. Here, the length of the connection component 13 is the length extending from the first end 131A of the connection component 13 to the second end 132A of the connection component 13, rather than the straight-line distance between the two ends of the connection component 13. Of course, in other embodiments, the fitting portion 133 may not be located in the middle area of the connection component 13. For example, as shown in FIGS. 35 and 24, the length of the connection component 13 between fitting portion 133 and the first end 131A of the connection component 13 may be greater than the length of the connection component 13 between the fitting portion 133 and the second end 132A of the connection component 13. The length of the connection component 13 between the fitting portion 133 and the first end 131A of the connection component 13 may be the length extending from the fitting portion 133 to the first end 131A of the connection component 13. The length between the fitting portion 133 and the second end 132A of the connection component 13 may be the length from the fitting portion 133 to the second end 132A of the connection component 13.

The fitting portion 133 may fit with the helix. When the earphone 4 is worn, the fitting portion 133 may be in contact with the helix or spaced from the helix by a small gap. By setting the fitting portion 133 at the area of the connection component 13 fitting with the helix, the connection component 13 may first deform first at the area fitting with the helix, and the deformation force of the connection component 13 at the area fitting with the helix may be minimized, thereby reducing the contact pressure between the connection component 13 and the helix and improving the wearing comfort.

In the embodiment of the present application, the first end 131A of the connection component 13 may be connected to the side of the second shell 12 facing away from the first shell 11. The second end 132A of the connection component 13 may be connected to the first shell 11. The inventors have found that when the earphone is clamped on the ear, the earphone may often press against the helix due to insufficient clamping space. Thus, the earphone will press against the helix, making the earphone uncomfortable to be worn. By connecting the first end 131A of the connection component 13 to the side of the second shell 12 facing away from the first shell 11, the length of the connection component 13 and the size of the clamping space may be further increased, thereby allowing the connection component 13 to fit the large ears, reducing the painful feelings of the helix caused by the connection component 13 pressing against the helix, and improving the wearing comfort of the ear-clip earphone 4.

Here, as shown in FIG. 40, the length H7 of the connection component 13 extending from the first end 131A of the connection component 13 to the second end 132A of the connection component 13 may be 31.5 mm to 33.5 mm, 31 mm to 33 mm, 32 mm to 34 mm, etc. The length H7 of the connection component 13 extending from the first end 131A of the connection component 13 to the second end 132A of the connection component 13 may be 31 mm, 31.5 mm, 32 mm, 32.4 mm, 32.5 mm, 33 mm, etc. The relatively long connection component 13 may increase the deformation ability of the connection component 13, reduce the clamping force of the ear-clip earphone 4, and improve the wearing comfort of the ear-clip earphone 4.

In one embodiment, the length H8 of the connection component 13 extending from the first fixing member 171 to the second fixing member 172 may be 23 mm to 25 mm, 23 mm to 24 mm, 24 mm to 25 mm, 23.5 mm to 24.5 mm, etc. The length H8 of the connection component 13 extending from the first fixing member 171 to the second fixing member 172 may be 23 mm, 23.5 mm, 24 mm, 24.5 mm, 25 mm, etc. The relatively long connection component 13 may increase the length H8 of the connection component 13 extending from the first fixing member 171 to the second fixing member 172, thereby improving the effective deformation length of the connection component 13 between the first fixing member 171 and the second fixing member 172, and thus enhancing the deformation ability of the connection component 13.

Of course, in other embodiments, the first end 131A of the connection component 13 may also be connected to the side of the second shell 12 facing the fitting portion 133. At this time, the length of the connection component 13 is smaller.

In one embodiment, the cross-sectional area of the connection component 13 may gradually increase from the fitting portion 133 to the first end 131A, which may not only increase the connection area and connection strength between the first end 131A and the second shell 12, but also make the connection component 13 appear smooth. In other embodiments, the cross-sectional area of the connection component 13 may gradually decrease or remain unchanged from the fitting portion 133 to the first end 131A.

In one embodiment, the cross-sectional area of the connection component 13 may gradually increase from the fitting portion 133 to the second end 132A, which may not only increase the connection area and connection strength between the second end 132A and the second shell 12, but also make the connection component 13 appear smooth. In other embodiments, the cross-sectional area of the connection component 13 may gradually decrease or remain unchanged from the fitting portion 133 to the second end 132A.

In one embodiment, the cross-sectional area of the fitting portion 133 may be less than or equal to 9 mm². For example, the cross-sectional area of the fitting portion 133 may be 7 mm² to 8 mm², 7 mm² to 9 mm², 8 mm² to 9 mm², etc. For example, the cross-sectional area of the fitting portion 133 may also be 7 mm², 7.5 mm², 8 mm², 8.5 mm², 9 mm², etc. In other embodiments, the cross-sectional area of the fitting portion 133 may also be greater than 9 mm².

In one embodiment, the cross-sectional area of the first end 131A of the connection component 13 may be 8.2 mm² to 9.2 mm², 8 mm² to 9 mm², 8.5 mm² to 9.5 mm², etc. For example, the cross-sectional area of the first end 131A of the connection component 13 may be 8.2 mm², 8.5 mm², 8.7 mm², 8.9 mm², etc.

In one embodiment, the cross-sectional area of the second end 132A of the connection component 13 may be 10 mm² to 11 mm², 9.5 mm² to 10.5 mm², 10.5 mm² to 11.5 mm², etc. For example, the cross-sectional area of the second end 132A of the connection component 13 may be 9.5 mm², 10 mm², 10.2 mm², 10.5 mm², 10.7 mm², 11 mm², 11.5 mm², 12 mm², etc.

In one embodiment, as shown in FIG. 35, a clamping space 101 is defined between the second shell 12, the first shell 11, and the connection component 13. A size H1 of the cross-section of the fitting portion 133 along a first direction may be less than or equal to 3 mm, wherein the first direction is the width direction of the first shell 11. A surface of the fitting portion 133 for defining the clamping space 101 is located at a side of the clamping space 101 along the first direction. When the clamping distance between the second shell 12 and the first shell 11 increases, by setting the size of the surface of the fitting portion 133 along the first direction being small (the surface is located at the side of the clamping space 101 along the first direction), the deformation force at the fitting portion 133 may be further reduced, thereby reducing the clamping force between the second shell 12 and the first shell 11, reducing the difficulty of opening and closing the ear-clip earphone 4, and thus improving the wearing comfort of the ear-clip earphone 4. At the same time, in the case that the overall height of the ear-clip earphone 4 is the same and the cross-section of the fitting portion 133 is the same, by the size of the surface of the fitting portion 133 along the first direction being small (the surface is located at the side of the clamping space 101 along the first direction), the size of the clamping space 101 along the first direction may further be increased, thereby allowing the ear-clip earphone 4 to adapt to ears of different sizes.

Here, the size H2 of the fitting portion 133 along the second direction may be greater than the size H1 of the fitting portion 133 along the first direction, and the second direction is the length direction of the first shell 11. The second direction and the first direction may be perpendicular to or substantially perpendicular to each other. As such, the size H1 of the fitting portion 133 along the first direction may be small, and the cross-sectional area of the fitting portion 133 may meet specific requirements. Therefore, in the case that the cross-sectional area of the fitting portion 133 is the same, the deformation force of the fitting portion 133 may further be reduced, thereby improving the wearing comfort of the ear-clip earphone 4.

Here, the size H1 of the fitting portion 133 along the first direction may be 2.3 mm to 2.7 mm, 2 mm to 2.5 mm, 2.5 mm to 3 mm, etc. For example, the size H1 of the fitting portion 133 along the first direction may be 2 mm, 2.5 mm, 3 mm, etc.

Here, the size H2 of the fitting portion 133 along the second direction may be 3.4 mm to 3.8 mm, 3 mm to 4 mm, 3.5 mm to 4 mm, etc.

Here, the size H1 of the connection component 13 along the first direction may gradually increase from the fitting portion 133 to the first end 131A. As such, the small fitting portion 133 may reduce the clamping force and the difficulty of opening and closing the ear-clip earphone 4, and the large first end 131A may increase the connection area and the connection strength between the connection component 13 and the second shell 12. Also, the connection component 13 may appear smooth. In other embodiments, the size H1 of the connection component 13 along the first direction may also remain unchanged from the fitting portion 133 to the first end 131A.

Here, the size H2 of the connection component 13 along the second direction may remain unchanged from the fitting portion 133 to the first end 131A, which allows the connection component 13 to be more compact and lightweight. In other embodiments, the size H2 of the connection component 13 along the second direction may gradually increase from the fitting portion 133 to the first end 131A.

Here, the size H1 of the connection component 13 along the first direction may gradually decrease from the fitting portion 133 to the second end 132A. Thus, the small fitting portion 133 may reduce the clamping force and the difficulty of opening and closing the ear-clip earphone 4, and the large second end 132A may increase the connection area and the connection strength between the connection component 13 and the first shell 11. Also, the connection component 13 may appear smooth. In other embodiments, the size H1 of the connection component 13 along the first direction may also remain unchanged from the fitting portion 133 to the second end 132A.

Here, the size H2 of the connection component 13 along the second direction may remain unchanged from the fitting portion 133 to the second end 132A, which allows the connection component 13 to be more compact and lightweight. In other embodiments, the size H2 of the connection component 13 along the second direction may also gradually increase from the fitting portion 133 to the second end 132A.

In one embodiment, as shown in FIG. 35, there is a first distance H3 between the fitting portion 133 and the second shell 12. The first distance H3 may be 9 mm to 11 mm, 9 mm to 10 mm, 10 mm to 11 mm, 9.5 mm, 10.5 mm, 10 mm, etc. Since the first distance H3 is relatively large, the ear-clip earphone 4 may further adapt to large ears.

In one embodiment, there is a second distance H4 between the first end 131A of the connection component 13 and the second end 132A of the connection component 13. The second distance H4 may be 17 mm to 19 mm, 17 mm to 18 mm, 18 mm to 19 mm, 17.5 mm, 18.5 mm, etc. Since the second distance H4 is relatively large, the ear-clip earphone 4 may further adapt to large ears.

In one embodiment, the cross-sectional shape of the connection component 13 is not limited. For example, the cross-section of the connection component 13 may be elliptical, and the minor axis of the cross-section of the connection component 13 may extend along the first direction, while the major axis of the cross-section of the connection component 13 may extend along the second direction. By setting the minor axis of the cross-section of the connection component 13 along the first direction, the clamping force of the ear-clip earphone 4 may be reduced, and the difficulty of opening and closing the ear-clip earphone 4 may be reduced. Also, the safety of wearing the ear-clip earphone 4 may be improved through the smooth connection component 13.

In one embodiment, the connection component 13 may further include an extension portion 134 provided at the first end 131A of the connection component 13. The extension portion 134 extends away from the fitting portion 133, and is located at the side of the second shell 12 facing away from the first shell 11. The extension portion 134 may improve the contact area and the connection strength between the connection component 13 and the second shell 12, and allow the ear-clip earphone 4 to appear smooth as a whole.

In one embodiment, the extension portion 134 is formed by extending the first end 131A of the connection component 13 at the side of the second shell 12 facing away from the first shell 11. Thus, the extension portion 134 may increase the contact area and the connection strength between the connection component 13 and the second shell 12, and the overall ear-clip earphone 4 may appear smooth. In other embodiments, the extension portion 134 may be omitted from the connection component 13.

Here, as shown in FIG. 35, the extension portion 134 includes a first surface 1341 facing the second shell 12. The first surface 1341 may cooperate with a second surface 114 of the second shell 12. Here, the first surface 1341 may be in contact with the second surface 114 or spaced from the second surface 114 by a small gap.

Here, the first surface 1341 may be a curved surface, which may improve the adhesion between the first surface 1341 and the second surface 114. In other embodiments, the first surface 1341 may also be flat.

Here, the second surface 114 may be curved, which may improve the adhesion between the first surface 1341 and the second surface 114. In other embodiments, the second surface 114 may also be flat.

Here, the first surface 1341 may be a curved surface, and the second surface 114 may also be a curved surface adapted to the first surface 1341, which may further improve the adhesion between the first surface 1341 and the second surface 114.

Here, as shown in FIG. 40, the first fixing member 171 may be fixed to the first end 131A and the extension portion 134 of the connection component 13 by bonding, snap-fitting, welding, or other manners. The first fixing member 171 may be connected to the second shell 12 by bonding, snap-fitting, welding, or other manners. By fixing the first fixing member 171 to the first end 131A and the extension portion 134 of the connection component 13, the connection strength between the connection component 13 and the second shell 12 may be improved. In other embodiments, the first fixing member 171 may also be fixed to one of the first end 131A and the extension portion 134 of the connection component 13.

As shown in FIG. 40, the length H5 of the extension portion 134 may be 7 mm to 8 mm, 7.5 mm to 8 mm, 7 mm to 7.5 mm, etc. The extension portion 134 with an appropriate length may increase the connection strength between the connection component 13 and the second shell 12, and the overall ear-clip earphone 4 may further appear smooth and aesthetic, thereby improving the user experience of the ear-clip earphone 4.

As shown in FIGS. 40 and 49, a first mounting hole 1342 may be defined at the side of the extension portion 134 facing away from the second shell 12. The ear-clip earphone 4 may also include a decorative component 173. The decorative component 173 may be fixed to the first mounting hole 1342 by bonding, snap-fitting, welding, and other manners. The decorative component 173 allows the ear-clip earphones 4 to have different appearances. For example, the material, the color, or the surface texture of the decorative component 173 may be different from that of the extension portion 134.

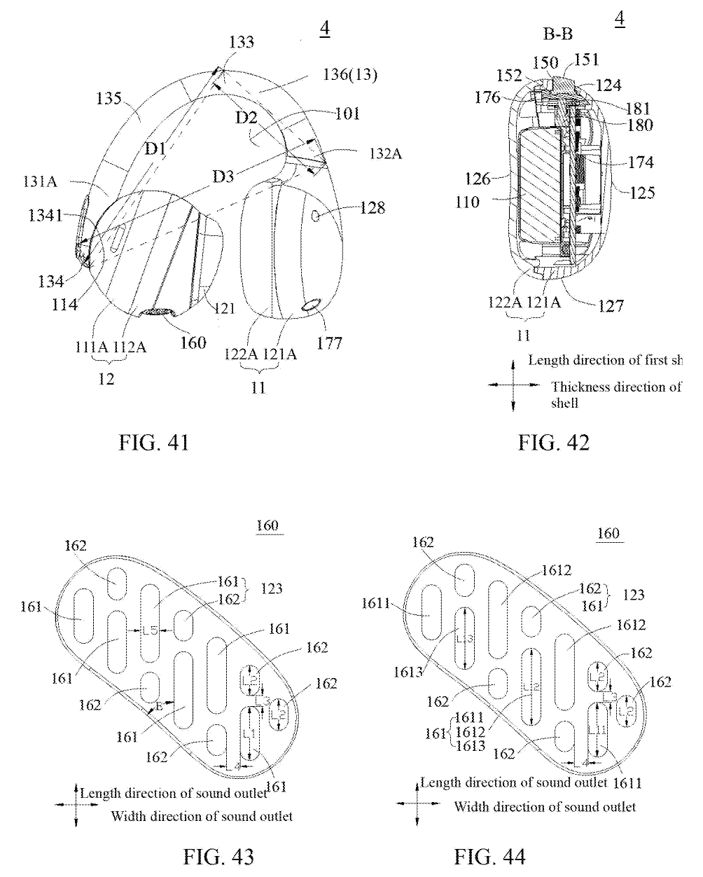

In one embodiment, as shown in FIGS. 40 and 41, the first shell 11 may include a connection part 123A that is convexly arranged. The connection part 123A may be connected to the second end 132A of the connection component 13 by bonding, snap-fitting, welding, or other manners. The first shell 11 is connected to the second end 132A of the connection component 13 through the connection part 123A, which may allow the connection area to be smooth and neat, and reduce the size of the second end 132A of the connection component 13 such that the ear-clip earphone 4 may be lightweight.

Here, the second end 132A of the connection component 13 may include a first inclined surface 1321, and the connection part 123A may include a second inclined surface 1231. The first inclined surface 1321 and the second inclined surface 1231 cooperate with each other to increase the contact area between the connection part 123A and the second end 132A of the connection component 13, thereby improving the connection strength between the connection part 123A and the second end 132A of the connection component 13. In other embodiments, the connection part 123A and the second end 132A of the connection component 13 may also be in contact with each other through two flat surfaces.

In one embodiment, as shown in FIG. 41, the maximum distance D1 between the fitting portion 133 and the extension portion 134 may be 24.5 mm to 26.5 mm, 24 mm to 27 mm, 24.5 mm to 25.5 mm, 25.5 mm to 26.5 mm, etc. Thus, the extension portion 134 may increase the clamping space of the ear-clip earphone 4 for clamping the ear, and also increase the connection strength between the connection component 13 and the second shell 12.

Here, the maximum distance D3 between the second end 132A and the extension portion 134 of the connection component 13 may be 26.5 mm to 28.5 mm, 26.5 mm to 27.5 mm, 27.5 mm to 28.5 mm, 26.5 mm to 27 mm, 27 mm to 28.5 mm, etc. The first end 131A of the connection component 13 is connected to the side of the second shell 12 facing away from the first shell 11, which may greatly increase the clamping space of the ear-clip earphone 4 for clamping the ear.

In one embodiment, the maximum distance D2 between the fitting portion 133 and the second end 132A of the connection component 13 may be 13.5 mm to 15.5 mm, 13.5 mm to 14.5 mm, 14.5 mm to 15.5 mm, 13.5 mm to 14 mm, 14mm to 15.5 mm, 13.5 mm to 15 mm, etc.

In one embodiment, the operation button 150 may be movably arranged on the first shell 11; The operation button 150 and the connection component 13 are located at two adjacent sides of the first shell 11, respectively, as shown in FIGS. 37 and 38.

The inventors have found that the operating structure of the earphone may often be incorrectly operated caused by the shaking of the earphone, making the operation of the earphone inconvenient. For example, the operation structure of the earphone may often fail such that multiple times of operation is required. The operation button 150 and the connection component 13 of the present application are located at two adjacent sides of the first shell 11, respectively. Thus, the user may operate the earphone 4 by gripping the operation button 150 with his index finger and thumb. Here, the first shell 11 and the operation button 150 are clamped between the index finger and thumb of the user, which may prevent the operation button 150 and the first shell 11 from shaking, reduce the mis-operation on the operation button 150, and greatly improve the convenience of operating the earphone 4.

In one embodiment, the operation button 150 and the connection component 13 may be located at two adjacent sides of the first shell 11, and the two adjacent sides of the first shell 11 are not the two sides along the thickness direction of the first shell 11.

In the embodiment of the present application, when the earphone 4 is worn, the second shell 12 may be located at the front side of the ear, the first shell 11 may be located at the back side of the ear, and the connection component 13 may be substantially arranged along the horizontal direction. The operation button 150 may be located at the top side of the first shell 11, as shown in FIG. 36 illustrating a specific state of the ear-clip earphone 4. Here, the user may contact a bottom side of the first shell 11 along the length direction of the first shell 11, and operate the operation button 150 by the index finger. The user may also simultaneously squeeze the ear-clip earphone 4 with the thumb and index finger to operate the operation button 150. Since the operation button 150 and the first shell 11 are located between the index finger and thumb, the operation button 150 may be accurately operated.

In other embodiments, when the earphone 4 is worn, the operation button 150 may also be located at the bottom side of the first shell 11. Here, the operation button 150 and the first shell 11 are located between the index finger and thumb, such that the operation button 150 may be accurately operated.

In one embodiment, the operation button 150 is used to control the sound emitting assembly 120 to output sound. For example, the operation button 150 may control the volume, the playing order of audios, and control the sound emitting assembly 120 when to start to stop playing the audios.

In one embodiment, as shown in FIGS. 37 and 42, the ear-clip earphone 4 may further include a control button 180. The control button 180 may be fixed to the first circuit board 174 by bonding, welding, or other manners. A fifth portion 181 of the control button 180 protrudes from the edge side of the first circuit board 174. The operation button 150 corresponds to the position of the fifth portion 181 of the control button 180 to press the control button 180. By setting the fifth portion 181 of the control button 180 to protrude from the edge side of the first circuit board 174, the operation button 150 can press the control button 180 by pressing the fifth portion 181 of the control button 180.

The thickness direction of the first circuit board 174 may be the same or substantially the same as the thickness of the first shell 11. The operation button 150 is located at the side of the first shell 11, and the side of the first shell 11 is not any of the two sides of the first shell 11 along the thickness direction. By arranging the fifth portion 181 of the control button 180 to protrude from the edge side of the first circuit board 174, the space utilization of the first shell 11 may be improved.

As shown in FIG. 42, the first shell 11 may define an installation through hole 124. The operation button 150 is movably arranged at the installation through hole 124. The ear-clip earphone 4 may also include a reset component 176 received in the first shell 11. The reset component 176 is connected to the inner wall of the installation through hole 124. The reset component 176 has elasticity. The operation button 150 presses the control button 180 through the reset component 176.

When the external force is applied onto the operation button 150, the operation button 150 moves toward the control button 180 and pushes the reset component 176 to come into contact with the control button 180. Thus, the control button 180 operates, and the reset component 176 deforms. When the external force is removed, the rebounding force of the reset component 176 will move the operation button 150 away from the control button 180, and the pressing force from the reset component 176 onto the control button 180 is removed.

The material of the reset component 176 is not limited. For example, the reset component 176 may be made of an elastic polymer material such as silicone or rubber. The gap between the reset component 176 and the inner wall of the installation through hole 124 may be sealed with a sealant or a sealing structure, so that the first shell 11 is sealed at the installation through hole 124 to prevent external liquids from entering the first shell 11.

Here, when the operation button 150 is not pressed, the reset component 176 may be in contact with the control button 180 or spaced from the control button 180 by a small gap. The operation button 150 may be in contact with the reset component 176 or spaced from the reset component 176 by a small gap.

In one embodiment, the first shell 11 may include a first exposing surface 125 and a first mating surface 126, which are opposite to each other along the thickness direction of the first shell 11. The first shell 11 may further include a connection side surface 127 that is connected to the first exposing surface 125 and the first mating surface 126. The operation button 150 and the connection component 13 are located at two adjacent sides of the connection side surface 127 as shown in FIG. 46, such that the operation button 150 will not affect the wearing of the earphone 4 and easy to be operated. The first mating surface 126 may be used to fit with the ear.

Here, the operation button 150 may be located at one of two sides of the first shell 11 along the length direction of the first shell 11. The connection component 13 may be located at one of two sides of the first shell 11 along the width direction of the first shell 11.

In one embodiment, the thickness of the operation button 150 may be the same or different along the moving direction of the operation button 150.

As shown in FIG. 42, the operation button 150 may include a second mating surface 152 and a second exposing surface 151, which are opposite to each other along the moving direction of the operation button 150. The second exposing surface 151 may be a curved surface. The connection side surface 127 of the first shell 11, where the operation button 150 is located, may be curved. The curving direction of the second exposing surface 151 may match the curving direction of the connection side surface 127 of the first shell 11, such that the operation buttons 150 located at the connection side surface 127 can match the shape of the connection side surface 127, thereby improving the smoothness and flatness of the ear-clip earphone 4. In other embodiments, the second exposing surface 151 and the second mating surface 152 may also be flat, which may be easily manufactured.

In one embodiment, the operation button 150 may be located at one of two sides of the first shell 11 along the length direction of the first shell 11. The connection component 13 may be located at one of two sides of the first shell 11 along the width direction of the first shell 11. Thus, the connection component 13 and the operation button 150 will not affect or interfere with each other. At the same time, when the earphone 4 is worn, the connection component 13 is substantially located along the horizontal direction, the length direction of the first shell 11 is substantially the vertical direction, and the width direction of the first shell 11 is substantially the horizontal direction. Since the first shell 11 sandwiched between the ear and head has a small size along the width direction of the first shell 11, the wearing comfort of the ear-clip earphone 4 may be improved. In other embodiments, the operation button 150 may also be located at one of two sides of the first shell 11 along the width direction of the first shell 11. The connection component 13 may also be located at one of two sides of the first shell 11 along the length direction of the first shell 11.

The operation button 150 may be strip-shaped and extend along the width direction of the first shell 11, thereby increasing the contact area between the user and the operation button 150 and improving the pressing feelings of the user.

In the embodiment of the present application, the operation button 150 and the connection component 13 may be connected to two adjacent edges of the exposing half shell 121A. The mating half shell 122A may be connected to the exposing half shell 121A by bonding, snap-fitting, welding, and other manners. The half shell 122A may be used to fit with the ear. By connecting the operation button 150 and the connection component 13 to the exposing half shell 121A, it is convenient to operate the operation button 150, and may prevent the operation button 150 and the connection component 13 from affecting the attachment between the mating half shell 122A and the ear.

As shown in FIG. 39, in one embodiment, the ear-clip earphone 4 may include a sound output component 160. The sound output component 160 may be provided on the second shell 12. The sound output component 160 defines at least two sound outlets 123 each communicating with the audio chamber 122. Each of the sound outlets 123 may be strip-shaped.

The inventors have found that when the sound outlet of the earphone is generally circular, the sound waves of the earphone have the same transmission characteristics along all directions, resulting in poor adaptability of the earphone. The sound outlets of the present application are strip-shaped. Thus, the sound outlet has a smaller size along the width direction of the sound outlet, which may improve the diffraction characteristics of the sound waves along the width direction of the sound outlet. Also, the sound outlet also has a larger size along the length direction of the sound outlet, such that the sound waves of some wavelengths may be directly transmitted without being blocked, thereby allowing the sound waves to be more focus along the length direction of the sound outlet, improving the sound utilization rate of the sound waves along the length direction of the sound outlet, and enhancing the adaptability of the ear-clip earphone 4. For example, when the earphone 4 is worn, the sound waves may be concentratedly transmitted to the cavity of auricular concha, thereby enabling more sound waves to be transmitted to the cavity of auricular concha and improving the effective utilization of the sounds from of the ear-clip earphone 4.

In one embodiment, the sound output component 160 may be fixed to the second shell 12 by bonding, snap-fitting, welding, or other manners. By separately forming the sound output component 160 and the second shell 12, the sound output component 160 may be easily processed. In other embodiments, the sound output component 160 and the second shell 12 may also be integrally formed as a whole.

In one embodiment, the lengths of the at least two sound outlets 123 may be the same or different from each other. When the lengths of the at least two sound outlets 123 are different from each other, the sound waves of different wavelengths may be transmitted more concentratedly, and more sound outlets 123 may be included.

In an embodiment, the at least two sound outlets 123 may include a first sound outlet 161 and a second sound outlet 162. The length of the first sound outlet 161 may be greater than the length of the second sound outlet 162.

Here, the length L1 of the first sound outlet 161 may be greater than 1 mm, 1.5 mm, 2mm, etc. As an example, the length of the first sound outlet 161 may be 1.2 mm to 2 mm, 1.2 mm to 1.9 mm, 1.3 mm to 2 mm, 1.4 mm to 2 mm, 1.5 mm to 2 mm, 1.6 mm to 2 mm, 1.7 mm to 2 mm, 1.8 mm to 2 mm, etc.

Here, the length L2 of the second sound outlet 162 may be less than 1 mm. As an example, the length of the second sound outlet 162 may be 0.7 mm to 0.9 mm, 0.7 mm to 0.8 mm, 0.8 mm to 0.9 mm, etc.

The first sound outlet 161 and the second sound outlet 162 may be spaced apart from each other along the length direction of the sound outlet 123. Thus, in the case that the installation space is the same, it is possible to arrange the longer first sound outlet 161, and at the same time arrange the shorter second sound outlet 162 to increase the overall space of the sound outlets 123.

The distance L3 between the first sound outlet 161 and the second sound outlet 162 along the longitudinal direction may be 0.2 mm to 0.3 mm, 0.25 mm to 0.3 mm, 0.2 mm to 0.25 mm, etc.

The at least two sound outlets 123 may be spaced apart from each other along the width direction of the sound outlet 123. The distance L4 between two adjacent sound outlets 123 along the width direction may be 0.25mm to 0.4mm, 0.25mm to 0.35mm, 0.25mm to 0.3mm, 0.3mm to 0.4mm, 0.35mm to 0.4mm, etc. By arranging the appropriate distance L4 along the width direction of the sound outlet 123, the area for setting the sound outlets 123 may be greatly increased.

Here, as shown in FIGS. 43 and 44, along the width direction of the sound outlet 123, one first sound outlet 161 may be adjacent to another first sound outlet 161 and another second sound outlet 162, and one second sound outlet 162 may be adjacent to another first sound outlet 161. By alternately arranging the first sound outlet 161 and the second sound outlet 162 along the width direction of sound outlet 123, the transmission performance of the sound waves of different wavelengths may be more uniform at various regions.

In one embodiment, as shown in FIG. 44, the first sound outlet 161 may include two first-sub-typed first sound outlets 1611 and a second-sub-typed first sound outlet 1612. The first-sub-typed first sound outlets 1611 are located at two ends of the sound output component 160 along the width direction of the sound outlet 123. The second-sub-typed first sound outlet 1612 may be located at the middle area of the sound output component 160 along the width direction of the sound outlet 123. The length of the second-sub-typed first sound outlet 1612 may be greater than the length of the first-sub-typed first sound outlet 1611, thereby facilitating the arrangement of the longer second-sub-typed first sound outlet 1612 at the middle area of the sound output component 160.

The first sound outlet 161 may further include a third-sub-typed first sound outlet 1613. Along the width direction of the sound outlet 123, the third-sub-typed first sound outlet 1613 may be located between the first-sub-typed first sound outlet 1611 and the second-sub-typed first sound outlet 1612. The length of the third-sub-typed first sound outlet 1613 may be greater than the length of the first-sub-typed first sound outlet 1611, and less than the length of the second-sub-typed first sound outlet 1612. By arranging the first sound outlets 161 to have different lengths, the wavelength range of the sound waves that are concentratedly transmitted to the ear may be increased, thereby enabling more sound waves of different wavelengths to be concentratedly transmitted.

In other embodiments, the first sound outlet 161 may also include one or two of the first-sub-typed first sound outlet 1611, the second-sub-typed first sound outlet 1612, and the third-sub-typed first sound outlet 1613.

The length L11 of the first-sub-typed first sound outlet 1611 may be 1.3 mm to 1.5 mm, 1.3 mm to 1.4 mm, 1.4 mm to 1.5 mm, etc. The length L12 of the second-sub-typed first sound outlet 1612 may be 1.8 mm to 2 mm, 1.9 mm to 2 mm, 1.8 mm to 1.9 mm, etc. The length L13 of the third--sub-typed first sound outlet 1613 may be 1.4 mm to 1.6 mm, 1.5 mm to 1.6 mm, 1.4 mm to 1.5 mm, etc.

The cross-sectional area of the first-sub-typed first sound outlet 1611 may be 0.6 mm² to 0.7 mm², 0.6 mm² to 0.65 mm², 0.65 mm² to 0.7 mm², etc. The cross-sectional area of the second-sub-typed first sound outlet 1612 may be 0.85 mm² to 0.9 mm², 0.8 mm² to 0.9 mm², 0.85 mm² to 0.95 mm², etc. The cross-sectional area of the third-sub-typed first sound outlet 1613 may be 0.7 mm² to 0.8 mm², 0.7 mm² to 0.75 mm², 0.75 mm² to 0.8 mm², etc.

In one embodiment, the width L5 of the sound outlet 123 may be 0.4 mm to 0.6 mm, 0.4 mm to 0.5 mm, 0.4 mm to 0.5 mm, etc.

In one embodiment, the cross-section of the sound outlet 123 may be waist-shaped, thereby allowing the sound waves to propagate through the smooth sound outlet 123. In other embodiments, the cross-section of the sound outlet 123 may also be elliptical.

In one embodiment, as shown in FIG. 43, the sound output component 160 may be strip-shaped. The length direction of the sound output component 160 and the length direction of the sound outlet 123 may be different from each other. In other embodiments, the sound output component 160 may not be strip-shaped, or the length direction of the sound output component 160 may be the same as the length direction of the sound outlet 123.

As shown in FIG. 43, a first angle E is defined between the length direction of the sound output component 160 and the length direction of the sound outlet 123. The first angle E may be 40 degrees to 60 degrees, 40 degrees to 50 degrees, 50 degrees to 60 degrees, 45 degrees to 60 degrees, 55 degrees to 60 degrees, etc.

As shown in FIG. 46, in one embodiment, the sound collector 194 may be installed inside the first shell 11. An angle K1 formed between the first plane O where the sound outlet 128 is located and the symmetrical plane I of the connection component 13 is less than or equal to 60 degrees. The first plane O is a plane defined by the contour of the sound collection hole 128 formed on a first outer surface 1251 of the first shell 11.

The inventors have found that when the earphone 3 is worn, the surface of some earphones, where the sound collection holes are located, may often be vertically arranged, such that the external wind will directly blow into the sound collection holes to generate wind noise. The wind noise affects the sound collection of the sound collector and further affects the sound collection effect of the earphone. In the present application, the angle K1 defined between the first plane O where the sound collection hole 128 is located and the symmetrical plane I of the connection component 13 is less than or equal to 60 degrees. When the earphone 4 is worn, the connection component 13 may substantially be horizontal, and the first plane O where the sound collection hole 128 is located is not vertically arranged, which can reduce the amount of the external wind blowing into the sound collection hole 128, thereby reducing the impact of the wind noise on the sound collection of the sound collector 194 and improving the sound collection effect of the ear-clip earphone 4.

The structure of the connection component 13 at two sides of the symmetrical plane I may be the same or substantially the same. The symmetrical plane I of the connection component 13 may be parallel or substantially parallel to the width direction of the first shell 11. The symmetrical plane I of the connection component 13 may also be the symmetrical plane of the first shell 11, and the structure of the first shell 11at two sides of the symmetrical plane I of the connection component 13 may be the same or substantially the same. The symmetrical plane I of the connection component 13 may also be the symmetrical plane of the second shell 12, and the structure of the second shell 12 at two sides of the symmetrical plane I of the connection component 13 may be the same or substantially the same, as shown in FIG. 36.

In one embodiment, the contour of the sound collection hole 128 formed on the first outer surface 1251 may be entirely located at the first plane O or symmetrical relative to the first plane O. For example, the contour of the sound collection hole 128 formed on the first outer surface 1251 may be straight, and is entirely located on the first plane O. For example, the contour of the sound collection hole 128 formed on the first outer surface 1251 may also be curved; the contour of the sound collection hole 128 formed on the first outer surface 1251 has a portion located at the first plane O and another portion located at two sides of the first plane O, and the maximum distance from the contour of the sound collection hole 12 to the first plane O is substantially the same. In other words, the contour of the sound collection hole 128 formed on the first outer surface 1251 is symmetrically arranged at two sides of the first plane O.

In one embodiment, the angle K1 defined between the first plane O and the symmetrical plane I of the connection component 13 may be 40 degrees to 55 degrees, 40 degrees to 50 degrees, 45 degrees to 55 degrees, 45 degrees to 55 degrees, 45 degrees to 60 degrees, 40 degrees to 60 degrees, etc.

In one embodiment, the first outer surface 1251 may be curved. By arranging the sound collection hole 128 on the curved surface, the curved surface may provide a guiding function for the sound waves, thereby allowing the external sound waves to be easily transmitted into the first shell 11 through the sound collection hole 128 and then collected by the sound collector 194. In other embodiments, the first outer surface 1251 may also be flat.

In one embodiment, the first outer surface 1251 may be in an exposed state to ensure that the sound collection hole 128 is not blocked, thereby improving the sound collection effect of the sound collection hole 128.

In one embodiment, as shown in FIGS. 46 and 47, the first outer surface 1251 is located at the side of the first exposing surface 125 near the connection side surface 127. Thus, the exposed sound collection hole 128 may improve the sound collection effect, and the first outer surface 1251 near the connection side surface 127 may reduce the distance between the sound collection hole 128 and the mouth of the user.

As shown in FIG. 48, the first shell 11 may include a long axis P1. The long axis P1 may be the line connecting the two farthest endpoints of the first shell 11 along the length direction of the first shell 11.

The sound collection hole 128 may be located at the side close to the long axis P1 along the width direction of the first shell 11, thereby reducing the distance between the sound collection hole 128 and the mouth of the user and improving the sound collection effect of the sound collection hole 128. In other embodiments, the sound collection hole 128 may also be located at the side away from the long axis P1 along the width direction of the first shell 11.

The distance Q2 between the sound collection hole 128 and the long axis P1 may be smaller than the distance Q1 between the sound collection hole 128 and the second end 132A of the connection component 13, thereby reducing the distance between the sound collection hole 128 and the mouth of the user and improving the sound collection effect of the sound collection hole 128. In other embodiments, the distance Q2 between the sound collection hole 128 and the long axis P1 may also be greater than or equal to the distance Q1 between the sound collection hole 128 and the second end 132A of the connection component 13.

The distance Q2 between the sound collection hole 128 and the long axis P1 may be 2.5 mm to 3.5 mm, 2.5 mm to 3 mm, 3 mm to 3.5 mm, etc. The distance Q1 between the sound collection hole 128 and the second end 132A of the connection component 13 may be 4.5 mm to 5.5 mm, 4.5 mm to 5 mm, 5 mm to 5.5 mm, etc.

The extension direction P2 of the sound collection hole 128 may be unparallel to the symmetrical plane I of the connection component 13. If the extension direction P2 of the sound collection hole 128 is parallel to the symmetrical plane I of the connection component 13, when the earphone 4 is worn, most of the external wind will directly blow into the sound collection hole 128 to generate wind noise, which reduces the sound collection effect. By setting the extension direction P2 of the sound collection hole 128 to be unparallel to the symmetrical plane I of the connection component 13, the amount of external wind blowing into the sound collection hole 128 may be reduced, thereby reducing the impact of the wind noise on the sound collection of the sound collector 194 and improving the sound collection effect of the ear-clip earphone 4.

As shown in FIG. 48, the extension direction P2 of the sound collection hole 128 may be perpendicular to the symmetrical plane I of the connection component 13. Here, the external wind will not blow into the sound collection hole 128, thereby greatly reducing the impact of the wind noise on the sound collection of the sound collector 194 and improving the sound collection effect of the ear-clip earphone 4.

The angle K2 formed by the extension direction P2 of the sound collection hole 128 and the symmetrical plane I of the connection component 13 may be 80 degrees to 110 degrees, 80 degrees to 100 degrees, 80 degrees to 90 degrees, 90 degrees to 110 degrees, 90 degrees to 100 degrees, etc. By setting the extension direction P2 of the sound collection hole 128 to be substantially perpendicular to the symmetrical plane I of the connection component 13, the impact of the wind noise on the sound collection of the sound collector 194 may be greatly reduced to improve the sound collection effect of the ear-clip earphone 4.

In one embodiment, there may be two sound collection holes 128, which are symmetrically arranged relative to the symmetrical plane I of the connection component 13. One of the two sound collection holes 128 is used to collect the voice of the user, and another of the two sound collection holes 128 is used to collect the sound from the external environment. The symmetrically arranged sound collection holes 128 allows the ear-clip earphone 4 to be worn interchangeably on the left ear and the right ear, thereby improving the adaptability of the ear-clip earphone 4.

In one embodiment, there may be two sound collectors 194. One of the two sound collectors 194 is used to collect the sound of the wearer, and another of the two sound collectors 194 is used to collect the sound from the external environment, thereby reducing the noise of the ear-clip earphone 4.

One of the two sound collectors 194 corresponds to one of the two sound collection holes 128, and another of the two sound collectors 194 corresponds to another of the two sound collection holes 128.

In one embodiment, the ear-clip earphone 4 may further include a sound guiding assembly 190. The sound guiding assembly 190 is received inside the first shell 11. The sound guiding assembly 190 defines a sound guiding channel 193. One end of the sound guiding channel 193 communicates with the sound collection hole 128, and another end of the sound guiding channel 193 corresponds to the position of the sound collector 194. The extension direction of the sound guiding channel 193 is different from the extension direction of the sound collection hole 128, such that the sound collection effect of the sound collector 194 may be improved through the sound guiding channel 193.

As shown in FIG. 47, the sound collector 194 may be fixed to the first circuit board 174 by bonding, welding, snap-fitting, or other manners. The sound guiding assembly 190 and the sound collector 194 are located at two opposite sides of the first circuit board 174 along the thickness direction of the first circuit board 174. The first circuit board 174 defines a sound guiding hole 1741. One end of the sound guiding hole 1741 communicates with the sound guiding channel 193, and another end of the sound guiding hole 1741 faces a sound collection surface of the sound collector 194. By transmitting the sound through the sound guiding hole 1741 and the sound guiding channel 193, the sound collection effect of the sound collector 194 may further be improved.

The sound guiding assembly 190 may include a sound guiding component 191 and a sealing component 192. The sound guiding component 191 may be installed inside the first shell 11 and connected to the inner wall of the first shell 11. The sound guiding channel 193 may be provided on the sound guiding component 191. The sealing component 192 may be located between the sound guiding component 191 and the first circuit board 174 to seal the gap between the sound guiding component 191 and the first circuit board 174. Thus, noise may be prevented from entering the sound guiding channel 193 through the gap between the sound guiding component 191 and the first circuit board 174, thereby improving the sound collection effect of the sound collector 194. At the same time, the liquid in the sound guiding channel 193 may also be prevented from entering other areas inside the first shell 11 through the gap between the sound guiding component 191 and the first circuit board 174.

The sound guiding component 191 may be installed inside the first shell 11 by bonding, welding, snap-fitting, or other manners. The sound guiding component 191 and the first shell 11 may also be integrally formed with each other.

The structure of the sealing component 192 is not limited. For example, the sealing component 192 may be cylindrical, annular, etc. The sound guiding channel 193 and the sound collector 194 may be connected to each other through the cavity of the sealing component 192.

In an embodiment, the extension direction P3 of the sound guiding channel 193 may be perpendicular to the extension direction P2 of the sound collection hole 128.

In one embodiment, as shown in FIGS. 51 and 53, the sound emitting assembly 120 may divide the audio chamber 122 into a front chamber 1131 and a rear chamber 1132. The second shell 12 may define the sound outlet 123 that communicates with the front chamber 1131, and the second shell 12 may define the rear-side chamber hole 115 that communicates with the rear chamber 1132. The rear-side chamber hole 115 is located at the clamping space 101 and close to the connection component 13.

The inventors have found that dust may often enter the hole structure of the earphone, which affects the audio effect of the earphone. The ear-clip earphone 4 of the present application has the rear-side chamber hole 115 located at the clamping space 101 and close to the connection component 13. In other words, the rear-side chamber hole 115 is located at the side of the second shell 12 facing the connection component 13. The connection component 13 may cover at least a portion of the rear-side chamber hole 115, thereby preventing external dust from entering the rear-side chamber hole 115 to affect the audio effect of the ear-clip earphone 4, and thus improving the audio effect of the ear-clip earphone 4. At the same time, since the connection component 13 may cover at least a portion of the rear-side chamber hole 115, the second shell 12 may appear neat and integral as a whole, thereby improving the user experience of the ear-clip earphone 4.

In one embodiment, as shown in FIG. 50, the second shell 12 may define only one rear-side chamber hole 115. Compared to two or more rear-side chamber holes 115, only one rear-side chamber hole 115 may reduce the processing difficulty of the ear-clip earphone 4. Here, in the case that the total cross-sectional area of the rear-side chamber holes 115 is the same, one rear-side chamber hole 115 with large cross-sectional area is easier to process and manufacture.

In one embodiment, the cross-sectional area of the sound outlet 123 may be the same as or close to the cross-sectional area of the rear-side chamber hole 115. By arranging the cross-sectional area of the rear-side chamber hole 115 to approach the cross-sectional area of the sound outlet 123, high-frequency sound leakage may be offset, thereby reducing the sound leakage and improving the audio effect of the ear-clip earphone 4.

The difference between the cross-sectional area of the sound outlet 123 and the cross-sectional area of the rear-side chamber hole 115 may be less than or equal to 2.5 mm², 2 mm², 1.5 mm², 1 mm², etc. Alternatively, the difference between the cross-sectional area of the sound outlet 123 and the cross-sectional area of the rear-side chamber hole 115 may be 1.5 mm² to 2.5 mm², 1.5 mm² to 2 mm², 2 mm² to 2.5 mm², etc. By arranging the cross-sectional area of the sound outlet 123 to approach the cross-sectional area of the rear-side chamber hole 115, high-frequency sound leakage may be offset, thereby reducing the sound leakage and improving the audio effect of the ear-clip earphone 4.

In one embodiment, the cross-sectional area of the rear-side chamber hole 115 may be greater than or equal to 3 mm², 4 mm², 4.5 mm², 5 mm², etc. The cross-sectional area of the rear-side chamber hole 115 may be 4.5 mm² to 5.5 mm², 4.5 mm² to 5 mm², 5 mm² to 5.5 mm², etc.

In one embodiment, when there are at least two sound outlets 123, the sum of the total cross-sectional areas of the at least two sound outlets 123 may be greater than or equal to 4 mm², 5 mm², 6 mm², etc. The cross-sectional area of the rear-side chamber hole 115 may be 4 mm² to 6 mm², 4 mm² to 5 mm², 5 mm² to 6 mm², etc.

In one embodiment, the rear-side chamber hole 115 may be located at the side of the second shell 12 near the first end 131A of the connection component 13. By positioning the rear-side chamber hole 115 at the side close to the first end 131A of the connection component 13, the distance between the connection component 13 and the rear-side chamber hole 115 may further be reduced, thereby improving the effect of the connection component 13 covering the rear-side chamber hole 115.

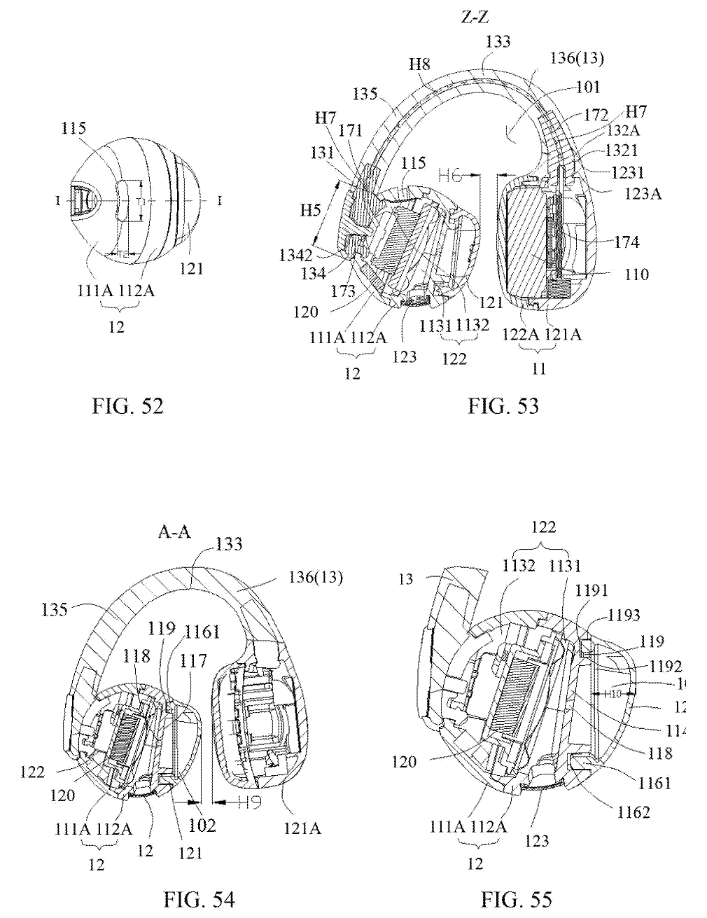

In one embodiment, as shown in FIGS. 51 and 52, a portion of the rear-side chamber hole 115 may be located at the symmetrical plane I of the connection component 13, such that the connection component 13 may cover more areas of the rear-side chamber hole 115. In other embodiments, the portion of the rear-side chamber hole 115 may not be located at the symmetrical plane I of the connection component 13.

In one embodiment, as shown in FIGS. 51 and 52, the rear-side chamber hole 115 may be symmetrically arranged with respect to the symmetrical plane I of the connection component 13. Thus, the connection component 13 may uniformly cover the rear-side chamber hole 115, and the second shell 12 may also appear neat and integral, thereby improving the user experience of the ear-clip earphone 4. In other embodiments, the rear-side chamber hole 115 may also be asymmetrically arranged relative to the symmetrical plane I of the connection component 13.

In one embodiment, as shown in FIG. 53, the sound outlet 123 and the rear-side chamber hole 115 may be located at two opposite sides of the second shell 12, thereby increasing the distance between the sound outlet 123 and the rear-side chamber hole 115, offsetting the high-frequency sound leakage, reducing the sound leakage, and improving the audio effect of the ear-clip earphone 4.

In one embodiment, as shown in FIGS. 50 and 52, the cross-section of the rear-side chamber hole 115 may be strip-shaped. Thus, the cross-sectional area of the rear-side chamber hole 115 may offset the high-frequency sound leakage, and the impact of the rear-side chamber hole 115 on the strength of the second shell 12 may be reduced.

As shown in FIG. 52, the length T1 of the cross-section of the rear-side chamber hole 115 may be 4 mm to 5 mm, 4.5 mm to 5 mm, 4 mm to 4.5 mm, etc. The width T2 of the cross-section of the rear-side chamber hole 115 may be 1 mm to 1.4 mm, 1.1 mm to 1.4 mm, 1.2 mm to 1.4 mm, 1.3 mm to 1.4 mm, etc.

The cross-section of the rear-side chamber hole 115 may be arranged along a curved trajectory. The cross-section of the rear-side chamber hole 115 may also be arranged along a straight trajectory.

As shown in FIG. 53, in one embodiment, the sound outlet 123 may be located at the side of the second shell 12 away from the fitting portion 133. The rear-side chamber hole 115 may be located at the side of the second shell 12 close to the fitting portion 133. Thus, the connection component 13 may cover the rear-side chamber hole 115, and the high-frequency sound leakage may be offset through the rear-side chamber hole 115.

In one embodiment, the rear-side chamber hole 115 may be provided on the first half shell 111A. The sound outlet 123 may be provided on the second half shell 12A. The sound emitting assembly 120 may be installed in the second half shell 112A, and located within the audio chamber 122 defined by the first half shell 111A and the second half shell 112A.

In one embodiment, a third cavity 102 is defined between the elastic component 121 and the second shell 12. Since the elastic component 121 may be an airbag, the third cavity 102 may also be referred to as an airbag cavity. The third cavity 102 communicates with the audio chamber 122.

When the earphone 4 is worn, the second shell 12 may be located at the front side of the ear, and substantially located at the cavity of auricular concha of the user. The audio from the sound emitting assembly 120 inside the second shell 12 may be transmitted to the cavity of auricular concha. The first shell 11 may be located at the back side of the ear. The connection component 13 may be in contact with the helix or spaced from the helix by a gap. By clamping the second shell 12 and the first shell 11 at two opposite sides of the ear bone, the ear-clip earphone 4 may be stably worn on the ear. Since the elastic component 121 is located at the side of the second shell 12 facing the first shell 11, the second shell 12 can come into contact with the ear through the elastic component 121, thereby reducing the clamping force of the ear-clip earphone 4 on the ear due to the deformation of the elastic component 121. During the wearing process, the elastic component 121 may adapt to the deformation of the ear, thereby improving the wearing comfort of the ear-clip earphone 4. When the elastic component 121 is deformed, since the third cavity 102 communicates with the audio chamber 122, the gas in the third cavity 102 may enter the audio chamber 122 under the compression force of the elastic component 121, thereby allowing the elastic component 121 to self-fittingly and rapidly deform. Thus, larger space may be provided for the deformation of the elastic component 121, thereby allowing the ear-clip earphone 4 to adapt to ears of different sizes and types. After the earphone 4 is worn, the elastic component 121 may rebound based on deformation force. Thus, the gas in the audio chamber 122 may enter the third cavity 102, such that the elastic component 121 may quickly recover its shape to adapt to the wearing position of the earphone 4 being worn, thereby improving the comfort and stability of the ear-clip earphone 4 through the elastic component 121. At the same time, by arranging the third cavity 102 to communicate with the audio chamber 122, the rapid deformation and recovery ability of the elastic component 121 may be greatly improved, and the adaptability of the ear-clip earphone 4 to ears of different sizes and shapes may be enhanced.

The inventors have found that a painful discomfort may generate when the ear-clip earphone is clamped on the user for a long time, thereby affecting the wearing experience of the ear-clip earphone. In the present application, the ear-clip earphone 4 has the elastic component 121 located at the side of the second shell 12 facing the first shell 11. When the earphone 4 is worn, the elastic component 121 and the ear are located between the second shell 12 and the first shell 11. The clamping force of the ear-clip earphone 4 on the ear may be reduced through the deformation of the elastic component 121, thereby preventing the ear-clip earphone 4 from hurting the ear when being worn for a long time. At the same time, since the elastic component 121 and the second shell 12 cooperatively define the third cavity 102 that communicates with the audio chamber 122, the elastic component 121 may quickly deform and discharge gas toward the audio chamber 122 when compressed, thereby quickly fitting with the ear. In addition, when the pressure applied onto the elastic component 121 decreases or disappears, the gas can quickly enter the third cavity 102 through the audio chamber 122, thereby enabling the elastic component 121 to quickly rebound. Thus, the problem of the elastic component 121 being unable to rebound or having a slow rebound speed may be solved.

Moreover, since the sound outlet 123 communicates with the audio chamber 122, when the ear-clip earphone 4 is worn, the gas in the third cavity 102 may easily enter the audio chamber 122 and the gas in the audio chamber 122 may also easily enter the third cavity 102 during the deformation and rebound process of the elastic component 121, thereby improving the rebound ability of the elastic component 121. At the same time, the ear-clip earphones 4 no longer deforms after being worn, the gas between the third cavity 102 and the audio chamber 122 substantially stops flowing, such that the third cavity 102 will not affect the sound output of the sound emitting assembly 120.

As shown in FIG. 38, in one embodiment, a height H10 of the elastic component 121 protruding from the second shell 12 is not limited. For example, the height H10 of the elastic component 121 protruding from the second shell 12 may be 2 mm to 3 mm, 2 mm to 3.5 mm, 2.5 mm to 3.5 mm, etc. For example, the height H10 of the elastic component 121 protruding from the second shell 12 may be 2.5 mm, 3 mm, 3.5 mm, etc.

The higher the elastic component 121 protruding from the second shell 12, the greater the deformation amount of the elastic component 121. For example, when the wall thickness of the elastic component 121 is equal to 0.5 mm, the maximum deformation height of the elastic component 121 may be the height H10 of the elastic component 121 protruding from the second shell 12 minus 0.5 mm.

The manner in which the third cavity 102 is defined between the elastic component 121 and the second shell 12 is not limited. For example, the elastic component 121 may be C-shaped, and most of the third cavity 102 may be located inside the elastic component 121. For example, a recess may further be defined at the side of the second shell 12 facing the first shell 11, which may form a large portion of the third cavity 102.

The third cavity 102 and the audio chamber 122 may communicate with each other through one or more through holes.

In one embodiment, the gap between the elastic component 121 and the second shell 12 may be sealed. By sealing the gap between the elastic component 121 and the second shell 12, the audio from the sound emitting assembly 120 may be prevented from leaking between the elastic component 121 and the second shell 12, thereby preventing the impact of the elastic component 121 on the audio from the sound emitting assembly 120. When the gap between the elastic component 121 and the second shell 12 is sealed, the gas in the third cavity 102 is discharged to the audio chamber 122 when the elastic component 121 is compressed and deformed. When the pressure applied onto the elastic component 121 is removed, the gas in the audio chamber 122 enters the third cavity 102 such that the elastic component 121 rebounds. The sealing manner between the elastic component 121 and the second shell 12 is not limited. For example, the gap between the elastic component 121 and the second shell 12 may be sealed with sealant. For example, the gap between the elastic component 121 and the second shell 12 may also be sealed by a sealing structure such as a sealing ring or a gasket.

In other embodiments, the gap between the elastic component 121 and the second shell 12 may not be sealed. Here, the elastic component 121 may tightly fit with the second shell 12.

In one embodiment, the third cavity 102 may only communicate with a portion of the audio chamber 122, and the remaining portion of the third cavity 102 that does not communicate with the audio chamber 122 may be sealed. For example, the elastic component 121 is a solid structure without any hole.

In one embodiment, the elastic component 121 may be fixed to the second shell 12 by gluing, ultrasonic welding, injection molding, or other manners. The connection area required by gluing may be small, which may reduce the space occupied by the connection area between the elastic component 121 and the second shell 12. Thus, in case that the setting space is certain, larger space may be provided for the deformation of the elastic component 121, which may allow the elastic component 121 to adapt to ears of different sizes. If the third cavity 102 does not communicate with the audio chamber 122, the elastic component 121 may be connected to the second shell 12 through a clamping structure, such that the gas in the third cavity 102 may be discharged out through the gap between the elastic component 121 and the second shell 12. During the rebound process of the elastic component 121, the external gas may enter the third cavity 102 through the gap between the elastic component 121 and the second shell 12, thereby allowing the elastic component 121 to rebound. However, since the elastic component 121 is tightly adhered to the second shell 12 during the rebound process of the elastic component 121, the gap between the elastic component 121 and the second shell 12 may be easily blocked, which weakens the rebound ability of the elastic component 121. However, by communicating the third cavity 102 to the audio chamber 122, the rebound ability of the elastic component 121 may be greatly improved.

In one embodiment, the elastic component 121 may be bowl-shaped, and the periphery of the elastic component 121 may be fixed to the second shell 12 by gluing, ultrasonic welding, injection molding, or other manners. When the bowl-shaped elastic component 121 is fixed to the second shell 12 by gluing, larger space may be provided for the deformation of the elastic component 121, thereby allowing the ear-clip earphone 4 to adapt to ears of different sizes.

In one embodiment, as shown in FIGS. 54 and 55, the audio chamber 122 may be adjacent to the third cavity 102, thereby reducing the installation space of the second shell 12. In other embodiments, the audio chamber 113 and the third cavity 102 may not be adjacent to each other. Here, the audio chamber 122 may communicate with the third cavity 102 through a tube or a channel.

In one embodiment, as shown in FIGS. 54 and 55, an annular groove 119 may be provided at the side of the second shell 12 facing the first shell 11. The elastic component 121 may include an annular flange 1161 inserted into the annular groove 119. The ear-clip earphone 4 may further include an adhesive component filled between the annular flange 1161 and the annular groove 119, such that the second shell 12 and the first shell 11 are connected together through the adhesive component. At the same time, by filling the adhesive component between the annular flange 1161 and the annular groove 119, the adhesive component may be prevented from being exposed from the second shell 12, such that the second shell 12 may appear neat. By filling the adhesive component between the annular flange 1161 and the annular groove 119, the adhesive may be prevented from flowing into the interior of the second shell 12. At the same time, by filling the adhesive component between the annular flange 1161 and the annular groove 119, the third cavity 102 may be a sealed cavity except for the portion communicating with the audio chamber 122, thereby improving the audio effect of the ear-clip earphone 4.

In other embodiments, the elastic component 121 and the second shell 12 may also be glued together through a face-to-face manner.

In one embodiment, if the overall height of the elastic component 121 is equal to 3.5 mm, the elastic component 121 is connected to the second shell 12 through a clamping structure or a buckle structure having a height of 1.8 mm, the wall thickness of the elastic component 121 is equal to 0.5mm, then, the deformable height of the elastic component 121 is equal to 1.2 mm (3.5mm-1.8mm-0.5mm=1.2mm).

In one embodiment, if the overall height of the elastic component 121 is equal to 3.5 mm, the height of the annular flange 1161 is equal to 0.5 mm, the wall thickness of the elastic component 121 may be 0.5 mm, then, the deformable height of the elastic component 121 is equal to 2.5 mm (3.5 mm- 0.5 mm- 0.5 mm=2.5mm). Thus, when the annular flange 1161 and the annular groove 119 are connected together through the adhesive component, the deformable height of the elastic component 121 may be greatly increased, thereby allowing the elastic component 121 to adapt to ears of different sizes.

In one embodiment, the adhesive component may be an adhesive or an adhesive agent that may be used for bonding. For example, the adhesive component may be a modified silane polymer adhesive, a specialized silicone adhesive e, polyurethane adhesive, a cyanoacrylate adhesive, an epoxy resin adhesive, a chloroprene rubber adhesive, etc. In one embodiment, when the second shell 12 and the elastic component 121 are connected together by the adhesive component, the tensile force may reach 1.2 kg or more, thereby ensuring stable assembly and connection strength.

In one embodiment, the specific position for filling the adhesive component is not limited. For example, the adhesive component may be filled between the end surface 1162 of the annular flange 1161 and the bottom surface 1191 of the annular groove 119, wherein there may be a gap between the end surface 1162 of the annular flange 1161 and the bottom surface 1191 of the annular groove 119. For example, the adhesive component may also be filled between the sidewall of the annular flange 1161 and the outer sidewall 1193 of the annular groove 119, wherein there may be a gap between the sidewall of the annular flange 1161 and the outer sidewall 1193 of the annular groove 119. For example, the adhesive component may also be filled between the sidewall of the annular flange 1161 and the inner sidewall 1192 of the annular groove 119, wherein there may be a gap between the sidewall of the annular flange 1161 and the inner sidewall 1192 of the annular groove 119. For example, the adhesive component may also be filled between the end surface 1162 of the annular flange 1161 and the bottom surface 1191 of the annular groove 119, and also between the sidewall of the annular flange 1161 and the inner and outer sidewalls 1192 and 1193 of the annular groove 119, thereby increasing the bonding area and the bonding strength.

In one embodiment, the distance between the annular flange 1161 and the outer sidewall 1193 of the annular groove 119 may be smaller than the distance between the annular flange 1161 and the inner sidewall 1192 of the annular groove 119, such that most of the adhesive component may be filled between the annular flange 1161 and the inner sidewall 1192 of the annular groove 119. During the manufacturing process, if a large amount of the adhesive is accidentally set, due to the large distance between the annular flange 1161 and the inner sidewall 1192 of the annular groove 119, the large amount of the adhesive may enter the third cavity 102, thereby preventing the adhesive from overflowing outside the second shell 12 to affect the appearance of the second shell 12.

In other embodiments, the distance between the annular flange 1161 and the outer sidewall 1193 of the annular groove 119 may also be greater than or equal to the distance between the annular flange 1161 and the inner sidewall 1192 of the annular groove 119.

In one embodiment, the annular flange 1161 may be adjacent to the outer sidewall 1193 of the annular groove 119, and the annular flange 1161 may be spaced apart from the inner sidewall 1192 of the annular groove 119. Here, the annular flange 1161 may be in contact with the outer sidewall 1193 of the annular groove 119, or spaced from the outer sidewall 1193 of the annular groove 119 by a small gap. Thus, most of the adhesive component may be filled between the annular flange 1161 and the inner sidewall 1192 of the annular groove 119. During the manufacturing process, if a large amount of adhesive is accidentally set, due to the large distance between the annular flange 1161 and the inner sidewall 1192 of the annular groove 119, the large amount of adhesive may enter the third cavity 102, thereby preventing the adhesive from overflowing outside the second shell 12 to affect the appearance of the second shell 12.

In other embodiments, the annular flange 1161 may also be spaced apart from the outer sidewall 1193 of the annular groove 119. The annular flange 1161 may also be adjacent to the inner sidewall 1192 of the annular groove 119.

In one embodiment, at least one limiting rib 1194 may be provided in the annular groove 119. The annular flange 1161 may define at least one limiting groove. At least one limiting rib 1194 is inserted into at least one limiting groove, thereby limiting the position of the elastic component 121 relative to the second shell 12 along the circumferential direction, and preventing the elastic component 121 from rotating relative to the second shell 12.

Here, the quantity of the limiting rib(s) 1194 is not limited. The quantity of the limiting groove(s) is not limited. For example, as shown in FIG. 56, there are two limiting ribs 1194 spaced apart from each other and two limiting grooves spaced from each other. The two limiting ribs 1194 are inserted into the two limiting grooves, respectively.

In one embodiment, the second shell 12 may include a first wall 117 located between the audio chamber 122 and the third cavity 102. The first wall 117 defines a first through hole 118 that communicates the third cavity 102 with the audio chamber 122. Thus, the third cavity 102 and the audio chamber 122 are adjacent to each other to reduce the installation space of the second shell 12. Also, the gas may flow between the third cavity 102 and the audio chamber 122 through the first through hole 118.

As shown in FIGS. 54 and 55, the cross-sectional area of the first through hole 118 may gradually increase along the direction from the audio chamber 122 to the third cavity 102. In other embodiments, the cross-sectional area of the first through hole 118 may gradually decrease or remain unchanged along the direction from the audio chamber 122 to the third cavity 102.

The cross-section of the first through hole 118 may be circular such that the first through hole 118 may be easily processed and manufactured. In other embodiments, the cross-section of the first through hole 118 may also be square, elliptical, or the like.

In one embodiment, as shown in FIGS. 54 and 55, the sound emitting assembly 120 may divide the audio chamber 122 into the front chamber 1131 and the rear chamber 1132. The front chamber 1131 communicates with the third cavity 102. The second shell 12 defines the sound outlet 123 communicating with the front chamber 1131, so that gas may quickly flow between the front chamber 1131 and the third cavity 102 through the sound outlet 123, thereby greatly improving the speed and ability of deformation/rebound of the elastic component 121.

The rear-side chamber hole 115 may communicate with the rear chamber 1132. In other embodiments, the rear chamber 1132 may also communicate with the third cavity 102. Here, the gas may quickly flow between the rear chamber 1132 and the third cavity 102 through the rear-side chamber hole 115.

The connection component 13 may include the fitting portion 133 for corresponding to the position of the helix of the ear. The sound outlet 123 may be located at the side of the second shell 12 away from the fitting portion 133 to allow the sound outlet 123 to be close to the cavity of auricular concha.

As shown in FIGS. 35 and 54, the distance H9 between the elastic component 121 and the first shell 11 may gradually decrease along the direction from a position away from the fitting portion 133 to a position near the fitting portion 133, such that the protruding portion of the elastic component 121 near the fitting portion 133 may enter the recess area of the ear, thereby further improving the wearing stability of the ear-clip earphone 4 through the elastic component 121. In other embodiments, the distance H9 between the elastic component 121 and the first shell 11 may gradually increase or remain unchanged along the direction from a position away from the fitting portion 133 to a position near the fitting portion 133.

Here, the elastic component 121 may be fixed to the second half shell 112A by bonding, snap-fitting, welding, and other manners. The third cavity 102 may be defined between the elastic component 121 and the second half shell 112A. The connection component 13 may be connected to the first half shell 111A by bonding, snap-fitting, welding, and other manners.

As shown in FIGS. 35 and 41, in one embodiment, the curvature of the first connection section 135 of the connection component 13 located between the first end 131A and the fitting portion 133 is smaller than the curvature of the second connection section 136 of the connection component 13 located between the second end 132A and the fitting portion 133.

The inventors have found that when the distance between the connection section of the earphone and the is relatively large, the wearing stability of the earphone may be affected. For example, when the distance between the ear and the connection section located at the front side of the ear is relatively large, the earphone may often shake, thereby affecting the wearing stability of the earphone. However, in the ear-clip earphone 4 of the present application, since the curvature of the first connection section 135 of the connection component 13 located between the first end 131A and the fitting portion 133 is smaller than the curvature of the second connection section 136 of the connection component 13 located between the second end 132A and the fitting portion 133, the first connection section 135 may better fit with the front side of the ear, such that the ear may serve to prevent the first connection section 135 from shaking or significantly shaking, thereby improving the wearing stability of the ear-clip earphone 4. At the same time, since the curvature of the first connection section 135 of the connection component 13 between the first end 131A and the fitting portion 133 is smaller, the volume and the weight of the first connection section 135 may be reduced, thereby achieving miniaturization and lightweight design of the ear-clip earphone 4.

In one embodiment, when the earphone 4 is worn, the second shell 12 may be located at the cavity of auricular concha, the fitting portion 133 may be located at the helix, the first connection section 135 may be located at the front side of the ear, and the second connection section 136 may be located at the back side of the ear. Due to a gentle transition from the ear canal to the helix, a smaller the curvature of the first connection section 135 may reduce the distance between the first connection section 135 and the front side of the ear, thereby allowing the first connection section 135 to closely adhere to the front side of the ear.

In one embodiment, as shown in FIG. 49, the ear-clip earphone 4 may include a second adsorption component 178 and a fourth adsorption component 179. The second adsorption component 178 may be installed on the second shell 12 by bonding, snap-fitting, welding, or other manners. The fourth adsorption component 179 may be installed on the first shell 11 by bonding, snap-fitting, welding, or other manners.

Based on this, referring to FIG. 57, one embodiment of the present application further provides an earphone module, which includes an earphone case and the earphone 2 (or earphone 3, earphone 4) mentioned in the above embodiments of the present application. The earphone case defines a fourth cavity for receiving the earphone 2.

In one embodiment, the earphone case may only include the function of receiving the earphone 2 therein. The earphone case may further have the function of charging the earphone 2 besides the function of receiving the earphone 2.

The above description is only some preferred embodiments of the present disclosure and is not intended to limit the present disclosure. Any modifications, equivalent substitutions and improvements made within the principles of the present disclosure should be included in the protection scope of the present disclosure.

1. An ear-clip earphone, characterized by comprising:
a postauricular component;
a preauricular component being configured to install at least a sound emitting assembly thereto; and
a connection component connected between the postauricular component and the preauricular component, a relative position between the postauricular component and the preauricular component being adjustable by the connection component to cooperatively clamp an ear;
wherein the preauricular component is provided with an elastic component, the elastic component is flexible and protrudes towards the postauricular component, and the elastic component is configured to cooperate with an ear bone of the ear to locate a position of the ear-clip earphone worn on the ear.

2. The ear-clip earphone according to claim 1, wherein a distance from an end of the elastic component away from the connection component to the postauricular component is denoted as L, a distance from another end of the elastic component near the connection component to the postauricular component is denoted as M, wherein L > M.

3. The ear-clip earphone according to claim 1, wherein the postauricular component and the elastic component cooperatively define a clamping gap, a width of the clamping gap gradually decreases along a direction from an end of the elastic component away from the connection component to another end of the elastic component near the connection component.

4. The ear-clip earphone according to claim 1, wherein the elastic component comprises:
a protruding portion arranged at an end of the preauricular component near the connection component; and
a supporting portion arranged at another end of the preauricular component away from the connection component, and the supporting portion extending towards the protruding portion and connected to the protruding portion;
wherein the protruding portion protrudes towards the postauricular component and the connection component, a thickness of the supporting portion gradually increases along an extending direction of the supporting portion, and a maximum thickness of the supporting portion is less than or equal to a minimum thickness of the protruding portion.

5. The ear-clip earphone according to claim 4, wherein a minimum opening of a gap between the protruding portion and the postauricular component is in a range from 0.4 mm to 6.5 mm; and/or
a maximum thickness of the protruding portion is in a range from 0.4 mm to 5.5 mm.

6. The ear-clip earphone according to claim 4, wherein along a direction from an end of the elastic component away from the connection component to another end of the elastic component near the connection component, a straight distance between the protruding portion and the connection component is in a range from 5 mm to 22 mm.

7. The ear-clip earphone according to claim 4, wherein at least a portion of the supporting portion is located at a contour edge of the preauricular component, and a maximum size of the preauricular component is in a range from 5 mm to 16 mm.

8. The ear-clip earphone according to claim 1, wherein two ends of the connection component are configured to extend outward by a distance from 0 mm to 12 mm.

9. The ear-clip earphone according to claim 1, wherein a quantity of the elastic component is at least two, each of the at least two elastic components is detachably connected to a side of the preauricular component facing the postauricular component, and the at least two elastic components have different characteristic parameters;
the characteristic parameters comprise at least one of a shape, a size, and a hardness.

10. The ear-clip earphone according to claim 9, wherein a gap defined between one elastic component of the at least two elastic components and the postauricular component is different from a gap defined between another elastic component of the at least two elastic components and the postauricular component, and/or
a space defined among one elastic component of the at least two elastic components, the postauricular component, the preauricular component, and the connection component is different from a space defined among another elastic components of the at least two elastic components, the postauricular component, the preauricular component, and the connection component.

11. The ear-clip earphone according to claim 9, wherein the connection component comprises a connection portion configured to correspond to a position of a helix of the ear;
a distance from an end of one of the at least two elastic components near the postauricular component to the connection portion is different from distance from an end of another of the at least two elastic components near the postauricular component to the connection portion.

12. The ear-clip earphone according to claim 9, wherein the at least two elastic components comprise a first elastic component, a second elastic component, and a third elastic component;
the first elastic component and the preauricular component cooperatively form a spherical structure when the first elastic component is detachably connected to a side of the preauricular component facing the postauricular component;
a first portion of the second elastic component and the preauricular component cooperatively form a spherical structure when the second elastic component is detachably connected to the side of the preauricular component facing the postauricular component, and a second portion of the second elastic component protrudes from the spherical structure;
a first portion of the third elastic component and the preauricular component cooperatively form a spherical structure when the third elastic component is detachably connected to the side of the preauricular component facing the postauricular component, and a second portion of the third elastic component protrudes from the spherical structure;
wherein a height of the second portion of the third elastic component protruding from the respective spherical structure is greater than a height of the second portion of the second elastic component protruding from the respective spherical structure.

13. The ear-clip earphone according to claim 1, wherein a side of the preauricular component facing the postauricular component comprises a convex portion and a flange located at a top of the convex portion;
the elastic component defines a groove configured for receiving the convex portion and an annular slot located at a bottom side of the groove, and the flange is detachably clamped in the annular slot.

14. The ear-clip earphone according to claim 1, wherein the elastic component comprises a first side facing away from the preauricular component, the first side comprises a first portion and a second portion, the first portion surrounds a periphery of the second portion, the second portion is recessed with respect to the first portion along a direction toward the preauricular component to form an avoidance portion, the first portion forms a clamping portion, and the clamping portion and the preauricular component are configured to cooperatively clamp on an auricle of the ear.

15. The ear-clip earphone according to claim 14, wherein the preauricular component and the first portion cooperatively define a first cavity, the preauricular component and the second portion cooperatively define a second cavity communicating with the first cavity, and each of the first cavity and the second cavity is filled with a gas.

16. The ear-clip earphone according to claim 1, wherein the elastic component is an airbag, and a side of the airbag facing the preauricular component forms an airbag cavity;
the ear-clip earphone further comprises an adjusting assembly defining a main discharge groove at a side of the airbag facing the preauricular component, the main discharge groove comprises a first end located inside the airbag cavity and a second end communicating to an exterior of the ear-clip earphone, such that the airbag cavity communicates with the exterior.

17. The ear-clip earphone according to claim 16, wherein the adjusting component further defines an auxiliary discharge groove at the side of the airbag facing the preauricular component, the auxiliary discharge groove comprises a first end communicating with the main discharge groove and a second end communicating with the exterior.

18. The ear-clip earphone according to claim 1, wherein the preauricular component defines an audio chamber configured for receiving the sound emitting assembly, the elastic component and the preauricular component cooperatively define a third cavity, and the third cavity communicates with the audio chamber.

19. The ear-clip earphone according to claim 18, wherein a side of the preauricular component facing the postauricular component defines an annular groove, the elastic component comprises an annular flange inserted into the annular groove; the elastic component is adhered to the preauricular component by an adhesive component filled in a gap between the annular flange and the annular groove.

20. An earphone module comprising:
an earphone case; and
an earphone according to claim 1 and received in the earphone case.
